(19) United States
(12) Patent Application Publication
(10) Pub. No.: US 2009/0011780 A1
(43) Pub. Date: Jan. 8, 2009

(54) Methods and Systems of Creating and Managing Addresses Corresponding to Disparate Communication Channels and Sending Messages to and Receiving Replies from Such Addresses

(76) Inventors: Robert Salinas, (US); Iain Glendinning, (US)

Correspondence Address: KENYON D. POTTER, 1180 EDDY ST. UNIT C, SAN FRANCISCO, CA, 94109, US

(21) Appl. No.: 12/106,265

(22) Filed: Apr. 18, 2008

Related U.S. Application Data
(60) Provisional application No. 60/913,228, filed on Apr. 20, 2007.

(51) Int. Cl. H04Q 7/20

(52) U.S. Cl. 455/466

(57) ABSTRACT

The invention includes systems and methods for creating and managing lists of addresses (mobile phone numbers, email addresses, and so on) corresponding to disparate communication channels and sending messages to addresses or groups of addresses that may correspond to disparate communication channels, and receiving replies via one or more of these communication channels. In particular, the invention relates to systems and methods for creating and managing lists of addresses where some of the addresses may be mobile phone numbers and other addresses may correspond to other communication channels including email and systems and methods of determining the gateway or domain if an incomplete address, determining the MIME type for the content of the message, determining the wrapper for the content of the message, sending the message to one or more addresses or a group of addresses, and receiving replies via one or more of these communication channels.

### PRIORITY CLAIM

This application claims the benefit under 35 U.S.C. Section 119(e) of U.S. Provisional Application No. 60/913,228, filed on Apr. 20, 2007. U.S. Provisional Application No. 60/913,228 is hereby incorporated by reference in its entirety.

### COPYRIGHT RIGHTS

A portion of the disclosure of this patent document contains material which is subject to (copyright or mask work) protection. The (copyright or mask work) owner has no objection to the facsimile reproduction by any-one of the patent document or the patent disclosure, as it appears in the Patent and Trademark Office patent file or records, but otherwise reserves all (copyright or mask work) rights whatsoever.

### FIELD OF THE INVENTION

This invention relates to systems and methods for creating and managing lists of addresses of electronic devices, and in particular, methods and systems for creating and managing addresses corresponding to disparate communication channels, and sending messages to addresses that may correspond to disparate communication channels, and receiving replies via one of these communication channels.

### DEFINITIONS

The following abbreviations and defined terms apply to methods or systems of the inventions described in this document. Abbreviations include but are not limited to acronyms and short hand expressions:
AC area code
AMR adaptive multirate (audio)
CCTV closed circuit TV
CF compact flash (memory)
COTS commercial off the shelf
DGPS digital GPS
DLP digital light processing
DPI dot per inch
DSL digital subscriber line
DTV digital television
ETA estimated time of arrival
FPD flat panel display
FTP file transfer protocol
GPS global positioning system
GUI graphical user interface
HDTV high definition television
HH hour(s)
HTML hypertext markup language
HTTP hypertext transfer protocol
IE Internet Explorer
IM instant messag(ing)
IP internet protocol
IR infrared
ISP internet service provider
LAN Local area network
LCD Liquid crystal display
LED Liquid emitting diode (display)
MIDI musical instrument digital interface
MIME Multipurpose Internet Mail Extensions
MMS multimedia messaging service
NFC near field communication
OEM original equipment manufacturer
Os operating system
PAN personal area network
PDA personal digital assistant
PIN personal identification number
PPI pixels per inch
PPT Powerpoint file
PPS Powerpoint Slideshow
QCIF Quarter Common Intermediate Format
QVGA Quarter Video Graphics Array
QXGA Quantum eXtended Graphics Array
RDF resource description framework.
RF radio frequency
RFI request for information
RFID radio frequency identification
RFRSS radio frequency signal strength
RSS RDF Site Summary or Rich Site Summary (an XML format for
syndicating web content)
SD secure digital (memory)
SGML Standardized Generalized Markup Language
SVGA Super Visual Graphics Array
SXGA Super Extended Graphics Array
SMIL Standardized Multimedia Integration Language
SMS short messaging service
SMTP simple mail transfer protocol
SS second (time)
SSR Small screen rendering
TEL telephone
TFT thin film transistor
TV television
° degree (geographical)
′ minute (geographical)
″ second (geographical)
URL uniform resource locator
VGA Video Graphics Array
W3C World Wide Web Consortium
WAP wireless application protocol
WAV wave file
WIFI wireless fidelity
WMF Windows media format
WML wireless markup language
XGA extended graphics array
XML extensible markup language
XHTML XML-compliant version of HTML

Definitions and defined terms include but are not limited to the following:

The term “activate” or “activation” means the activation of any user account whatsoever including but not limited to a free account, a paid account, a trial account, and so on. The term “activate” or “activation” also means activation of a user account by any communication channel including but not limited to the same communication channel as that used to setup the user or a disparate communication channel than that used to setup the user account.

The term “address” means any address for receipt of electronic communication(s) by one or more persons whatsoever including but not limited to an email address, an IM address, a telephone number, a voice mailbox, a fax number, a mobile phone number, a cell phone number, a pager number, and so on. The term “address” can be the ultimate address of the recipient or another address such as a forwarding address, anonymous address, and so on. For example, address may be an email forwarding address. The term “address” can be the address in whole or in part. For example, the whole address may be “username@domainname”, “groupname@domainname”, “forwardingemailacct@domainname”, or so on, and a partial address may be just a “username”, “groupname”, “forwardingemailacct”, or so on. For example, in the context of mobile phones, the whole address may be a “10digitnumber@gateway” and a part of the address may be just a “10digitnumber”, “phonenumber” or so on. In another example, in the context of smart phones including BlackBerrys, the whole address may be “8characterisequence@gateway”, “username@gateway”, or so on, and a part of the address may be just a “8characterisequence”, “username”, or so on.

The term “carrier” means any type of telecommunications carrier including but not limited to carriers that provide services via landline, wireless, radio, cable, satellite, NFC, and so on. For example, carrier can provide a service for voice communications via one or more communication channels. Carrier can also mean any organization that operates a service for multimedia communications. For example, a carrier may operate a MMS gateway or other server for transmission of multimedia messages via one or more communication channels.

The term “communication channel” means any type of channel capable of communications whatsoever including but not limited to telephone, radio, TV, cable TV, satellite TV, satellite radio, internet, wireless, cellular, and so on, and be any form of media including but not limited to email, IM, facsimile, SMS/MMS messaging, voice or audio transmission, video transmission, data transmission, and so on. The term “communication channel” can be one-way or two-way communication channels. For example, broadcast radio, broadcast TV, satellite radio, and satellite TV are examples of one-way communication channels while telephone, internet, cable, and cellular are examples of two-way communication channels. A communication channel can be used to send messages one-to-one or one-to-many. For example, a person-to-person voice communication using a telephone is an example of a one-to-one message while a TV, radio, or web broadcast is an example of a one-to-many message.

The term “displayed object” means any visible object displayed on a device whatsoever including but not limited to one or more items of text, markup language (including HTML, XML, WML, and so on); one or more documents (including RTF, DOC, PDF, and so on); one or more images (including pictures, photos, stills, charts, and so on); and other objects (including text boxes, tables, frames, maps, banners, RSS, and so on); or any combination of objects. The term “displayed object” also means any web resource whatsoever and in whatever form including but not limited to audio objects, e.g. music; motion picture or video objects without sound track, e.g. cartoons, animations, silent films, and so on; motion picture or video objects with sound track, e.g. movies, TV shows, music videos, and so on; and/or multimedia objects, e.g. slides with audio, film or video with sound track, presentation with voice over, and so on.

The term “media” means any digital media whatsoever including but not limited to one or more lists, stories, headlines, scores, and so on; one or more songs, tunes, music, and so on; one or more videos, movies, segments, clips, and so on; one or more photos, images, pictures, and so on; one or more items of text, markup language, and so on; or any combination of media. The term “media” also means other forms of content including interactive content such as games, simulations, contests, puzzles, polls, quizzes, surveys, stories where users elect the ending, and so on. For example, digital media text may include text in one or more formats: TXT, RTF, DOC, HTML, XML, and so on. In another example, digital music media may include music in one or more formats: MIDI, MPEG e.g. MP3, WAV, WMF, AMR, and so on. In still another example, digital photo media may include photos, images, pictures and so on, in one or more of the formats: JPEG, GIF, BMP, TIFF, PPT, PPS, PNG and so on. In yet still another example, digital video media may include video in one or more formats: animated GIF, MOV, WMF, EPS, SWF, PNG, G3P, and so on.

The term “media center” means any storage of digital media whatsoever including but not limited to an online or offline repository of digital media. For example, an online repository of digital media may include an online service accessible through the internet, wireless networks, or any network whatsoever. For example, an offline repository may include any electronic device whatsoever including a mobile phone or other mobile device.

The term “MIME type” is an Internet standard for describes message content types. MIME messages can contain text, images, audio, video, and other application-specific data. A registry of MIME types is maintained by the Internet Assigned Numbers Authority (IANA). Standards relating to MIME types are developed by the Internet Engineering Task Force (IETF) in the following Request for Comment (RFC) documents which are hereby incorporated by reference in their entirety:
RFC-822 Standard for ARPA Internet text messages
RFC-2822 Internet Message Format
RFC-2045 MIME Part 1: Format of Internet Message Bodies
RFC-2046 MIME Part 2: Media Types
RFC-2047 MIME Part 3: Header Extensions for Non-ASCII Text
RFC-2048/4289 MIME Part 4: Registration Procedures
RFC-2049 MIME Part 5: Conformance Criteria and Examples
RFC-2913 MIME Content Types in Media Feature Expressions
RFC-3023 XML Media Types
RFC-3459 Critical Content Multi-purpose Internet Mail Extensions (MIME)
RFC-3625 The QCP File Format and Media Types for Speech Data
RFC-3839 MIME Type Registrations for 3rd Generation Partnership Project (3GPP) Multimedia files
RFC-4281 The Codecs Parameter for “Bucket” Media Types
RFC-4393 MIME Type Registrations for 3GPP2 Multimedia Files
RFC-4337 MIME Type Registration for MPEG-4

The term “group” or “grouping” means any group of intended recipients of one or messages such as email, an IM, a SMS message, a MMS message, and so on. Typically, each member of a group of intended recipients has an address for receipt of electronic communications. In another context, the term “group” or “grouping” also means any list, collection, mix, assembly, compilation, or collection of any digital media whatsoever. A group or grouping of digital media may comprise one item, several items or many items

The term “playlist” means any grouping of media including any form of digital media whatsoever including but not limited to one or more songs or music, one or more videos, one or more photos, pictures or images, one or more items of text, or any combination of media. The term “playlist” also means lists of items (including text or multimedia) comprising scores, highlights, headlines, stock valuations, business metrics, search results, nearby stores or locations, operating hours, real estate comparables, price comparisons, etc. The term “playlist” also means forms of interactive media that may require user response(s) such as quizzes, polls, contests, puzzles, games, and so on. These playlists may take the form of TEXT, multimedia (TEXT, MUSIC and/or VIDEO), or TEXT or THUMBNAILS with LINKS to multimedia, and so on. For example, a playlist may include music in any formats such as MIDI, MPEG e.g. MP3, WAV, WMA, AMR, and so on. For example, a playlist may include pictures, photos, slides, stills, and so on in any format such as JPEG, GIF, BMP, TIFF, PPT, PPS, PNG and so on. For example, a playlist may include videos, clips, trailers, and so on, in any format such as MOV, WMF, EPS, SWF, PNG, G3P, and so on. However, playlist may include any type of media whatsoever including but not limited to a list of items with links to other media. Examples include a list of items comprising text with links to additional text or to photos, music, or videos; the list of items may include a series of images with links to additional text or to photos, music or videos; the list of items may include a series of images with accompanying text with each images and/or text having links to photos, music or videos. In the context of pictures, photos, slides, stills, and so on, the terms “slideshow”, “photo album”, or “face book” may be interchanged with “playlist”. In the context of video, the term “movie”, “video”, “videoshow”, “video recording”, or “podcast” may be interchanged with “playlist”. A picture playlist (aka slideshow) may comprise various picture media including images, photos, stills, frames, drawings, renderings, and so on. A music playlist may comprise various music media including songs, sound bites, sound tracks, recordings, and so on. A video playlist may comprise various video media including video clips, movie clips, video segments, video ads, TV broadcasts, podcasts, and so on. A generalized playlist may comprise a collection or list of items of media including stories, reports, scores, headlines, stock valuations, business metrics, product descriptions, product pricing, bestsellers, showtimes, horoscopes, team members, contestants, candidates, nearby store locations, nearby friends or family, real estate comparables, and so on.

The term “screen” means any visual display including but not limited to a CRT, LED, LCD, FPD, TV, HDTV, projection screen, etc., and is used interchangeably with the term “visual display”. A screen is capable of displaying M pixels by N lines whereby a screen with 800 pixels by 600 lines is capable of displaying 800 distinct dots on each of 600 lines, or about 480,000 pixels

The term “screen resolution” means the clarity or sharpness of a display and is signified by the number of dots (pixels) on the entire screen and denoted by M pixels×N lines and is contrasted with unitized “resolution” which is signified by DPI or PPI.

The term “full size screen” means any visual display capable of a screen resolution of at least 800 pixels by 600 lines (e.g. SVGA), and typically has 1024 by 768 pixels (e.g. XGA), or 1248 by 1024 pixels (e.g. SXGA), 2048 by 1536 pixels (e.g. QXGA), and so on. The term “full size screen” also means any visual display regardless of type of hardware including but not limited a CRT, LED, LCD, FPD, TV, HDTV, projection screen, and so on.

The term “miniature size screen” is any screen that has fewer pixels than a full size screen including but not limited to 640×480 pixels (e.g. VGA), 320×240 pixels (e.g. QVGA), or 352×288 pixels (e.g. CIF), or 176×144 pixels (e.g. QCIF), and so on. The term “miniature screen” also means any visual display including but not limited a LED, LCD, FPD, TV, HDTV, and so on.

The term “mobilize” means conversion of one or more webpages (or web resources) that are capable of being displayed on a computer with a full size screen, e.g. desktop, laptop or notebook, to a one or more webpages that can be displayed on at least one mobile device with a miniature screen, e.g. PDA, mobile phone, smart phone, and so on. The term “mobilize” can also mean the conversion of one or more webpages that are capable of being displayed on a computer with a full size screen to one or more webpages that can be displayed on both a computer with a full size screen and at least one mobile device with a miniature screen, or that can be displayed on a computer with a full size screen and multiple mobile devices with miniature screens. The term “mobilize” can also mean creation of one or more webpages that are capable of being displayed on at least one mobile device with a miniature screen, e.g. PDA, mobile phone, smart phone, and so on, with or without benefit of one or more pre-existing webpages as a starting point. As used herein, the term “conversion” includes but is not limited to selecting, arranging, and/or adapting content from one or more existing webpages for display on mobile devices, substituting existing representations of such content with images, pictures, iconographics and/or symbols, and supplementing existing content with additional content such as text, pictures, and so on. As used herein, the term “creation” includes but is not limited to selecting, arranging, and/or adapting content from any source (digital or non-digital) for display on mobile devices.

The term “area code” means digits 1-3 of a 10-digit telephone number representing a unique code that corresponds to a particular geographic area, e.g. 415 is the area code for the city of San Francisco, Calif. In a full telephone number, the digits of “area code” typically precede the digits of the “exchange code”. The term “area code” may also be known as “city code” and these terms may be used interchangeably.

The term “day” is any day or date whatsoever and can mean any period of time having a 24-hour duration including but not limited to a calendar day, a working day, a day of week, a day of month, a day of year, any holiday, e.g. Valentine's day, New Year's Eve, New Year's Day, Christmas Eve, Christmas Day, Independence Day. and so on. The “term” day may also mean “date” or “calendar date” and these terms may be used interchangeably. See also “time of day” defined below.

The term “country code” means the number, e.g. typically 2 digits, that precedes the telephone number and is a unique code that corresponds to a particular country.

The term “delivery” means delivery in any form whatsoever including but not limited to delivery by voice messages, text messages, IM, email with or without attached documents, multi-media including streaming, tickers, RSS, WAP, internet, messaging service, narrowcast, and so on, and may utilize any communication protocol such as IP, mobile IP, FTP, HTTP, HTTPS, and so on.

The term “device” means any electronic device including but not limited to mobile electronic devices or immobile electronic devices that are capable of either one-way or two-way communications including but not limited to cellular phones, handheld radios, pagers, laptop computers, notebook computers, ultra-compact computers, desktop computers, set-top boxes, cable boxes, satellite phones, video phones, PDAs, MP3 players, devices on-board vehicles including but not limited to planes, ships, cars or trucks, and so on, and RFID devices attached to other tangible items such as products, packaging, shelves, displays, signs, exhibits, and so on.

The term “exchange code” means digits 4-6 of a 10-digit telephone number or digits 1-3 of a 7-digit telephone number. In the latter context, the term “exchange code” may also be known as a “prefix”, e.g. NXX, and these terms may be used interchangeably. In a full telephone number, the digits of “exchange code” typically follow the digits of the “area code”.

The term “identifier” means any information in any form whatsoever that uniquely identifies a device including but not limited to a telephone number, a device identification number, a device's name, a user's name, a street address, a pre-assigned identification number, a user-defined passcode, a pre-assigned or user-defined username, birthplace, and so on.

The term “internet service provider” means any person or entity whatsoever that provides an access point to the internet including but not limited to telephone companies, telecommunications companies, cable companies, media companies and any other commercial organizations as well as universities and other institutions, not-for-profits, community associations, government entities, and so on.

The term “message” means information in any form whatsoever including but not limited to a text message, picture, photo, cartoon, audio, video, animation, presentation, and so on, and any combination of these forms include multi-media message, audio-video, voice over animation, voice over presentation, pictures or photos with captions, cartoons with captions or call-outs, and so on. For example, a message may be a SMS message, a MMS message, an email, an IM, a voice message, or any other type of electronic message. A message can be an advertisement or promotional information pushed by an advertiser to a user's mobile device, a message requested by the user of the device, or any message initiated by any person, organization, or entity. A message may be initiated in response to a specific request or in response to an automated protocol.

The term “narrowcast” means transmission of a RF signal, or the act of transmitting a RF signal, from a source resulting in receipt of the RF signal in relatively small geographical area. A narrowcast can be from any RF source whatsoever including but not limited to a single cell tower, a transmitter, a base station, a repeater station, a two-way radio, a bluetooth source, a RFID source, a NFC source, any electronic device capable of RF transmission, and so on. The geographical area of a narrowcast typically has a maximum range of up to 10 kilometers but may have a lesser or greater range.

The term “near field communication” means transmission of a RF signal, or the act of transmitting a RF signal, from a source resulting in receipt of the RF signal in a small or very small spatial area. A near field communication can be from any source such as an electronic device, a POS device, a RFID source, a NFC source, a microchip, and so on, or any source attached to or embedded in another electronic device. The spatial area of a near field communication typically has a maximum range up to 1 meter but may have a lesser or greater range.

The term “network” means any communications network, any subnetwork (aka “subnet”) or any combination of these, including but not limited to ethernet, LAN, WAN, PAN, internet, intranet, extranet, wired network, wireless network, telephone network, cellular network, cable network, satellite network, a mesh of network connections or access points, and so on, including but limited to transmission via conventional electrical conductors, twisted pair, Cat-V, Cat-10, or Cat-100 cables, coaxial cables, fiberoptic cables, DSL, broadband, light transmission, laser transmission, and RF transmission at any frequency, and so on.

The term “BlackBerry PIN” means a special address code similar to a postal code or phone number for sending emails only to other BlackBerry device users. The term “PIN Messaging” means sending private emails only between mobile devices, e.g. BlackBerry devices. This is not compatible with phone numbers, email addresses or SMS (text messaging). It is an entirely different kind of an address. Not every such user needs to use PIN messaging, but the feature is considered a valuable feature, especially for security purposes. The term “Pin-to-Pin” or “Peer-to-Peer” (P2P) means allows messages to be sent directly between handhelds using PINs. It provides backup when email is down and private mail routing around an email and IM server, e.g. BlackBerry Enterprise Server (BES).

The term “purchase” means any type of acquisition whatsoever including but not limited to outright purchase, subscriptions, payment plans, and so on. The term “purchase” also means both paid acquisitions, e.g. purchases, paid subscriptions, and so on, and non-paid acquisitions (with or without registration) such as downloads, trial versions, shareware, freeware, music or video clips, movie trailers, promotional media, and so on.

The term “telephone number” means a number that corresponds to a particular electronic device including but not limited to a mobile phone, PDA, an electronic device connected to a landline, and so on. A telephone number typically corresponds to an electronic device that is capable of voice communications but also correspond to an electronic device that is capable of voice, facsimile, text, and/or video communications.

The term “time” means the duration of time as measured in seconds from an established point in time to the current time of day as measured in years, days, hours, minutes, seconds, or any combination of these, where a year comprises about 365.25 days, a day comprises 24 hours, an hour comprises 60 minutes, and a minute comprises 60 seconds. By convention, time is often measured as the number of seconds from beginning of Jan. 6, 1980. The term “time” can also mean anything that represents time or has temporal significance, e.g. time of day, time of month, time of year, summer time, and holiday's including St. Valentine's day, New Year's eve, Christmas, the time between thanksgiving and Christmas, etc. See also the term “time of day” defined below.

The term “time of day” means the time of day in any form whatsoever including time of day as measured in hours, or a combination of hours and minutes, e.g. HH:MM, or a combination of hours, minutes, and seconds, e.g. HH:MM:SS, from the beginning of the current day where a day comprises 24 hours, an hour comprises 60 minutes and a minute comprises 60 seconds. The term “time of day” may also be measured in a portion of a 24-hour period that occurs each day such as morning, afternoon, evening, night, breakfast, lunch, dinner, dawn, sunrise, dusk, sunset, and so on.

The term “wireless service provider” means any person or entity whatsoever that provides access to the internet and/or other network(s) including but not limited to telephone companies, telecommunications companies, cable companies, media companies and any other commercial organizations as well as universities and other institutions, not-for-profits, community associations, government entities, and so on. Access may be WIFI (including any type of 802.11 network, e.g. 802.11b, 802.11a, 11g, dual-band, etc.), bluetooth (including any type of personal area network), broadband, or any other wireless protocol and may be connected through a wireless access point, a host device with wireless capability, or any other means of access such as a publicly accessible grid of devices (or mesh).

The term “validate” or “validation” means the verification of the validity of any address whatsoever including but not limited to an email address, a mobile phone number, a pager number, a BlackBerry ID, and so on, using any communication channel whatsoever including but not limited to the same communication channel as that of the address to be validated or a different communication channel different than the address to validated. The term “validate” or “validation” can also mean verification of the ownership and/or control of any address using any communication channel.

### BACKROUND OF THE INVENTION

Earlier methods of sending messages were directed to sending a message using a single communications channel. Within a communications channel, methods may use one or more protocols which are standard methods of transmitting information. For example, in the context of email communications, there are several email protocols: IMAP, POP3, SMTP and HTTP by which the mail client and mail server can exchange information with each other.

The Internet Message Access Protocol (IMAP) is a standard protocol for accessing e-mail from a server via one or more networks including the Internet. IMAP is a client/server protocol in which e-mail is received and held for a user by a server. Only if a user requests to read a specific email message will it be downloaded from the server. Thus, IMAP requires only a small data transfer and works well even over a connection with limited bandwidth such as dialup connection or network limitations such as a wireless carrier network. You can also manage your email account (including creating, moving and deletes email and folders) on the server. IMAP is embodied in internet servers accessible over one or more networks such as Microsoft Internet Server 6 made by Microsoft Corporation of Redmond, Wash. See also RFC 2060 published by IETF.org and the IMAP.org.

The Post Office Protocol Version 3 (POP3) protocol provides a simple, standardized way for users to access mailboxes and download messages to their computers. When using the POP protocol, all of a user's email messages will be downloaded from the mail server to the user's computer or another computer as a proxy for the user. A user can choose to leave copies of your emails on the server as well. Once a user's messages are downloaded, a connection to the internet connection is no longer required. Thus, the user can subsequently read the email messages without disruption and without incurring further communication costs. Yet, the user may have transferred a lot of unwanted messages (including spam or viruses). See also RFC 1939 published by the IETF.org which is incorporated herein by reference.

Simple Mail Transfer Protocol (SMTP) protocol is primarily utilized by a Mail Transfer Agent (MTA) to deliver a user's email to the recipient's mail server. The SMTP protocol is generally utilized to send emails, not to receive them. Depending on a user's network and/or ISP settings, the user may not be able to use the SMTP protocol except under certain conditions set by incoming and outgoing mail servers. See also RFC 2821 published by the IETF.org which are incorporated herein by reference.

The HTTP protocol is general protocol for web-based communications and not a protocol dedicated for email communications, but it can be used for accessing your mailbox. In the context of web-based email, this protocol can be used to compose or retrieve emails from an your email account. Hotmail offered by Microsoft Corporation is a good example of using HTTP for email. HTTP is also embodied in web-based email services such as Yahoo! Mail offered by Yahoo! Inc. of Sunnyvale, Calif. and Gmail offered by Google, Inc. of Mountain View, Calif. See also RFCs 2616 and 2818 published by the IETF.org which are incorporated herein by reference. Similar to HTTP intended for web based communications via desktops and notebooks, WAP is another general protocol intended for web-based communications via wireless devices. Similar to HTTP, WAP is not a protocol dedicated for email communications although it can be used for accessing your email account. In the context of web-based email, this protocol can be used to compose or retrieve emails from an your account. Yahoo Mail is a good example of using WAP for email. See also documents published by the Open Mobile Alliance which are incorporated herein by reference.

Other communications channels may use other standard protocols in addition to or in lieu of the above protocols. For example, in the context of mobile phones, text messages can also be sent to a using SMS and multimedia messages can be sent using MMS. SMS, EMS, and/or MMS are standards for telephony messaging systems used to send messages from one mobile device to one or more other mobile devices. MMS relies on a group of related protocols denoted by MMX (including MM1, MM2, MM2, . . . , MMX) developed by the Third-Generation Partnership Program (3GPP), Third-Generation Partnership Program 2 (3GPP2), and more recently in conjunction with the Open Mobile Alliance (OMA), said protocols incorporated herein by reference. A protocol such as SMTP (or IMAP, HTTP, and so on) may still be used to send one or more SMS, EMS, or MMS messages via the Internet to a mobile phone by addressing the message(s) to one or more addressees (typically mobile phone numbers) and sending to a wireless carriers' gateway server, e.g. SMS gateway or MMS gateway. Regarding mapping of MMS to internet and internet to MMS, see RFC 4355 and RFC 4356 published by IETF.org which are incorporated herein by reference.

Yet, another communications channel relates to mobile communication devices (typically handheld devices) which do not rely on mobile phone numbers as “addresses” for receipt of electronic communications. Instead, they may utilize a username, personal identifier, or other numeric or alphanumeric identifier as the “address” for receipt of electronic communications. For example, the username may be an 8-character username (a.k.a. “BlackBerry PIN”) of the type utilized by the BlackBerry® service offered by Research in Motion of Waterloo, Ontario. A competing service is the SideKick® service offered by T-Mobile USA of Bellevue, Wash. Such a communication channel also relies on different hardware and operating systems than regular mobile phones and are often called “smartphones”. For example, an embodiment of the hardware is the Treo line of products made by Palm Inc of Sunnyvale, Calif. Other embodiments of smartphones are made by many manufacturers including Nokia, Sony Eriksson, RIM, and so on. For example, embodiment of the software is PalmOS® by Palm Inc. and Windows Mobile® by Microsoft Corporation. One of the first systems to provide “always on” notification of mail, and thus, a “push” system was Blitzmail made by Dartmouth College of Hanover, N.H., and subsequently other systems were developed for desktop or notebook computers. The first wireless carrier service to utilize push mail for a mobile device was the BlackBerry service. Other manufacturers have subsequently developed push e-mail systems for other handheld devices including Symbian based mobile phones or Windows Mobile 5.0 devices, and the recently announced, Yahoo! mail service using Apple's iPhone.

In the communications channel of communications devices that do not rely on mobile phone numbers, another example of a handheld device is the Pocket PC®, or PPC, trademarked by Microsoft Corporation. Any device which is to be classified as a Pocket PC must: Run Microsoft's Windows Mobile, PocketPC edition; come bundled with a specific suite of applications in ROM; include a touchscreen; include a directional pad or touchpad; include a set of hardware application buttons; and be based on an ARM version 4 compatible CPU, Intel XScale CPU, MIPS CPU or SH3 CPU. Early Pocket PC has limited connectivity, e.g. external modem. Windows Mobile 5 Mobile 5.0 incorporates connectivity features integrated Bluetooth and WiFi. Unlike a mobile phone or smart phone, a Pocket PC does not have an integrated telephony. Thus, addresses for receipt of communications by users of Pocket PCs are limited to email addresses or IM addresses or the like.

Similarly, an example of a quasi-handheld device is a Tablet PC (or other tablet computer). A Tablet PC may or may not have a touch screen but can be similar to a Pocket PC in other respects. For example, a Tablet PC may be portable and may allow for connectivity by external modem or other means. However, like a Pocket PC, a Tablet PC does not have an integrated telephony. Thus, addresses for receipt of communications by users of Tablet PCs are limited to email addresses or IM addresses or the like.

Still another communications channel relates to mobile communication devices (typically laptops, notebooks, and the like) which do not rely on mobile phone numbers for the “address” of electronic communications. Instead, they may utilize a username or other identifier as the “address” for receipt of electronic communications. For example, an embodiment of the hardware is the notebook PC of the type made by Dell Inc. of Round Rock, Tex. For example, an embodiment of the software is the Windows XP OS by Microsoft Corporation. Unlike mobile phones or smartphones, notebooks typically do not have integrated telephony. Thus, addresses for receipt of communications by users of notebooks are generally limited to email addresses or IM addresses or the like. Recently, many users of laptops and notebooks and the like have additional capabilities including Voice over IP (VoIP) using the internet connection. Yet, the VoIP does not support receipt of data communications, e.g. media and documents.

Heretofore, each communications channel was primarily designed for, and dependent on, particular protocol(s) of receiving communications. For example, desktop computers use email or IM protocols for receipt of communications regardless of the type of connection or network protocol. Laptops and notebooks computers receive communication using email or IM protocols for receipt of communications. More recently, desktops as well as laptops and notebooks can receive voice communications using VoIP. Tablet PCs and Pocket PC often have even less connectivity, and at best, are limited to the capability of laptops and notebooks. Mobile phones receive voice communications over a carrier's wireless network (e.g. GSM, TDMA, CDMA, PCS, traditional cellular, and so on) and can also receive SMS and MMS messages over a carrier's network but mobile phones did not receive email or IM messages except through applications such as an onboard web browser using wireless application protocol (WAP). Smart phones can receive voice communications and SMS and MMS messages over a carrier's network as well as receiving communications via email or IM protocols.

Examining smartphones with the Blackberry service, the prior teaches that connectivity is “universal” with respect to the BlackBerry Enterprise Server (BES) and the BlackBerry devices within the network in communication with the BES. For example, an organization with its own BES (or a hosted BES solution) can have devices on different carriers, and connected through different cellular network protocols, all functioning in an integrated fashion. In addition to push-mail, another feature is a Mobile Data Service (MDS) that enables encrypted data communications. Yet, a major limitation with this approach is that connectivity is limited to the devices within the network. Even if the BES server is configured to communicate with to mobile devices outside the network, that such a level of connectivity (including push-mail and MDS) is limited to BlackBerry devices. The prior art teaches away from inter-connectivity with non-BlackBerry devices.

Examining the wireless carriers, the prior art teaches that individual carrier's networks are built on varying protocols, e.g. GSM, CDMA, and so on. In addition, each carrier exerts extensive control over use of its network including each subscriber's voice and data communications. Carriers tend to resist development and adoption interoperable standards and protocols for communications. A major exception is SMS and MMS message protocols for which the wireless carriers have supported their development and adoption through participation in technical forums. MMS is represents an evolution of SMS from text to multimedia. Wireless carriers have adopted SMS and MMS messaging (rather than email or IM) as primary communications channel for sending and receiving data communications. Wireless carriers generally favor the SMS and MMS messaging protocols because they can charge substantial fees for transmitting data (both sending and receiving) through this communications channel (as opposed to email or IM for which carriers cannot exact such fees. Further, wireless carriers rely on the mobile phone number, e.g. 10digitnumber, as the primary address for sending and receiving data communications such that wireless carriers teach that a sender must know the cell phone number of each recipient to send a message to a cell phone as a SMS or MMS message (as opposed to knowing only a recipient's email which would enable a recipient to keep his or her actual cell phone number private).

The prior art teaches grouping of addresses of recipients of communications by a single communications channel, or to create, manage, and send messages to lists or groupings of addresses of a single class of devices. Earlier methods include applications (typically running on computers) or services (typically running on servers) that enable a user or users to create and manage lists or groupings of email addresses for use in distribution of email communications. One example of this method is embodied in a software program such as LISTSERV® Maestro made by L-Soft International Inc. of Landover, Md. Another example of this method is embodied in a list of IM buddies used by instant messaging software of the type made by Yahoo! or AOL. Earlier methods also include applications on smartphones that enable a user or users to create, manage, and send messages to lists or groupings of addresses of devices in the same network. An example of such a method is embodied in the BlackBerry® service offered by Research in Motion Ltd. In this example, a BlackBerry device may send a message to an address consisting of a BlackBerry PIN or to a ‘distribution list’ of such addresses. Yet, the BlackBerry service does not cross-channel communications in that a single ‘distribution list’ does not include email, BlackBerry PIN and mobile phone numbers. Earlier methods also include applications on mobile phones that enable a user or users to create and manage lists or groupings of 10digitnumber addresses for distribution of SMS or MMS communications to mobile phones. One example of such a method is embodied in the software such as that which creates, manages, and sends messages to a ‘distribution list’ on a mobile phone such as the MotoRazr V3m made by Motorola Inc. of Schaumburg, Ill. In this example, a ‘distribution list’ may comprise addresses corresponding to phone numbers, a voicemail box, and/or an email address. This ‘distribution list’ onboard a mobile phone represent the first example of lists of addresses with cross-channel communications but is still limited to two channels at a time: either a) SMS and email or b) MMS and email depending on the circumstances. However, this ‘distribution list’ does not allow selection of more than a single communication channel per recipient nor more than one address per recipient in the same communications channel unless a user employs a workaround—that is, manually inserting a recipient's name more than once in the list with a different address associated with each instance of the recipient's name.

Since applications onboard devices have limitations, web based applications and services represent other methods. An example of an earlier method for sending and receiving email is embodied in Eudora made by Qualcomm Inc. and Microsoft Outlook made by Microsoft Corp. Yet, these email programs do not run on many mobile devices such as mobile phones that have a different OS, e.g. Symbian. Also, the email address of a user is not typically the email address associated with a mobile phone, e.g. usernameNN@carrier.com and the carrier does not generally provide a straightforward means to retrieve the user's email that may stored on an out-of-network mail server, e.g. using POP3. Thus, users have difficulty receiving email on mobile phones. The prior art teaches a method to obtain email on any mobile phone using a third party to retrieve and send email to the user's mobile phone via a SMS message. This method is embodied in the forthcoming service at Teleflip.com offered by Teleflip Inc. of Hollywood, Calif. Yet, this service can only deliver messages using a single communications channel, namely cell phones, and is also limited to sending SMS or text messages (as opposed to MMS messaging). Also, the same service can be accomplished by having a user's email server forward a copy of the user's email to the email address assigned to the phone by the user's carrier and without the charge for SMS messaging.

The prior art teaches another method that addresses delivery of messages to a single communications channel comprising devices with BlackBerry service. This method uses by a 3^{rd} party to send messages to any mobile device with the BlackBerry service. This method is embodied in the service web2pin.com offered by Information Solutions, Inc of Oxford, Ga. Yet, this service can only deliver messages using a single communications channel, namely BlackBerry enabled devices.

Heretofore, the prior art does not teach a web based method or system to create and manage lists or groups of addresses that correspond to disparate communications channels. As discussed above, an example of a list having addresses that correspond to disparate communications channels would be a list containing both an email address and a mobile phone number. The prior art does not teach a method for sending messages to addresses that correspond to disparate communications channels. Thus, a long felt need is for systems or methods that enable a user or users to create a list of or group of disparate addresses and to send a message to all the addresses in the list or group of addresses regardless of whether the addresses correspond to disparate devices and/or disparate communications channels.

Mobile phones have heretofore been designed and used for multiple purposes. Mobiles phones are undoubtedly designed to be used for communication purposes. In addition, mobile phones are designed to be used for other purposes such as calculators, calendars, notepads, and games. Mobile phones are increasingly becoming the standard ‘device’ for mobile communications as well as many other purposes. The market for mobile phones is continuing to experience significant growth and appears to be merging with the market for PDAs such as the iPAQ made by Hewlett-Packard or the Treo made by Palm, Inc. As such, the most popular device of today and tomorrow is likely to be a mobile electronic device, e.g. mobile phone, that includes wireless communications including voice, email, IM, and so on plus other applications such as calendar, calculator, notes, navigation, and so on. Mobile devices can also function as a user's MP3 player or Podcast player or for playback of any type of media including movies, slideshows, and so on.

Thus, mobile devices will likely have at least a dual role comprising a communications device and a media device. As a communications device, a user's wishes to be able to send and receive messages regardless of the communications channel(s) enabled on the user's device. As a media device, advertisers and marketers wish to be able to send marketing messages to mobile users and receive feedback from them regardless of the communications channels(s) enabled on the user's device.

Heretofore, the prior art does not teach methods for distributing messages to addresses corresponding to all mobile users including disparate communication channels. In particular, with the sole exception of a ‘distribution list’ onboard a cell phone, no earlier method allows sending messages and receiving replies using disparate communications channels. No earlier method can send messages to a list of addresses corresponding to all of the following disparate communication channels including email, IM, SMS, MMS, BlackBerry ID, Sidekick, fax and/or VoIP. Further, the prior art does not show any method that satisfy a sender's desire to efficiently send messages to a list of addresses corresponding to disparate communication channels.

Heretofore, the prior art does not teach methods for collecting and validating addresses of mobile devices which are necessary for certain forms of mobile marketing. Mobile marketing can take varied forms including both advertising and direct marketing. Many companies are pursing advertising as initial approach to mobile marketing while others are pursuing direct marketing. The Mobile Marketing Association actively works to establish industry-wide, national and international codes of conduct, best practices and guidelines for mobile marketing.

A prerequisite to a mobile marketing campaign using direct marketing is having the mobile contact information, e.g. cell phone numbers and personal information about their users. Email addresses are insufficient for mobile marketing because most mobile devices are mobile phones and users of mobile phones do not check their email using mobile phones. Rather, most users of mobile devices utilize IM and text messaging (and recently MMS messaging).

One approach to collecting addresses would to purchase such subscriber information from wireless carriers. Yet, wireless carriers are restricted from selling such information. Thus, third parties may be not be able purchase such subscriber information directly from wireless carriers. In addition, reputable companies generally wish to avoid offending existing and prospective customers by sending unsolicited messages to their cell phones which may be perceived as ‘spam’. Thus, another approach is to independently collect the information from consumers similar to collection of email addresses. Many consumers are willing to give their email addresses as part of Internet promotions. For example, consumers may sign up on a company's website for a contest or other promotion. Similar to email, companies may collect mobile contact information (cell phone number, Blackberry ID, etc.) as part of a promotion.

Collecting the consumer's cell phone number may be done with or without registration provided the company's privacy policy appropriately addresses the collection and use of personal information. However, the practice of ‘formal’ registration is preferred for several reasons including validation of email address and subsequent updates of personal information. As part of a typical Internet registration process, a company in the business-to-consumer (B2C) market may request a consumer to submit an email address and other personal information one or more screens. An example of collection of information during the registration process is shown in Tables 1A and 1B below:

TABLE 1A
First Screen

<Introductory text, e.g. Please enter the following:>
Username*:
Password*:
Email*:
Confirm email*:

TABLE 1B
Second Screen

<Additional text, e.g. Registration near complete...>
Zip*:
Age:
Gender:
Current occupation:
Current education level: High school College
Post-graduate/Professional
Current residence: Rent Own
Current income level: $
.
.
.

If the company is in the business-to-business (B2B) market, the first and second screens would be modified to collect the user's title, company name, among other things. Yet, the registration process has lacked data entry fields to collect mobile devices for multiple communication channels such as mobile phone number, BlackBerry ID, Sidekick username, and so on.

### SUMMARY OF THE INVENTION

This invention relates to systems and methods for creating and managing lists of addresses of electronic devices, and in particular, methods and systems for creating and managing addresses corresponding to disparate communication channels, and sending messages to addresses that may correspond to disparate communication channels, and receiving replies via one of these communication channels.

An object of the present invention is a software application installed on a computer (as opposed to a web based service) for sending messages to multiple addresses some of which may correspond to disparate communication channels.

An object of the present invention is a web based or “online” service (as opposed to a software application installed on a computer) for sending messages to multiple addresses some of which may correspond to disparate communication channels.

An object of the present invention is to send a message to a list of addresses that may correspond to disparate communication channels. In one embodiment, the list of addresses may include multiple addresses of the same recipient but at least one of the addresses corresponds to a disparate communication channel. In another embodiment, the list of addresses may include addresses of different recipients wherein one or more of the addresses correspond to at least one disparate communication channel. In other embodiments, the list of addresses includes both multiple addresses for one recipient and addresses for other recipients wherein one or more of the addresses correspond to at least one disparate communication channel.

An object of the present invention is to send a message to a primary address of a recipient using one communications channel and to send the same message to another address of that recipient using a disparate communications channel. In one embodiment, a message is sent to recipient at multiple addresses in the same communication channel to ensure receipt of the message by the intended recipient in the event may be at more than one location, e.g. home versus work, at the time the message is sent. In another embodiment, a message is sent to recipient at multiple addresses that may correspond to disparate communication channels to ensure receipt of the message by the intended recipient in the event is mobile at the time the message is sent.

An object of the present invention is to receive replies to messages sent to addresses that may correspond to disparate communications channels. In one embodiment, the service could save replies to a message for subsequent viewing by the sender. In another embodiment, the service could forward replies to the same or a disparate communication channel. For example, a reply from a recipient of a MMS message coming from a mobile phone may be forwarded to the sender of the MMS message by MMS message or by email or by another communication channel.

An object of the present invention is to forward an incoming message to an address corresponding to another communications channel. In contrast to email forwarding which is limited to a single channel, an embodiment of the present invention includes forwarding a SMS or MMS message to an email or an email to a SMS or MMS message. In another embodiment, the invention includes relaying a SMS or MMS message received from a mobile phone to another mobile phone.

Still another object of the present invention is to archive messages by sending a copy of incoming and/or outgoing messages to a repository using a predetermined address corresponding to a communications channel.

Still another object of the present invention is a registration process for collecting addresses of mobile devices including mobile phones. For example, a registration process could include a data entry form for collecting a mobile phone number, a Blackberry ID, a Sidekick username, and so on. To collect mobile contact information, the first screen would also include a webform field for cell phone number and the second screen may have additional webform fields. The additional fields may be optional (without an asterisk) or required (with an asterisk). Typically, if a user enters an address for a particular communication channel, e.g. mobile phones, then the user typically enters the address again to confirm the accuracy of the address. An example of the registration fields is shown in Tables 2A and 2B below:

TABLE 2A
First Screen

Username*:
Password*:
<optional text>
Confirm Password*:
<optional text, e.g. Do you wish to receive messages
via your mobile phone?>
Mobile phone number*:
Confirm mobile number*:
<optional text, e.g. Enter your carrier and device information>
Wireless carrier:
Handheld device:
<optional text, e.g. Do you wish to receive messages
via your BlackBerry?>
Blackberry PIN or username:
Confirm Blackberry PIN or username:
<optional text, e.g. Do you wish to receive messages
via your Sidekick?>
Sidekick username:
Confirm Blackberry PIN or username:

TABLE 2B
Second Screen

<optional text, e.g. registration near complete>
Zip*:
Age:
Gender:
Current occupation:
Current education level: High school College
Post-graduate or Professional
Current residence: Rent Own
Current income level: .
.
.
.

Similar to validation of an email address by sending an email to the address for verification and/or account activation, the process may validate a mobile phone number by sending a message to the mobile device, e.g. mobile phone. The message sent to the mobile device may request a user to reply in order to confirm validity and/or ownership/control of the mobile address to complete the validation of the address. Validation of the address may or may not be required to complete the signup and/or registration processes. Typically, the signup or registration processes would require validation prior to sending messages to the address. In addition, the message sent the mobile device may request user to reply with a code that identifies the user's device, OS, browser, and/or other device parameters. In this way, the user can also confirm the model of the mobile device and other device parameters specific to a user.

If the data entry process is a registration process rather than a signup process, a user may provide one or more addresses. Validation of each address may or may not occur prior to account activation. For example, a user may already have an active account when the user is prompted to update the account to include a mobile address. In this way, the user can access the online website prior to completing validation of each address.

Even without a specific promotion used to collect mobile phone number on via a web based interface, a company may collect a mobile phone number from existing and prospective customers for whom the company has email addresses since customers may have consented to receipt of emails. The company may simply send these customers an email inquiring whether the recipient is interested in receiving information via their mobile phone. See example Table 3 below.

TABLE 3
Example of Inquiry to Customer

To: <username>@domainname.com
From: <noreply>@yourcompany.com
Subject: Get on your Mobile Phone
Dear Customer:
Are you interested in receiving product information on
your mobile phone? If so, click the following link and
enter your mobile contact information, e.g. cell phone number. Thank you.
https://www.yourcompany.com/query? . . .

After consumers have provided mobile contact information, e.g. mobile phone number, to the company, the company may begin a mobile marketing campaign. The company may also use the mobile phone number (or continue to use email) to send message having varied purposes including content delivery, promotions and reminding customers to update account information.

Still another object of the present invention is a registration process for validating addresses of mobile devices including mobile phones. For example, a registration process could send a message to the address of the mobile device to validate the address entered during the registration process.

Another object of the present invention is to make any mobile device a vehicle for delivery of messages in any form, e.g. text, audio, video, multimedia, and so on, and in particular for delivery of marketing messages, video advertising and/or advertising media. In the preferred embodiment of the invention, the media file is sent to the mobile devices as a single file. For example, both the video and audio tracks may be sent in a single file such as a 3GP or a MP4 file using multipart MIME complaint code that may include HTML or SGML without the need to use SMIL. In another embodiment, the media file is sent to mobile devices as separate files. For example, the video file and audio file may be sent as separate files and synchronized upon delivery using code that may or may not include SMIL.

Another object of the present invention is to convert video, audio and other media files to the file format necessary to reach all mobile phones regardless of the particular carrier or particular device type. An embodiment of the invention includes conversion of media to a format that will be accepted by carriers and sent to mobile phones as one or more MMS messages. A wireless carrier typically requires media files in a particular format for delivery to mobile devices such as mobile phones. Also, the media files, e.g. video, may require varied formats. No single media format is compatible with every mobile device and/or every carrier's wireless network. However, wireless carriers generally accept media files in or more common formats, and if necessary, process the files prior to delivery to the mobile phone. Further, each carrier's wireless network may have limitations on media files specific to that network, e.g. maximum file size in megabytes and/or duration in seconds. Thus, the size of the file may need to be limited to a maximum size, e.g. 15-sec, 30-sec, or 60-sec video to reach the mobile phone.

As stated above, in order to be accepted by a wireless carrier and delivered through its MMS gateway to a mobile phone, a multimedia message generally needs to be sent in a multipart MIME compliant email or the like. The multipart MIME compliant email can include text and pictures, text and picture and audio, text and video, and so on. In one embodiment, the message is sent using the built-in PHP function mail( ). In another embodiment, the message is sent using a function sendmail( ) or the like. I another embodiment, the message is sent using a mail exchange server that may be available as a COTS server, e.g. Microsoft enterprise server, BlackBerry enterprise server, etc. or may be a custom mail server. In still another embodiment, the message is sent using a mail client application that may be available as a COTS application or may be a custom application. In yet still another embodiment, the message is sent using a plug-in or add-in to another application such as a browser, instant messenger, player, reader, or so on.

One complication is that the wrapper and/or codecs of media files uploaded by users may be unacceptable to gateways of wireless carriers. Thus, prior to a user sending multimedia message that includes a media file, that media file may have to be converted to a format or codex that can be accepted by wireless carriers. Another complication is that the wireless carrier of each recipient is not known. A solution is to convert the media files to a format or codex that is common to all wireless carriers such that is will be accepted by all wireless carriers. An example of an audio format or codex that is commonly accepted by wireless carriers is AAC. An example of a video format or codex that is commonly accepted by wireless carriers is H.264. Still another complication is that the capability of recipient devices to play media formats is not uniform. Fortunately, if the media file is accepted, wireless carriers will process the audio and video files, e.g. downsampling or transcoding, prior to delivery to the mobile phones. Thus, prior to a user sending a multimedia message, the media file would ideally be converted to the highest quality format or codex that is common to all wireless carriers. Examples of media formats or codex that are accepted by one or more wireless carriers are shown in Table 4 below:

TABLE 4
Examples of Media Formats or Codex for Mobile Phones

| Audio | Video |
|---|---|
| AAC | H.263 |
| AMR | H.264 |
| AWB | MPEG4 |

As a further complication, the audio and video files need to be inserted in a wrapper to be accepted by the wireless carriers. In one embodiment these media files can be inserted into a wrapper such as a 3gp for delivery to cell phones. For example, the multipart MIME compliant email would have at least one part that is content-type=video/3gp. Several examples of MIME types that are supported by one or more mobile phones and/or networks are shown below in Table 5 below:

TABLE 5
Examples of MIME Types for Mobile Phones

| Type/sub-type | Extension |
|---|---|
| audio/amr | amr |
| audio/mid | mid |
| audio/mp3 | mp3 |
| video/wmv | wmv |
| video/3gpp | 3gp |
| video/3gpp2 | 3g2 |

### BRIEF DESCRIPTION OF THE DRAWINGS

FIG. 1A is a flowchart of mutually exclusive processes for sending a message to one or more addresses within a single communication channel.

FIG. 1B is a flowchart of a process for sending mail via TELNET using SMTP commands.

FIGS. 2A through 2E are screen layouts of alternative data entry forms for signup and/or registration processes.

FIG. 3A is diagram of a list of email addresses generated from a signup process and

FIG. 3B is a diagram of a list of mobile phone numbers generated from a signup process.

FIGS. 3C and 3D are alternative diagrams of data records generated from a signup process.

FIGS. 3E and 3F are alternative diagrams of data records generated from a user registration process.

FIGS. 4A, 4B, and 4C are flowcharts of processes (and subprocesses) for pre-determining a wrapper and codecs for media; pre-determining a multimedia message template; and pre-determining domains for addresses.

FIGS. 5A through 5G are flowcharts of alternative processes (and subprocesses) for sending a message to one or more addresses that correspond to disparate communication channels.

FIG. 6A is flowchart of a subprocess for pushing a message to an email address.

FIG. 6B is flowchart of a subprocess for pushing a message to a mobile phone.

FIG. 6C is flowchart of a subprocess for pushing a message to a BlackBerry.

FIG. 6D is flowchart of a subprocess for pushing a message to a Sidekick.

FIG. 6E is flowchart of a generalized subprocess for pushing a message to one or more addresses corresponding to a communication channel.

FIGS. 6F and 6G are flowcharts of streamlined subprocesses for pushing a message to one or more addresses based on pre-determined wrapper and codecs.

FIG. 7A is a flowchart of a subprocess for determining a wrapper.

FIG. 7B is a flowchart of a subprocess for selecting a common format for each media component.

FIG. 7C is a flowchart of a subprocess for determining the domain name or gateway corresponding to recipient's address.

FIG. 7D is a flowchart of a subprocess for determining if an address is deliverable at a domain or gateway.

FIG. 7E is a flowchart of a subprocess for preparing a multimedia message.

FIGS. 8A through 8F are screen layouts of alternative data entry forms for signup and/or registration processes that may include addresses that may correspond to disparate communication channels.

FIG. 9A is diagram of a list of addresses generated from a signup process and FIG. 9B is a diagram of data records generated from a signup process with each record having one or more addresses that may correspond to disparate communication channels.

FIGS. 9C through 9G are alternative diagrams of data records generated from a signup process including a validation process. FIG. 9H is an alternative diagram of data records generated from a signup process with each record having one or more addresses that may correspond to disparate communication channels.

FIGS. 9I, 9J and 9K are alternative diagrams of data records generated from a user registration process.

FIGS. 10A and 10B are alternative diagrams of data records generated from one or more processes that verify deliverability of a message to an address(es).

FIGS. 11A and 11B are plan views of a mobile phone's display and user interface showing alternative objects in the display area.

FIGS. 12A and 12B are schematic drawings of alternative circuits of mobile devices.

FIGS. 13A, 13B, and 13C are schematic drawings of alternative circuits of other electronic devices including stationary electronic devices.

FIGS. 14A through 14D are perspective drawings of alternative mobile devices.

FIG. 14E is a perspective drawing of a stationary electronic device.

FIGS. 15A, 15B and 15C are schematic drawings of alternative networks for mobile devices.

FIGS. 15D and 15E are schematic drawings of alternative networks for other electronic devices.

FIG. 16 is a schematic drawing of server(s) connected through one or more networks to one or more devices.

### DETAILED DESCRIPTION OF THE INVENTION

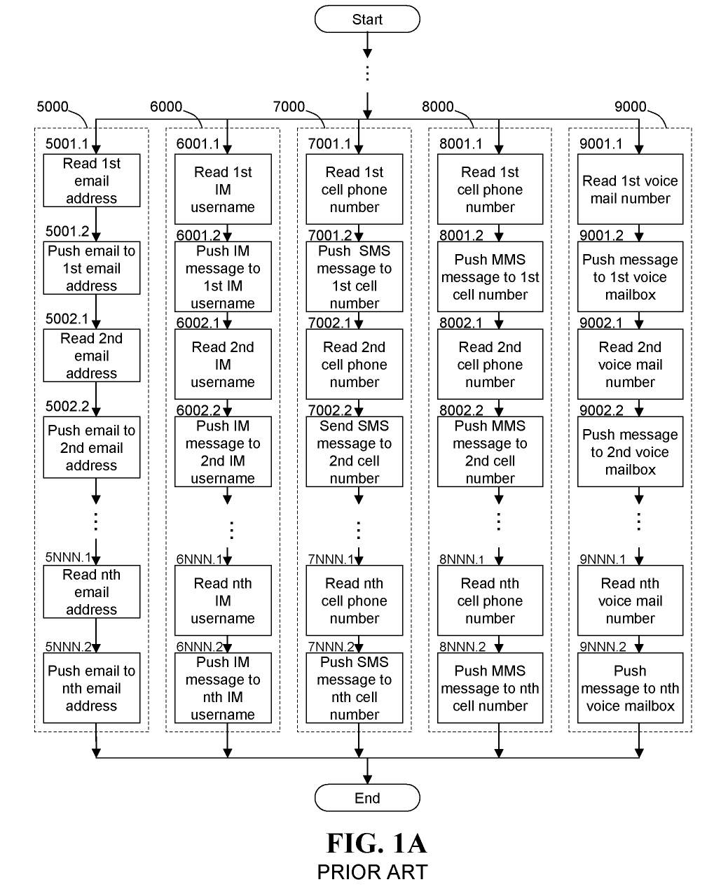

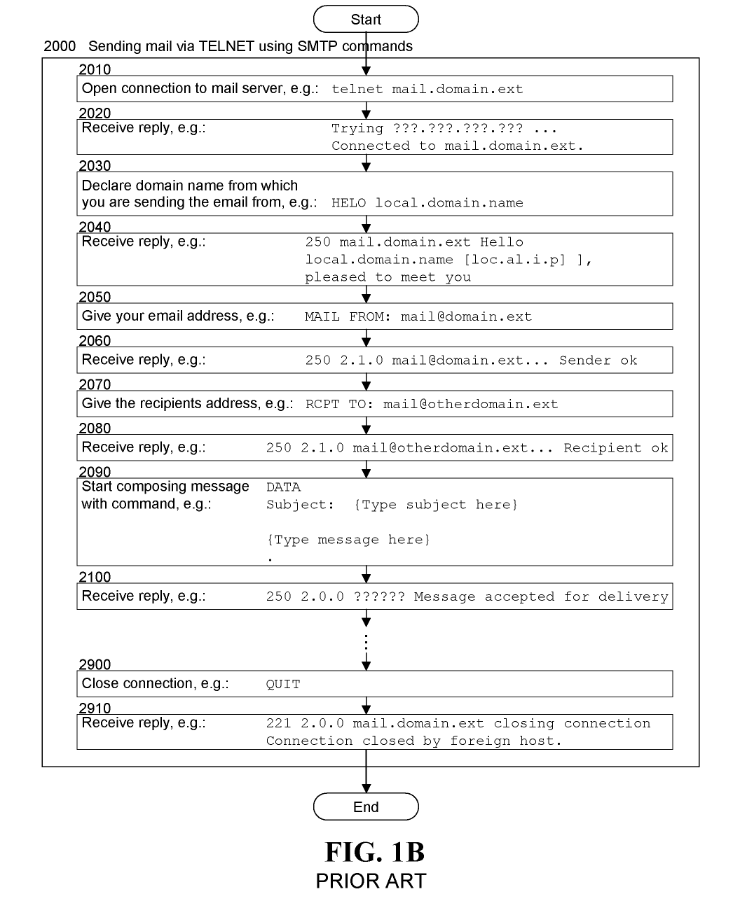

With reference to FIG. 1 through FIG. 9, processes and subprocesses are depicted by boxes having either solid, phantom or dashed lines. Required steps in these processes or subprocesses are generally depicted by boxes having solid lines. Alternative and/or additional steps are generally depicted as boxes having phantom lines. Steps having substeps detailed in a separate figure are generally shown as dashed lines.

FIG. 1A describes methods in the prior art wherein mutually exclusive processes 5000 through 9000 for sending a message to one or more addresses within a single communication channel. Each of these mutually exclusive processes corresponds to a different communication channel. Each method has a first step N001.1 of reading an address and a second step N001.2 of sending the message to that address. Each method may also have a third step N002.1 of reading a second address in the same communication channel and fourth step N002.2 of sending the message to that address. Each method may have additional steps NNNN.1 and NNNN.2 of sequentially reading from a list of addresses in the same communication channel and sending the message to those addresses. For example, a process 5000 corresponds to a single communication channel that comprises email messaging. Another process 6000 corresponds to a single communication channel that comprises IM messaging. Still another process 7000 corresponds to a single communication channel that comprises SMS messaging. Still another process 8000 corresponds to a single communication channel that comprises MMS messaging. Still another process 9000 may correspond to a single communication channel that comprises voice mail communications. Yet still another process may be a single communication channel that comprises fax communications. In contrast, the only method in the prior art which sends messages to multiple communication channels is the method of the ‘distribution list’ onboard certain mobile phones. Such existing method includes email as an alternative channel to MMS in the event that sender does not have the mobile phone number for a recipient or the recipient's phone can not receive MMS messages.

FIG. 1B describes a method in the prior art for sending a message via telnet using SMTP. The method includes the steps of 2010 through 2100. The method has preliminary steps 2010 through 2080 prior to the step 2090 of composing the message and a subsequent step 2900 to close the connection. This method does not teach how to send messages to disparate communication channels or even how to send messages for cross-platform delivery within a single communication channel.

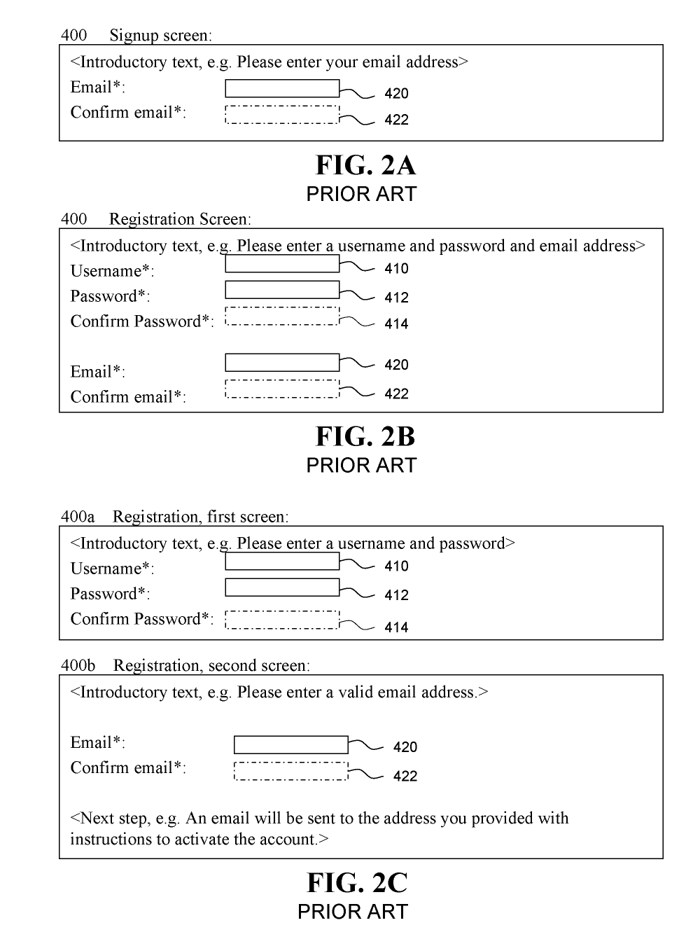

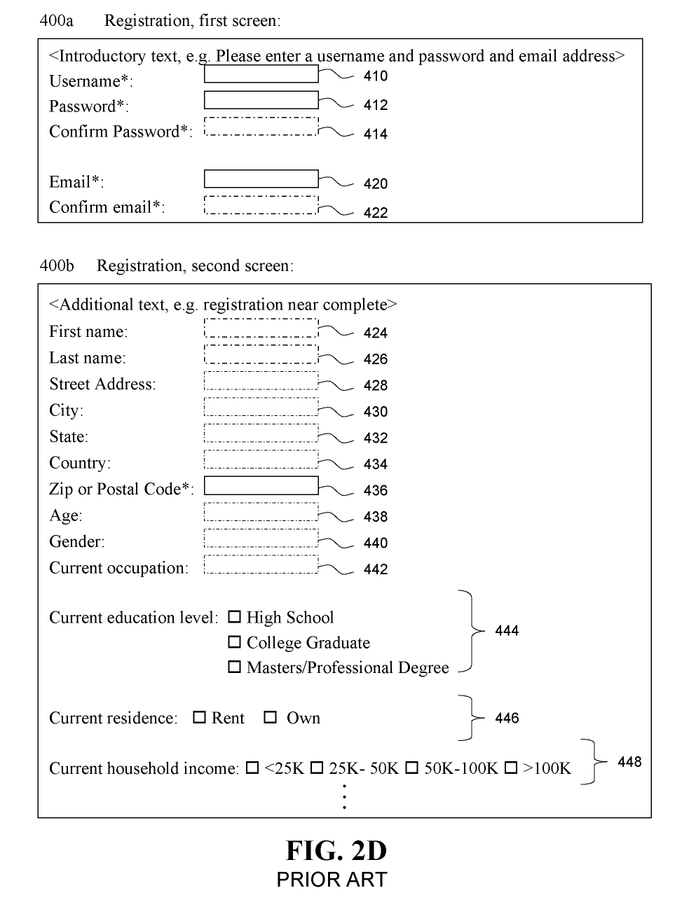

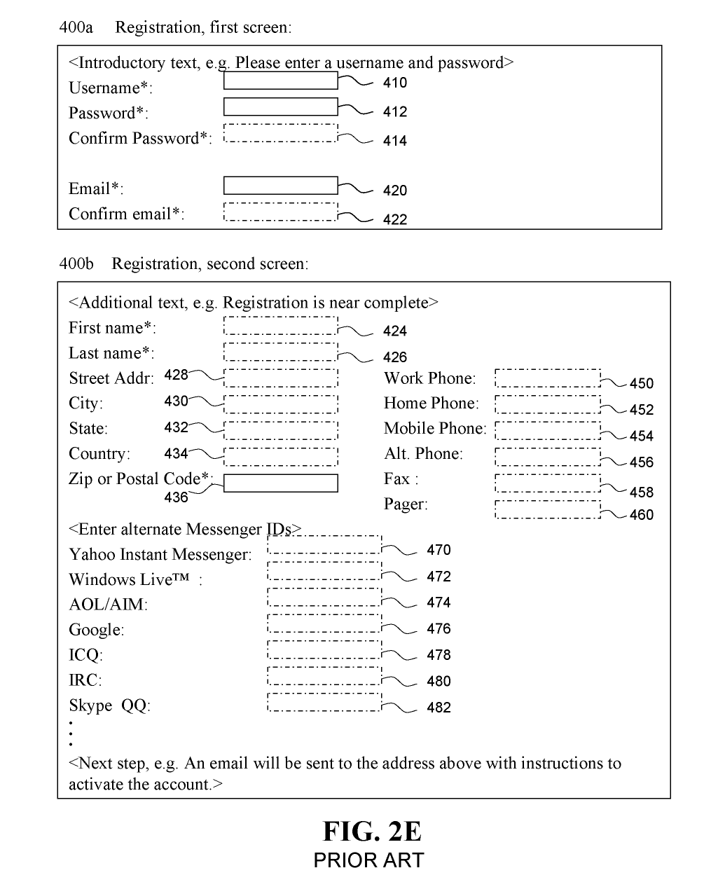

FIG. 2A describes a screen layout of a data entry form in the prior art for a user signup process without establishing an account having a username and/or password. As part of the signup process, a message is typically sent to the email address which requests the recipient to validate the email address. Typically, the user may be asked to click through a link to validate the email. FIG. 2A shows a very simple layout for a signup process having a single screen 400. For example, the data entry form for a simple signup process may have only a data element 420 for entry of the email address and optionally a data element 422 for a duplicate entry of the email address to confirm the accuracy of data entry of the email address. FIG. 2B through FIG. 2E describe screen layouts of alternative data entry forms in the prior art for a user registration process. As part of the registration process, a message is typically sent to the email address (or mobile phone number) which requests the recipient to validate the email address (or mobile phone number). FIG. 2B shows a very simple layout for a registration process having a single screen 400. FIG. 2C through FIG. 2E show more elaborate layouts for registration processes having at least two screens 400a and 400b. In FIGS. 2B and 2C, the data entry forms have at least data elements 410, 412, and 420 and may have optional data elements 414 and 422 for verifying accuracy of data entry of the password and email address. In FIGS. 2D and 2E, the data entry forms have more data elements which may include data elements 424 through 4NN. No data entry form in the prior art has a data element for a BlackBerry ID, Sidekick username, or other addresses for mobile phones in addition to a mobile phone number.

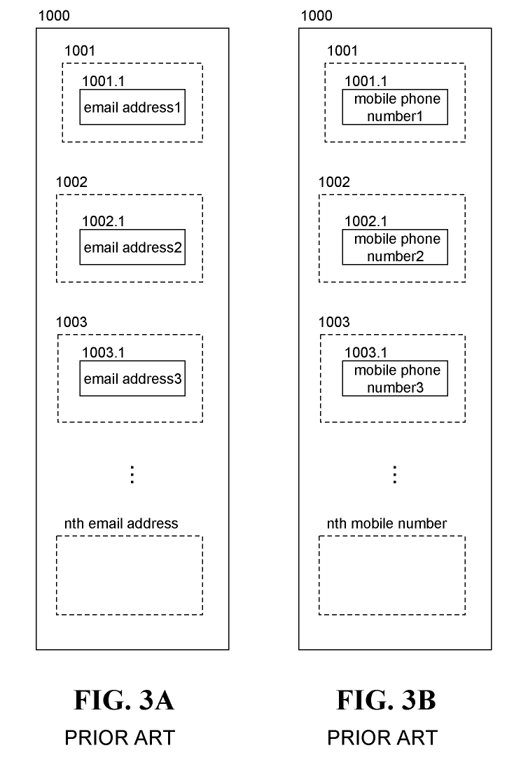

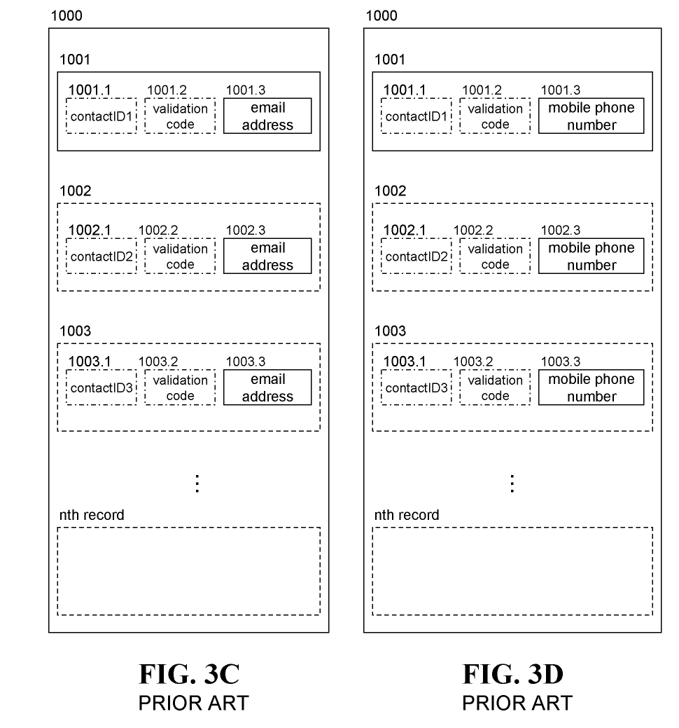

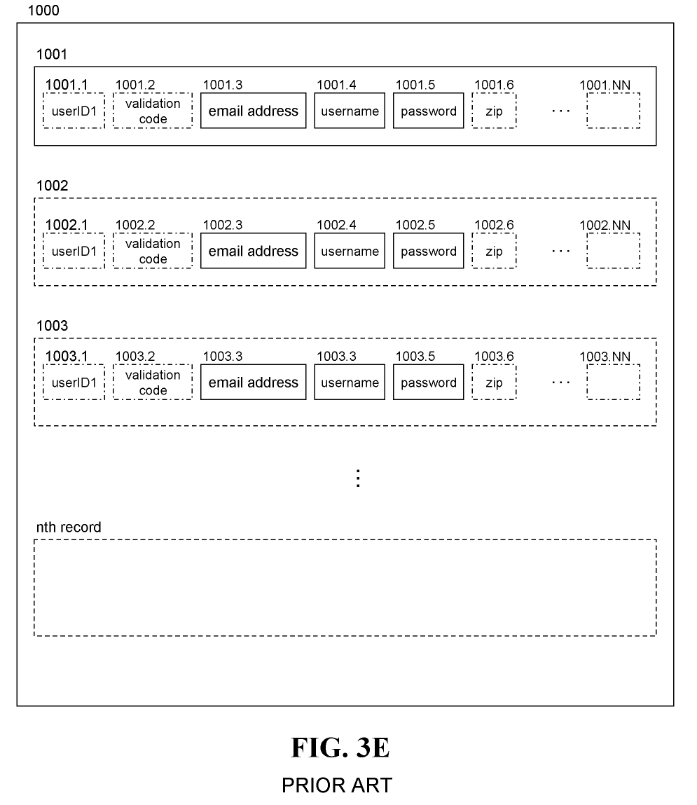

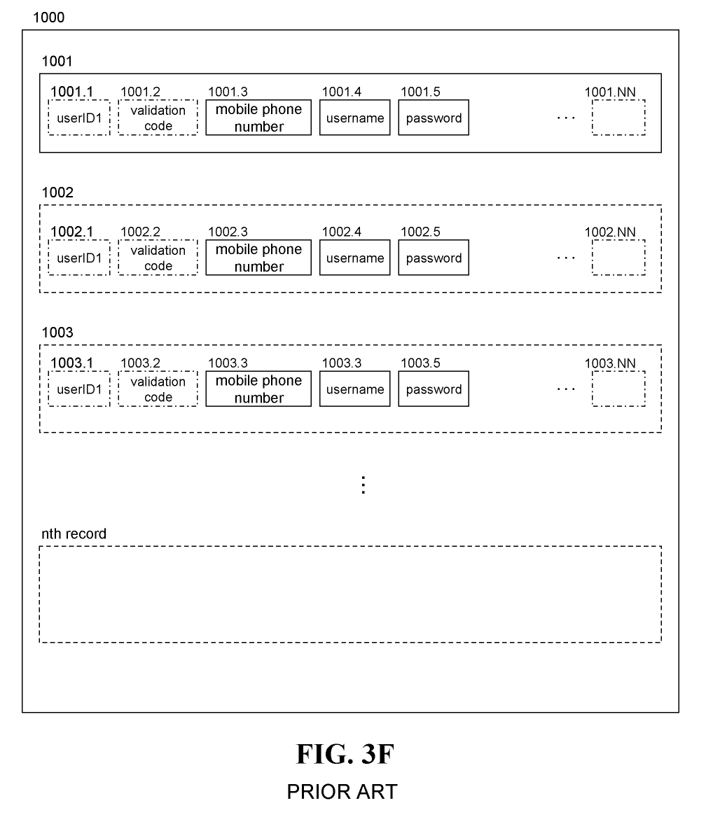

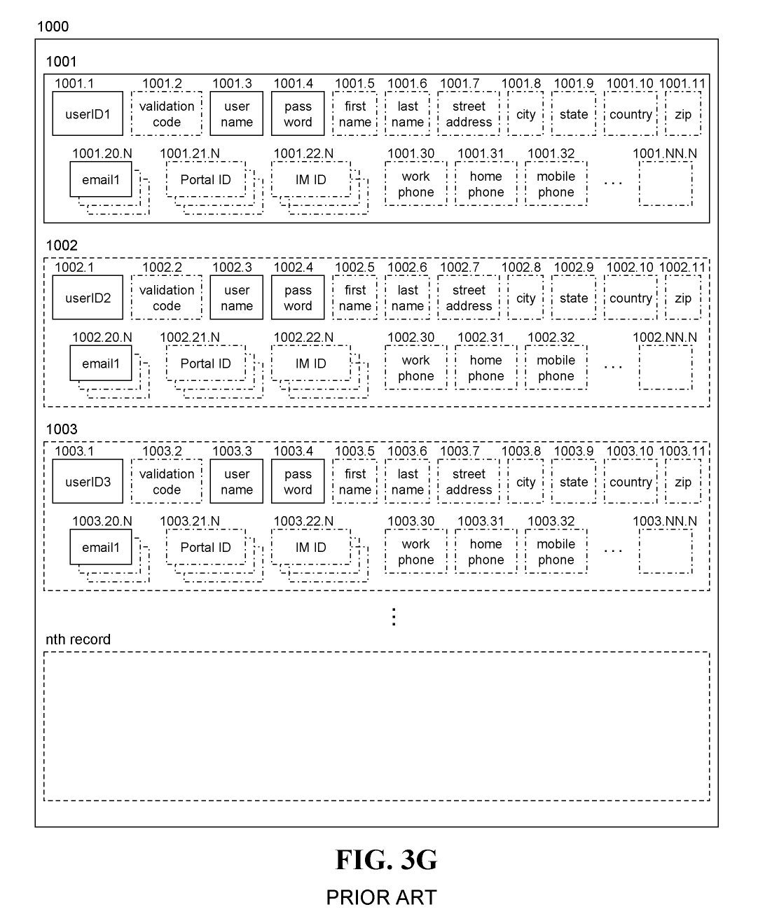

FIGS. 3A through 3G describes a method in the prior art for storing contact information and/or user account information. FIG. 3A describes a method in the prior art for storing email addresses. In one embodiment, the method describes a list 1000 of email addresses 1001, 1002, 1003, . . . , nth email address. In another embodiment, the method describes email addresses stored in a text file containing a series of alphanumeric sequences separated by commas or other delimiters. FIG. 3B describes a method in the prior art for storing mobile phone numbers. In one embodiment, the method describes a distribution list 1000 of mobile phone numbers 1001, 1002, 1003, . . . , nth phone number. FIGS. 3C and 3D describe methods for storing email addresses or mobile phone numbers, respectively, as a data element in records 1001, 1002, 1003, . . . , nth record, in a datatable 1000 without data elements for a username and/or password. FIGS. 3E and 3F describe methods for storing email addresses or mobile phone numbers, respectively, as a data element in records 1001, 1002, 1003, . . . , nth record, in a datatable 1000 that include data elements for a username and/or password. FIGS. 3G and 3H describe methods for storing user account information in multiple data elements including username, password, email address, work phone, zip code, and so on, as data elements in records 1001, 1002, 1003, . . . , nth record, in a datatable 1000. Methods in the prior art may have more data elements. For example, a method in the prior art has data elements 1NNN.21.1 through 1NNN.21.N representing one or more portal IDs such the Yahoo ID. For example, another method in the prior art has data elements 1NNN.22.1 through 1NNN.22.N representing one or more IM IDs such as the AIM service offered by America Online. Methods in the prior art may teach methods of storing large numbers (>1,000,000) of data records but these methods teach only a finite number of data elements in each record. However, other than mobile phone number and page numbers, prior art does not teach a method that includes data elements for mobile devices such as BlackBerrys, Sidekicks, and so on.

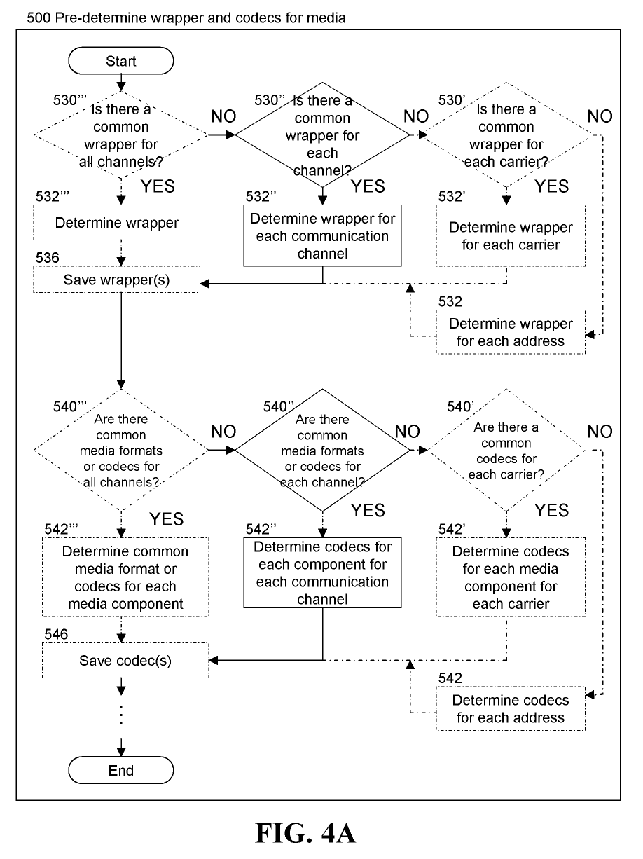

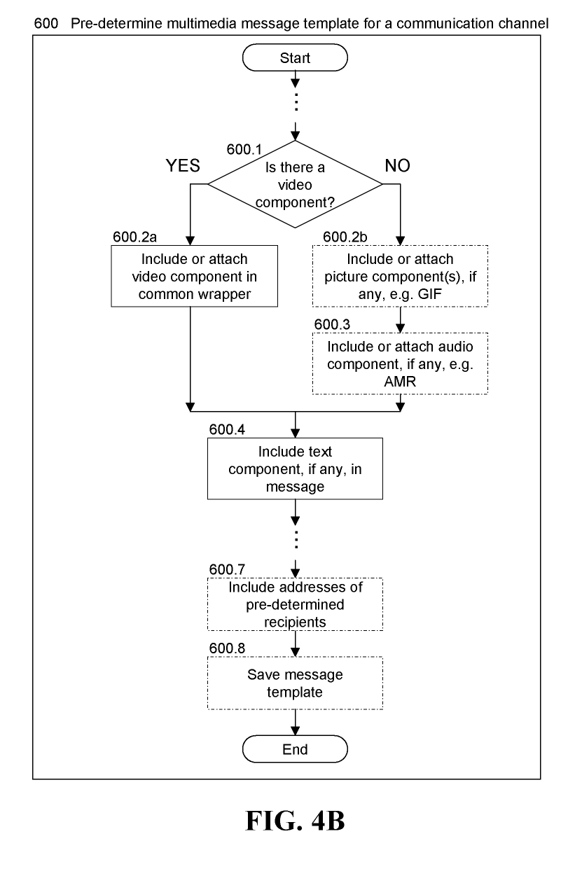

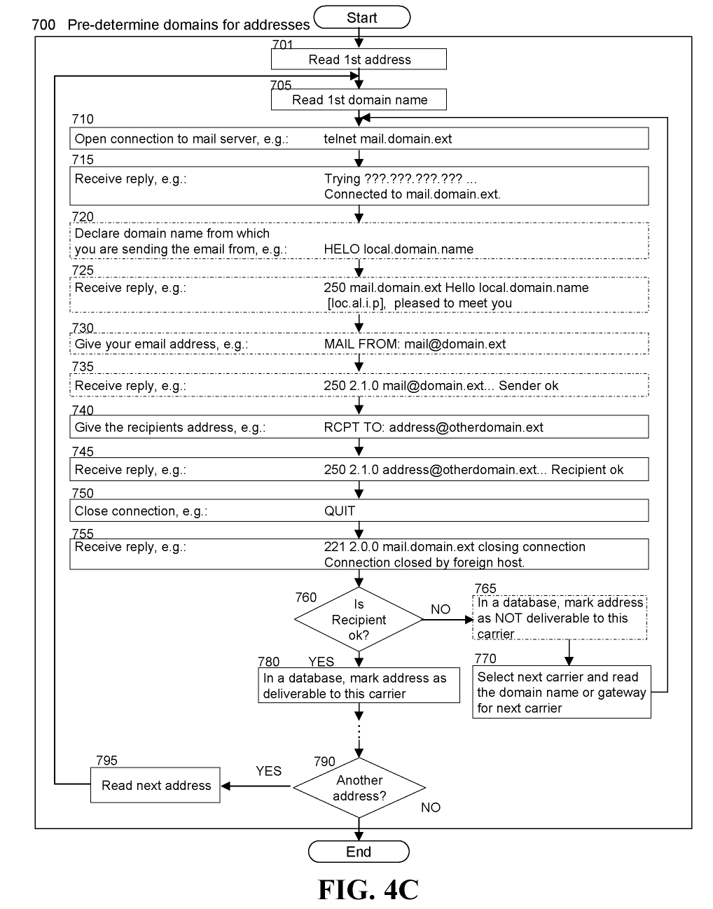

FIG. 4A describes a process 500 (and subprocesses) for pre-determining a wrapper and selecting a format or codec for each media component. In one embodiment, FIG. 4A describes the process as having at least the steps of 532″ determining a common wrapper and the step 542″ of determining common media format or codec for each media component for each communication channel. For example, in the context of mobile phones, the wrapper may be carrier independent, and thus, a single wrapper, e.g. 3GP, may be suitable for cross-platform delivery of messages to mobile phones even if the MIME type used to describe the content type of the wrapper varies, e.g. video/3gp vs. video/3gpp vs. video/3gpp2. The process 500 may have the preliminary step 530″ of assessing whether a common wrapper exists for each communication channel and a preliminary step 540″ of assessing whether common codecs exist for each communication channel. In another embodiment, FIG. 4A describes the process having the alternative step 532′ of determining a wrapper for each carrier and the alternative step 542′ of determining a format or codec for each media component for each carrier. In still another embodiment, the process describes the preliminary step 530′ of assessing if there exists a common wrapper for the carrier and step 542′ of assessing if there exists common media formats or codecs for the carrier. In still other embodiments, process having the alternative step 532 of determining a wrapper for each individual address and the alternative step 542 of determining a format or codec for each media component for each individual address.

FIG. 4B describes a process 600 (and subprocessess) for pre-determining a multimedia message template for a communication channel. In one embodiment, FIG. 4B describes the process 600 as having a step 600.1 of assessing whether there is a video component and a step 600.2a of including or attaching the video component in the common wrapper for the communication channel. In one embodiment, the video component is transcoded from its native format or codec. In another embodiment, the video component is included or attached without transcoding. The process 600 may include alternative steps 600.2b and/or 600.3 of including or attaching a picture and/or audio components. The process may also include additional steps 600.4 of including a text component, among other steps. For example, the process may include the additional step 600.7 of including one or more address(es) of predetermined recipients and/or the step 600.8 of saving the message template for later use.

FIG. 4C describes a process 700 to predetermining the domain name or gateway at which a message is deliverable. In one embodiment for a single address, the process includes the steps 701, 705, 710, 715, 740, 745, 750, 755, 760, 770, and 780. In another embodiment for multiple addresses, the process includes the additional steps 790 and 795. Step 705 reads the first domain name or gateway to verify deliverability. For example, the domain name or gateway may be looked up in SMS/MMS address registry 4000. Steps 710 and 715 establish a network connection to domain or gateway. Steps 740 and 745 verify deliverability to a particular address at a particular domain or gateway. Steps 760 and 780 record in a database if message is deliverable to the particular address. In the preferred embodiment, the address is an address registry 4000 comprising records of addresses and domain names or gateways. In other embodiments, the process 700 includes additional steps 720, 725, 730, and 735. In still another embodiment, the process 700 has an optional step 765 for marking in database if message is not deliverable to an address. In the context of mobile phones, the domain name of correct carrier to deliver a message may be identified using one of the embodiments of this process. More significantly, the process allows the domain name to be determined one time for each address and the address and corresponding domain name stored in a phone number datatable 3500 or other database. One embodiment would have steps 705 and 770 read domain names or gateways in alphabetical order. Another embodiment would have steps 705 and 770 read domain names or gateways in order of the largest to smallest subscriber base of a carrier. Still another embodiment would have steps 705 and 770 read domain names or gateways in an arbitrary or random order. Yet still another embodiment would have step 705 read domain name of the original carrier to which that address was assigned. For example, when checking a particular mobile phone number, e.g. 760-641-XXXX, the step 705 could read domain name or gateway for the carrier, e.g. Sprint, to which the number was originally assigned based on the area code and prefix. And yet still another embodiment would have step 705 read the domain name of the carrier supplied by a user during a registration process when the user establishes a user account. Due to portability of certain addresses, e.g. mobile phone numbers, the process may be repeated periodically to update domain names or gateways for each address. When updating a domain name, one embodiment would have step 705 read the domain name or gateway of the user's existing carrier from the record in user datatable 3000 rather than domain name of the first carrier in the SMS/MMS address registry 4000. Thus, the process can be made more efficient by selecting an optimal domain name or gateway at the start the process.

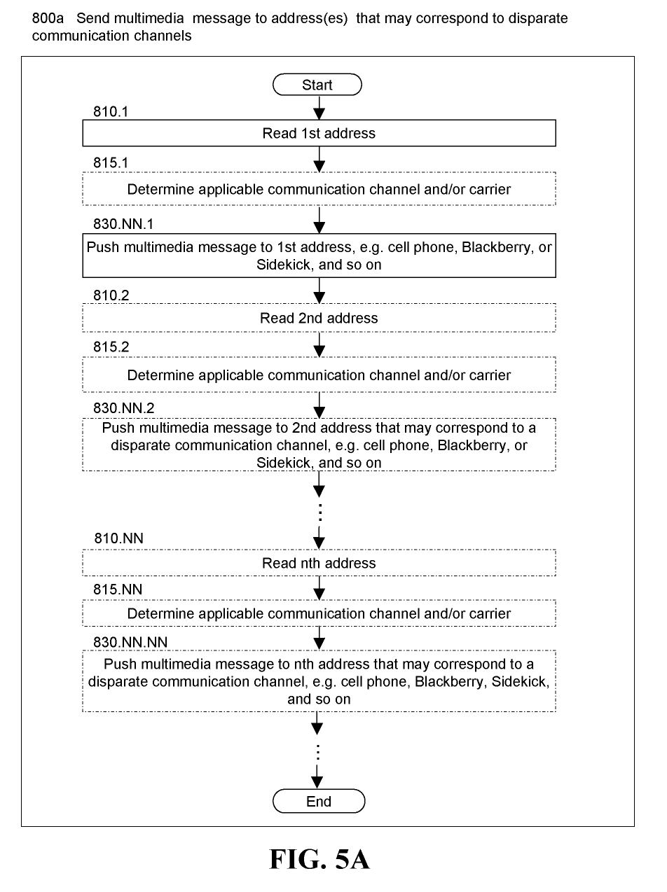

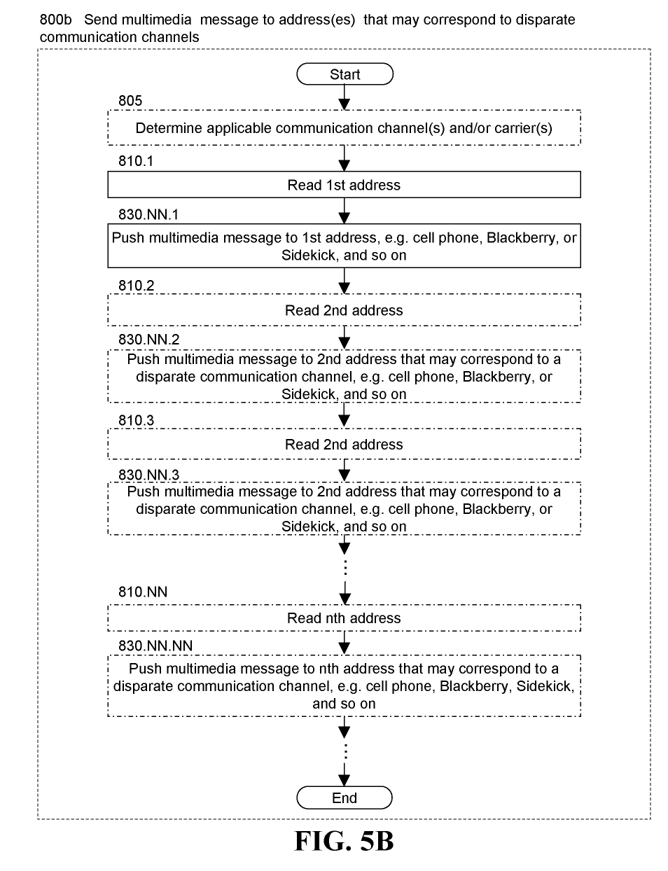

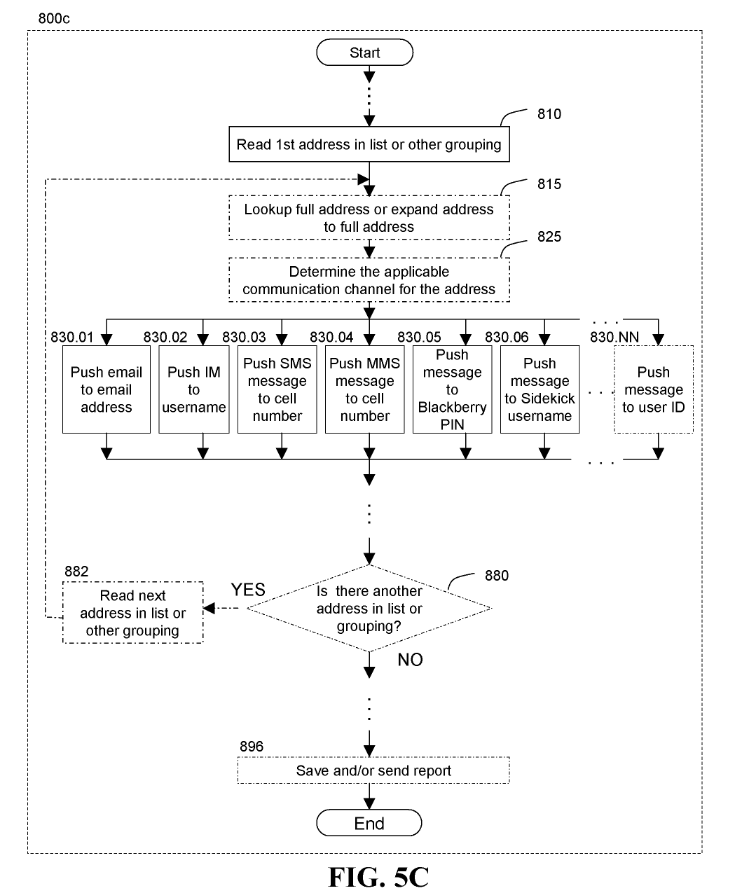

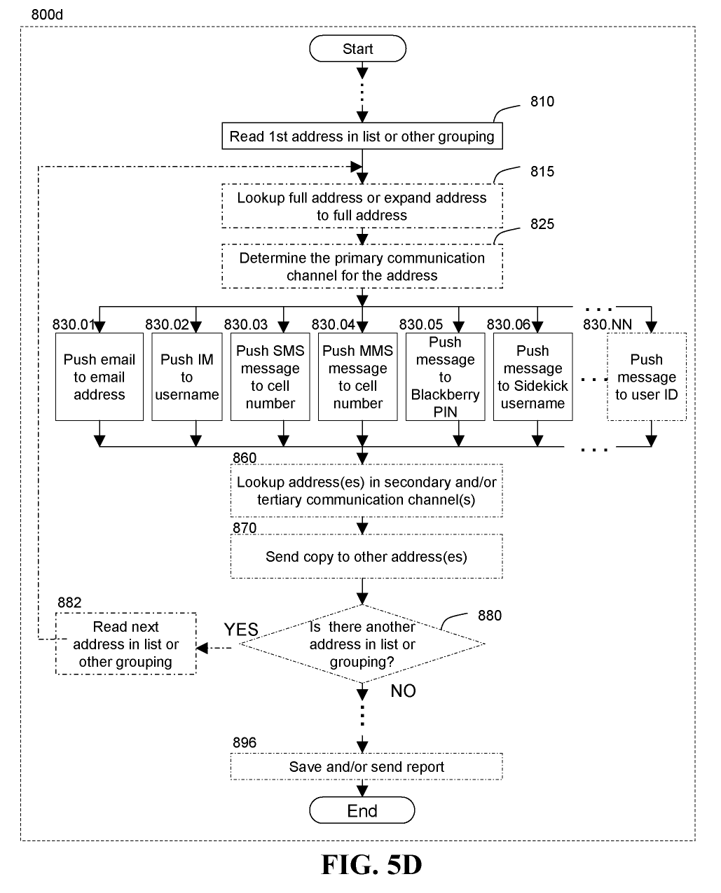

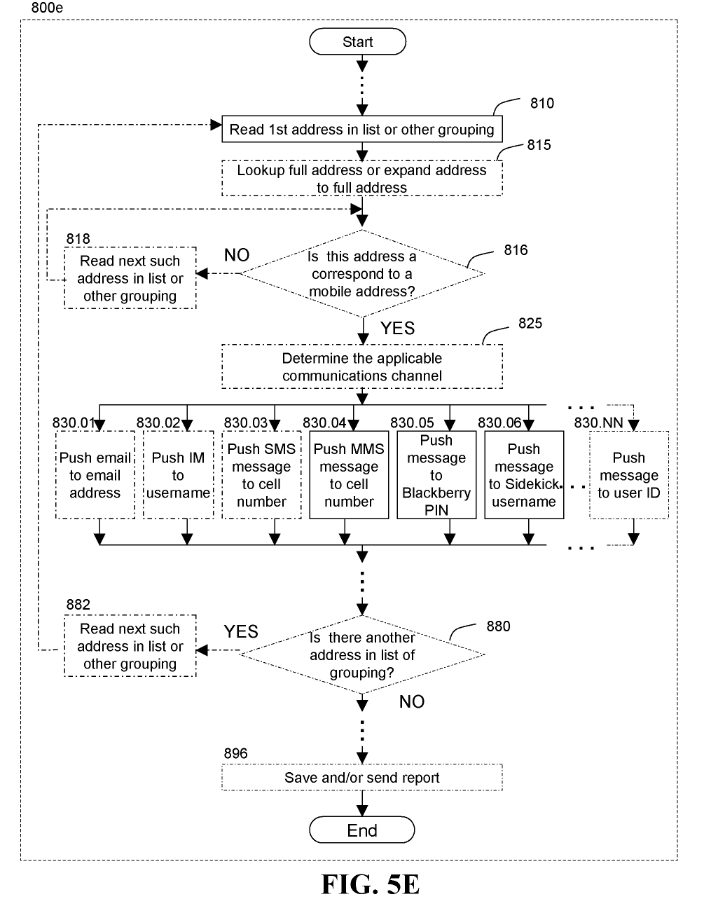

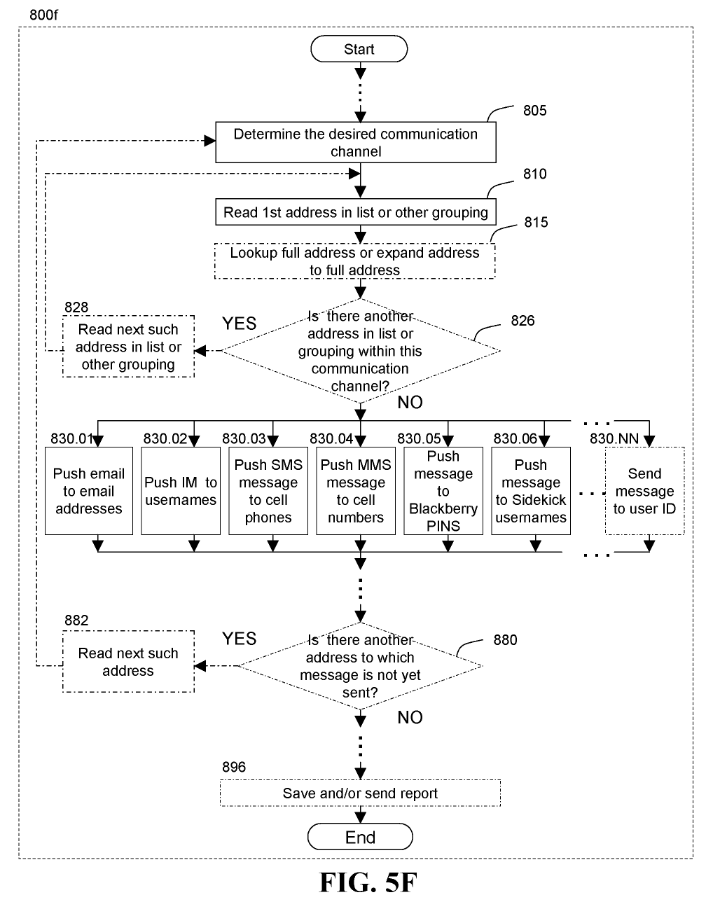

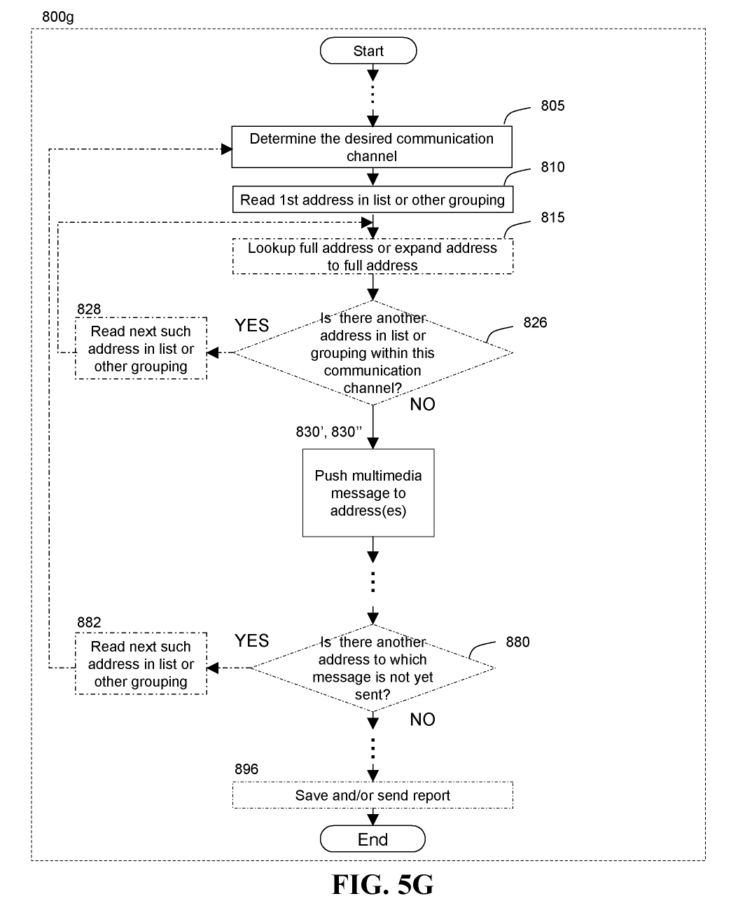

FIGS. 5A through 5G describe alternative processes 800a through 800g, respectively, and their subprocesses for sending a message to one or more addresses that correspond to one or more disparate communication channels including but not limited to voicemail, facsimile transmission, pager, email, IM, SMS, MMS, BlackBerry ID, Sidekick username, other IDs or usernames, and so on. For example, one communication channel is MMS messaging. Another example of a communication channel is messaging to Blackberry devices. Another example of a communication channel is messaging to Sidekick devices. Still another example of a communication channel is messaging via email. Still another example of a communication channel is messaging via voice mail. Yet still other examples of communication channels are IM, paging, satellite, radio, WiFi, NFC, and so on. Yet another communication channel is combination of communication channels or a hybrid communication channel. In the preferred embodiment, the communication channel is a combination of disparate communication channels that includes at least MMS messaging and may also include messaging to BlackBerry devices and messaging to other devices via email. For example, a service prepares a MIME compliant email to send via the internet to addresses that include the domain or gateway of one or more carriers who in turn deliver the message using MMS messaging.

FIGS. 5A and 5B describe a processes 800a and 800b for sending a multimedia message to one or more addresses that may comprise that may correspond to disparate communication channels. In one embodiment, the disparate communication channels comprise mobile phone numbers, BlackBerry usernames or IDs, Sidekick usernames, and so on, or any combination of addresses of mobile devices. In another embodiment, such addresses may correspond to multiple carriers including but not limited to wireless carriers and/or to multiple communication channels including but not limited to MMS, email, and so on. In one embodiment, FIG. 5A describes a process 800a that includes the steps of reading a first address 810.1 and pushing a multimedia message to a first address 830.NN.1 via a communication channel that may correspond to a mobile phone, a BlackBerry, a Sidekick, and so on. In another embodiment, the process 800a includes additional steps of reading a second address 810.2 and pushing the message to the second address 830.NN.2 via a communication channel that may correspond to a mobile phone, a BlackBerry, a Sidekick and so on. In still other embodiments, the process includes the additional steps of reading a third address 810.3 and pushing the message to the third address 830.NN.3 via a communication channel that may correspond to a mobile phone, a BlackBerry, a Sidekick and so on; and the additional steps of reading an nth message 810.NN and pushing the message to the nth address 830.NN.NN via a communication channel that may correspond to a mobile phone, a BlackBerry, a Sidekick, and so on. In yet still another embodiment, the process includes the additional steps of 815.1, 815.2, . . . 815.NN of determining the communication channel(s) and/or carrier(s). For example, in one embodiment the communication channel can be determined for mobile phone numbers as compared to BlackBerrys, Sidekicks and so on. In another embodiment, the carrier can be determined for each mobile phone number. Still another embodiment includes step 896 of saving and/or sending a report of the message transmittal.

In one embodiment, FIG. 5B describes a process 800b that includes the steps of reading a first address 810.1 and pushing a multimedia message to a first address 830.NN.1 via a communication channel that may correspond to a mobile phone, a BlackBerry, a Sidekick, and so on. In another embodiment, the process 800b includes additional steps of reading a second address 810.2 and pushing the message to the second address 830.NN.2 via a communication channel that may correspond to a mobile phone, a BlackBerry, a Sidekick and so on. In still other embodiments, the process includes the additional steps of reading a third address 810.3 and pushing the message to the third address 830.NN.3 via a communication channel that may correspond to a mobile phone, a BlackBerry, a Sidekick and so on; and the additional steps of reading an nth message 810.NN and pushing the message to the nth address 830.NN.NN via a communication channel that may correspond to a mobile phone, a BlackBerry, a Sidekick, and so on. In yet still another embodiment, the process includes a preliminary step 805 of determining the applicable communication channel and/or carrier such that addresses may be sorted and/or grouped by communication channel and/or by carrier in preparation for subsequent steps 810.1, 810.NN.1, 810.2, 810.NN.2, . . . , 810.NN, 830.NN. For example, a communication channel can be determined, e.g. MMS messaging, for a group of addresses comprising mobile phone numbers as distinguished from BlackBerrys, Sidekicks and so on. In another example, a carrier can be determined, e.g. Verizon, for a group of mobile phone numbers as distinguished from all mobile phone numbers. And in still yet another embodiment, the process 800 could omit the step 815. For example, steps 830NN.1, 830NN.2, . . . , 830.NN.NN could push messages to all communication channels and/or all carriers as a default since a carrier will ignore a message that it receives if the message does not have a deliverable address. In another example, the steps 830NN.1, 830NN.2, . . . , 830.NN.NN could push message to the carrier corresponding to each address based on predetermined domain names or gateways for each carrier. Still another embodiment includes step 896 of saving and/or sending a report of the message transmittal.

In one embodiment, FIG. 5C describes the process 800c that has at least the step 810 of reading an address and the alternative steps 830.01, 830.02, 830.03, . . . , or 830.NN of pushing a message to the address corresponding to NN possible communication channels. For example, the step of reading an address may comprise looking up an address in a datatable, retrieving an address from a web interface, e.g. using PHP, javascript, ASP.NET, or other scripting, and so on. In other embodiments, the process 2000c may also have one or more additional steps including steps 815, 825, 880, 882, 896. For example, one embodiment of the process includes the step 815 of looking up the full address or expanding the address to the full address. For example, another embodiment of the process includes the step 825 of determining the applicable communication channel corresponding to the address. In still another example, an embodiment of the process includes steps 880 and 882 of determining if there is another address in the list and reading that next address. In yet still another example, an embodiment of the process includes step 896 of saving and/or sending a report of the message transmittal.

FIG. 5D describes the process 800d that has at least the step 810 of reading an address and the alternative steps 830.01, 830.02, 830.03, . . . , or 830.NN of pushing a message to the address corresponding to NN possible communication channels. For example, the step of reading an address may comprise looking up an address in a datatable, retrieving an address from a web interface, e.g. using PHP, javascript, ASP.NET, or other scripting, and so on. In other embodiments, the process 800d may also have one or more additional steps of 815, 825, 860, 870, 880, 882, and 896. For example, one embodiment of the process includes the step 825 of determining the primary communication channel corresponding to each address. In another example, the process 800d includes steps 860 and 870 of determining if there is a secondary and/or tertiary communication channels and then sending a copy to other address(es). In still another example, another embodiment of the process includes steps 880 and 882 of determining if there is another address in the list or grouping and reading that address. In yet still another example, an embodiment of the process includes step 896 of saving and/or sending a report of the message transmittal.

FIG. 5E describes the process 800e that has at least the step 810 of reading an address and the alternative steps 830.01, 830.02, 830.03, . . . , or 830.NN of pushing a message to the address corresponding to NN possible communication channels. For example, the step of reading an address may comprise looking up an address in a datatable, retrieving an address from a web interface using PHP, javascript, ASP.NET, or other scripting, and so on. In one embodiment, the process 800e has only alternative steps 830.04, 830.05, and 830.06 of pushing a message to an address corresponding to only three out of NN possible communication channels. In other embodiments, the process 800e may also have one or more additional steps 815, 816, 818, 825, 880, 882, and 896. For example, one embodiment of the process includes the step 825 of determining the applicable communication channel corresponding to the address. In another example, an embodiment of the process 800e includes steps 816 and 818 of determining if address is a mobile address and then reading such next address. In still another example, another embodiment of the process includes steps 880 and 882 of determining if there is another address in the list or grouping and reading that address. Thus, the message can be sent addresses corresponding only to communication channel(s) for mobile devices, e.g. mobile phones, BlackBerrys, Sidekicks, and so on. In yet still another example, an embodiment of the process includes step 896 of saving and/or sending a report of the message transmittal.

FIG. 5F describes the process 800f that has at least the step 805 of determining the desired communication channel, the step 810 of reading an address, and the alternative steps 830.01, 830.02, 830.03, . . . , or 830.NN of pushing a message to the address corresponding to NN possible communication channels. For example, the step of reading an address may comprise looking up an address in a datatable, retrieving an address from a web interface using PHP, javascript, ASP.NET, or other scripting, and so on. In other embodiments, the process 800f may also have one or more additional steps 815, 826, 828, 880, 882, and 896. In another example, the process 800d includes the step 826 of determining if there is another address in the list within the same communication channel and then the step 828 of reading such next address in the list or grouping. Thus, the message can be sent to a group of addresses corresponding to any desired communication channel. In still another example, an embodiment of the process may includes step 880 of determining if there is another address to which this message is not sent and step 882 of reading that next such address. Thus, the addresses corresponding to a disparate communication channel can be grouped and the message can be sent to this group of addresses corresponding to this disparate communication channel.

Similar to FIG. 5F above, FIG. 5G describes the process 800g that has at least the step 805 of determining the desired communication channel and the step 810 of reading an address. For example, the step of reading an address may comprise looking up an address in a datatable, retrieving an address from a web interface using PHP, javascript, ASP.NET, or other scripting, and so on. However, FIG. 5G describes a process having a step 830′ or 830″ of pushing a multimedia message to one or more address(es) corresponding to a subset of NN possible communication channels that are capable of receiving multimedia. In other embodiments, the process 800g may also have one or more additional steps 815, 826, 828, 880, 882, and 896. In another example, the process 800d includes the step 826 of determining if there is another address in the list within the same communication channel and then the step 828 of reading such next address in the list or grouping. Thus, the multimedia message can be sent to a group of addresses corresponding to any desired communication channel capable of multimedia communications. In still another example, an embodiment of the process may includes step 880 of determining if there is another address to which this message is not sent and step 882 of reading that next such address. Thus, the addresses corresponding to a disparate communication channel can be grouped and the multimedia message can be sent to this group of addresses corresponding to this disparate communication channel.

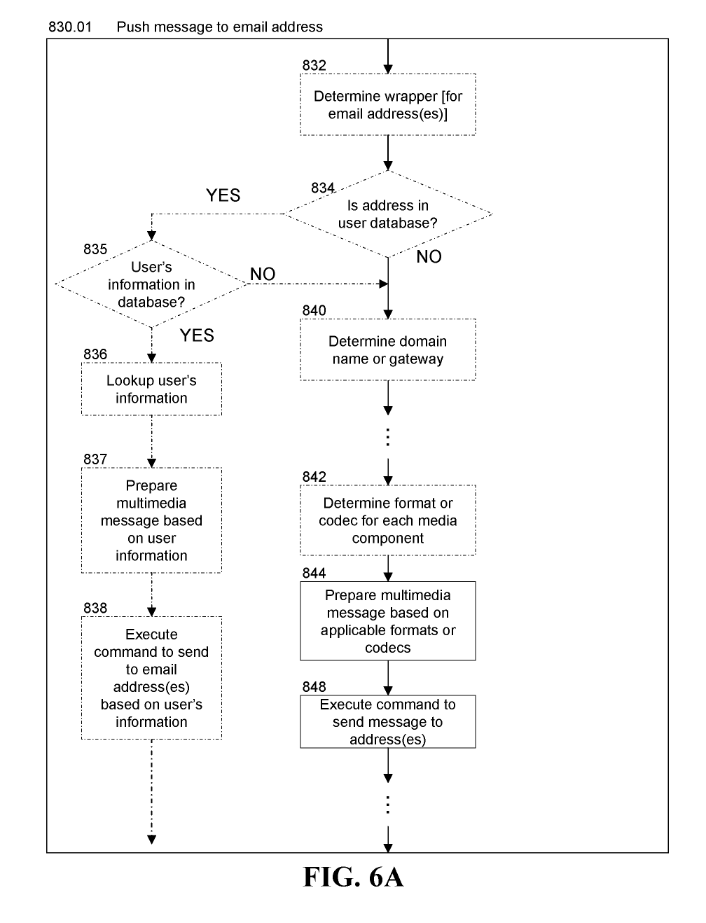

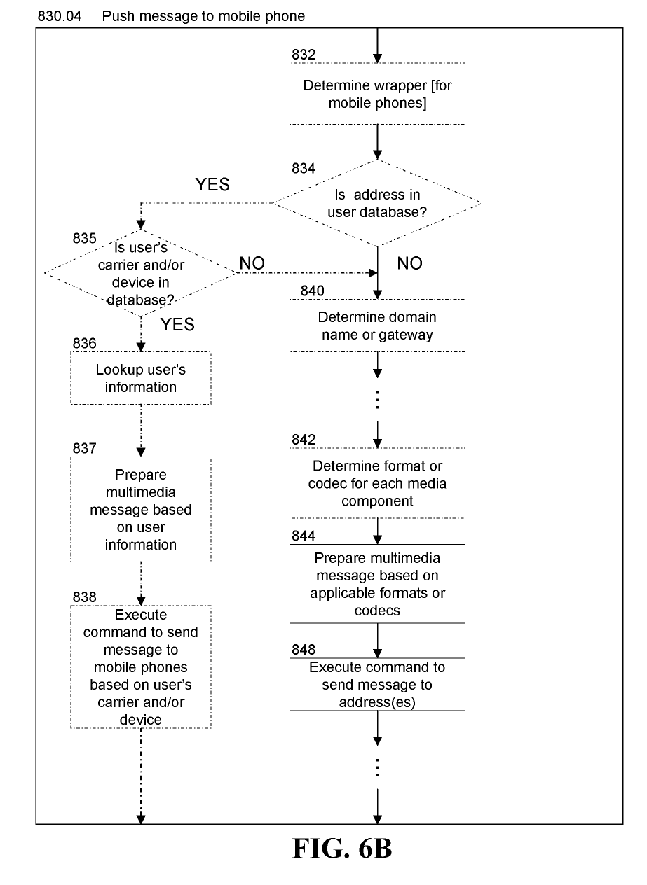

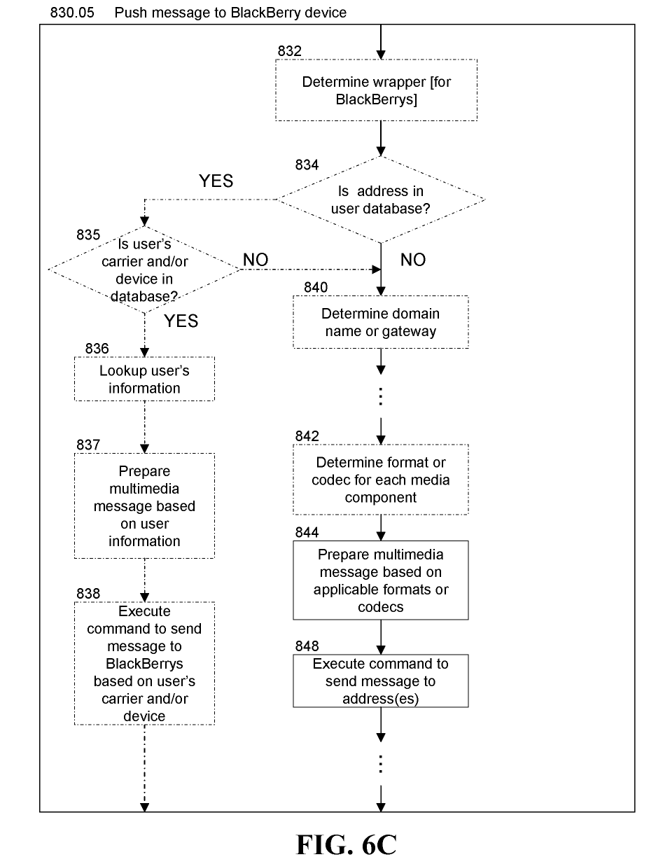

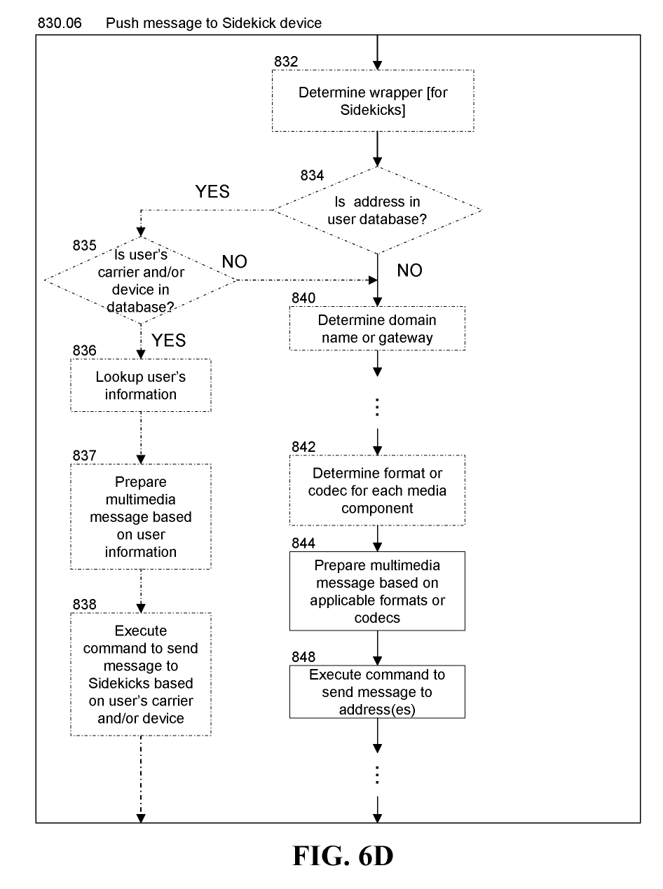

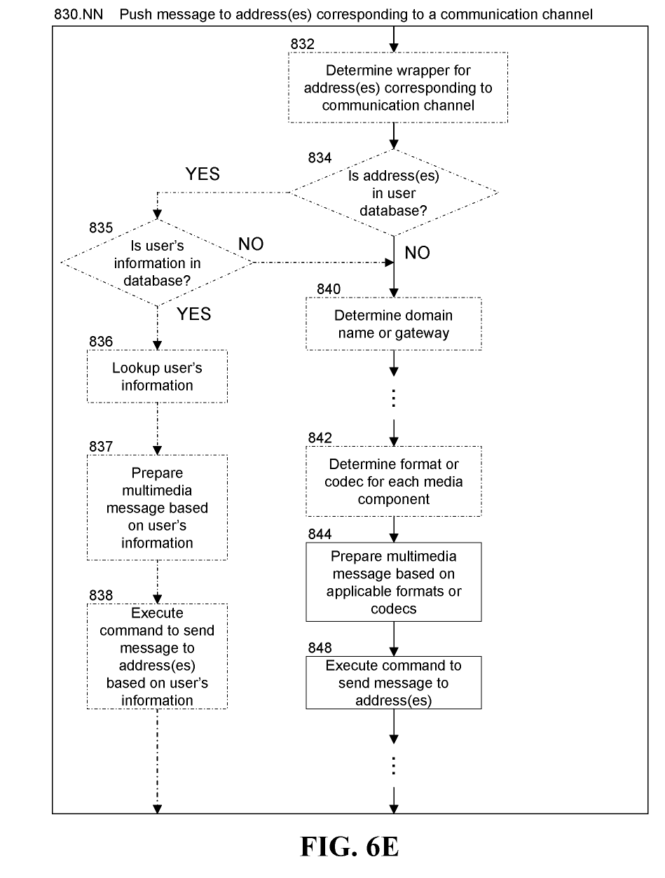

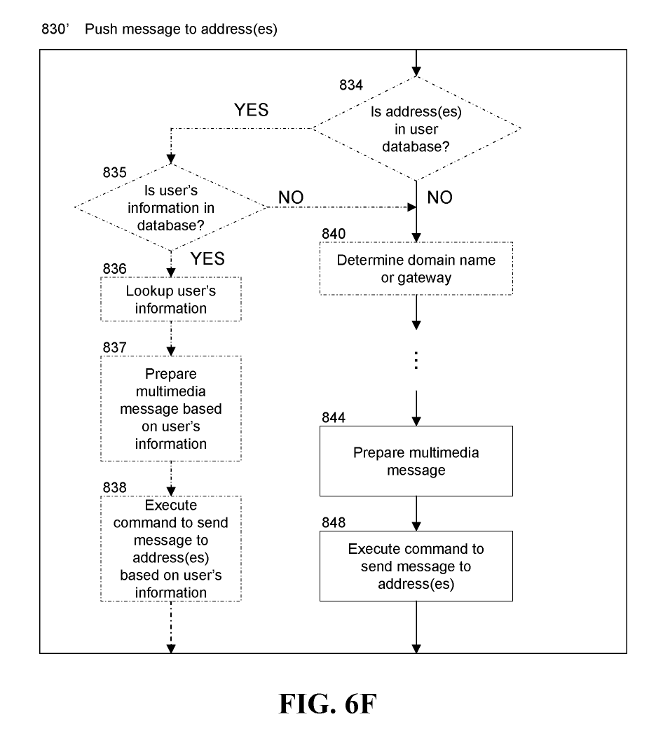

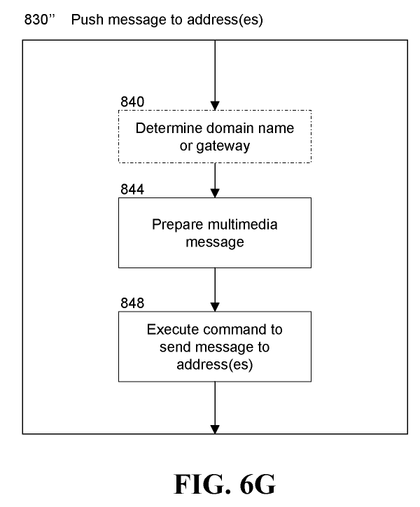

FIGS. 6A through 6E describe alternative subprocesses for pushing a message via disparate communication channels including but not limited to email, IM, SMS, MMS, Blackberry, Sidekick, and so on. FIG. 6A describes the subprocess 830.01 for pushing a message to an email address. FIG. 6B describes the process 830.04 for pushing a message to a mobile phone using SMS or MMS messaging. FIG. 6C describes the process 830.05 for pushing a message to a BlackBerry. FIG. 6D describes the process 830.06 for pushing a message to a Sidekick. FIG. 6E describes the process 830.NN for pushing a message to an address corresponding to a communication channel out of NN possible communication channels.

In FIGS. 6A through 6E, one embodiment of the subprocess has at least the step 844 of preparing a multimedia message based on applicable formats or codecs and a step 848 of executing a command to send the message to an address. In another embodiment, the process has a step 842 of determining a common format or codec for each media component. For example, the step 842 of determining common format(s) or codecs may be done at run-time. Alternatively, the step 842 may be performed in advance and the formats or codecs saved to increase efficiency of execution. For example, the step of executing a command to send a message may comprise calling a mail function, e.g. mail( ) to send an email using SMTP, or saving the message to the outbox of a mail client, e.g. Eudora or MS-Outlook, for immediate or batch processing, and so on. In another embodiment, FIGS. 6A through 6E describe the subprocess as having an additional step 832 of determining a wrapper for the multimedia. Similar to step 842 described above, step 832 may be performed at runtime or in advance of runtime to increase efficiency. In another embodiment, FIGS. 6A through 6E describe the subprocess as having an additional step 840 of determining the domain name or gateway. In other embodiments, the subprocess has alternative steps 835 through 838 assessing whether user's information in database, looking up user's information, preparing message based on user information, and executing a command to send email to based on user's information.

FIGS. 6F and 6G describe the alternative subprocesses 830′ and 830″ of sending a multimedia message, e.g. video, to one or more address(es), in which the alternative processes 830.01, 830.02, . . . , 830.NN are replaced with more simplified subprocesses for sending a multimedia message. Although both FIG. 6G is the most simplified. In one embodiment, the subprocesses still include the step 844 of preparing a message and the step 848 of executing a command to send the message to address(es). In this example, the steps of determining the wrapper and that of determining the formats or codecs are eliminated because process 500 is performed in advance of alternative processes 800a, 800b, 800c, . . . , or 800g. In another embodiment, the subprocess includes an additional step 840 of determining the domain name or gateway. However, step 840 can be eliminated if process 700 is performed in advance. In other embodiments, the subprocess can be further streamlined by shortening or eliminating the step 844 of preparing the multimedia message. For example, the step 844 may be shortened or eliminated if process 600 is performed in advance. As described above, process 600 comprises pre-determining a multimedia message template for each communication channel.

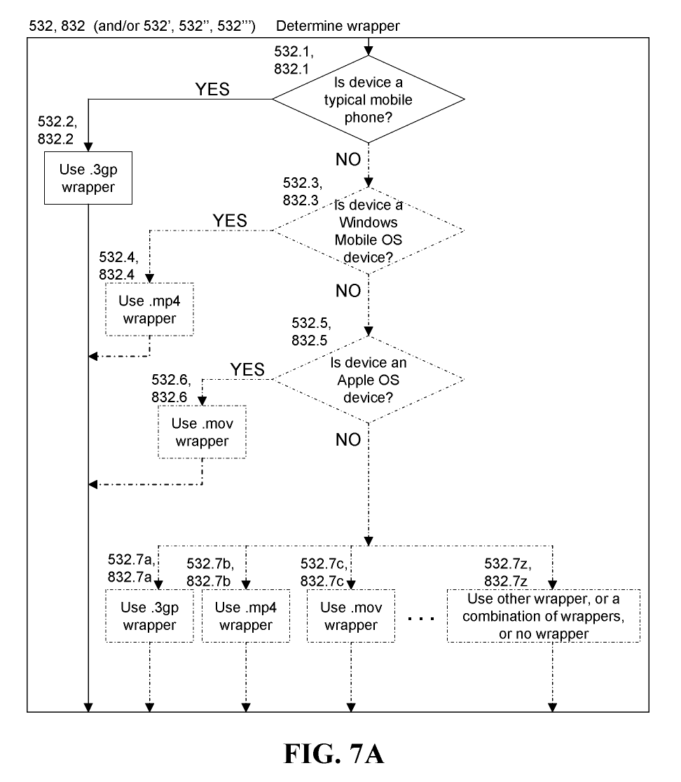

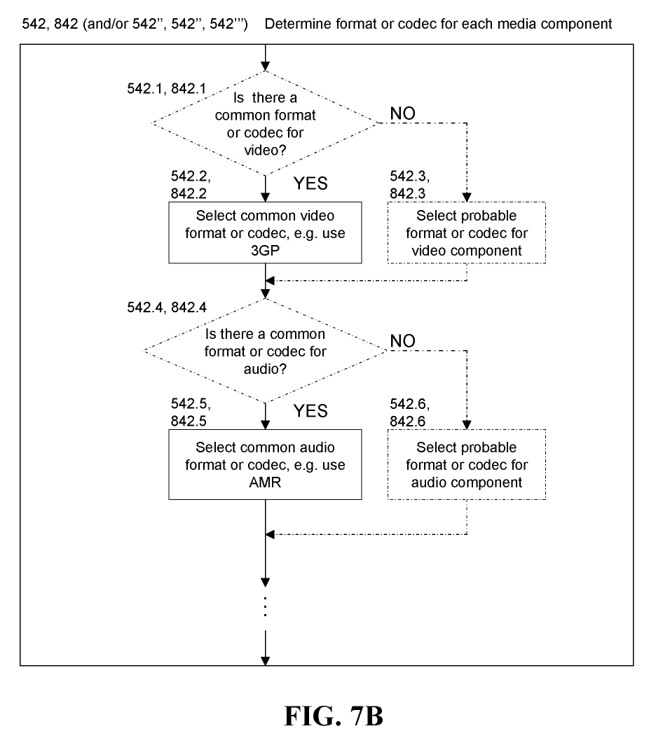

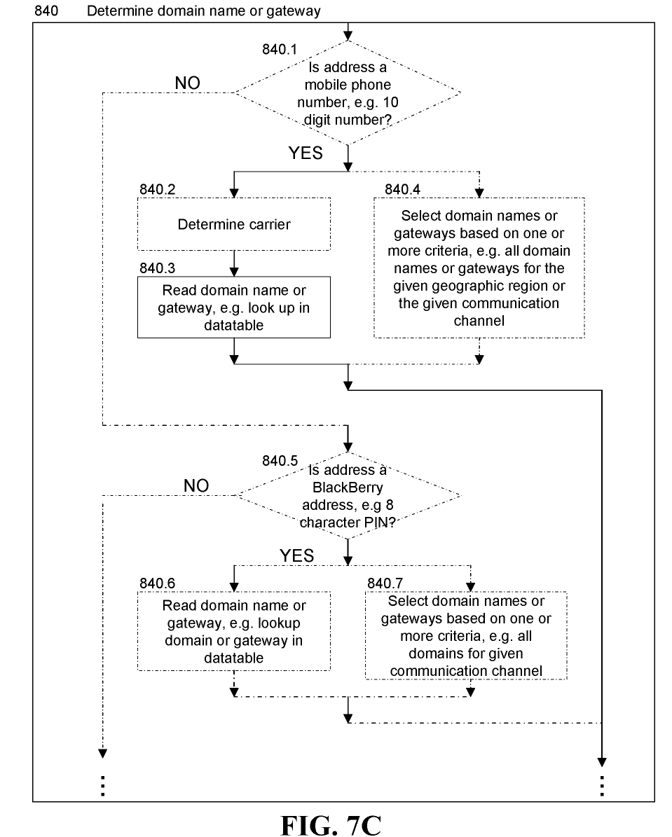

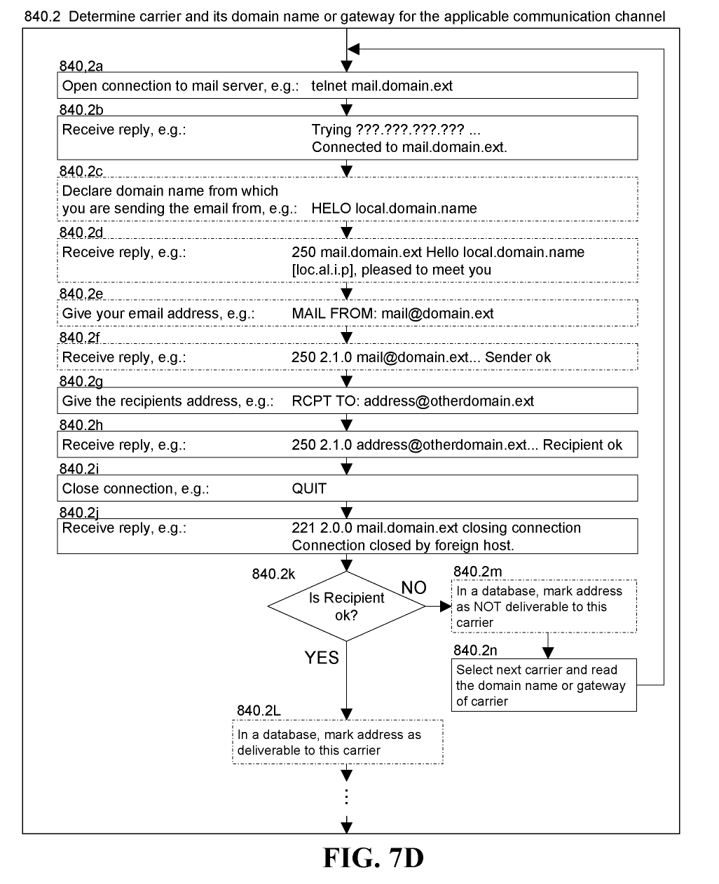

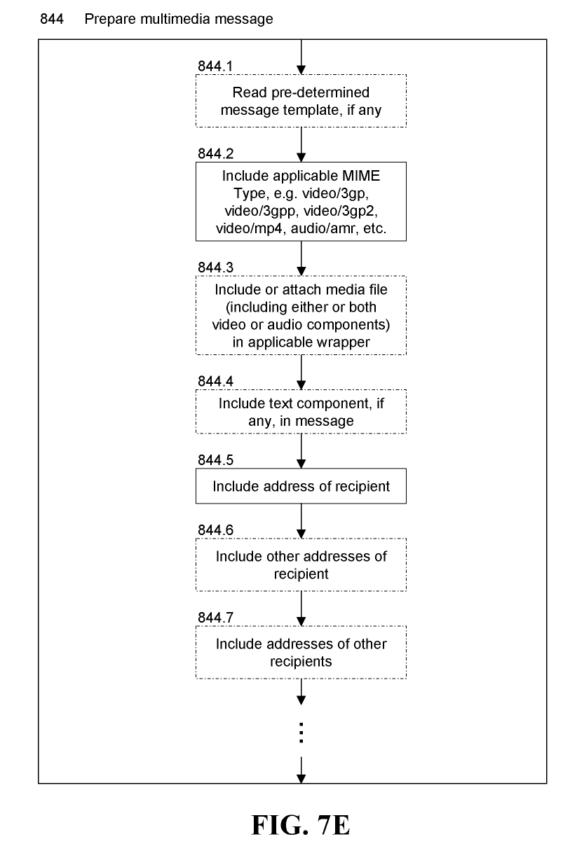

FIGS. 7A through 7E describe subprocesses 832 (=532), 842 (=542), 840, 840.2 and 844 for determining a wrapper; determining a format or codec for each media component; determining the domain name or gateway for an address; determining if an address is deliverable at the domain name or gateway; and preparing multimedia message. In one embodiment, FIG. 7A describes a subprocess 832(=532) as having at least the step of 832.2 of using a .3GP wrapper. In another embodiment, FIG. 7A has a preliminary step 832.1 of determining if device is a mobile device. In other embodiments, FIG. 7A describes the process as having additional steps 832.3, 832.4, . . . , 832.7 of assessing the type of device and of using the corresponding wrapper, e.g. .3gp, .mp4, .mov, and so on.

In one embodiment, FIG. 7B describes a subprocess 842(=542) having at least the step 842.2 of selecting a common video format or codec and the step 842.5 of selecting a common audio format or codec. In another embodiment, FIG. 7B describes a process having preliminary step 842.1 of determining if there is a common format or codex for video components and/or the step 842.4 of determining if there is a common audio format for audio components. For example, in the context of mobile phones, a common video format or codec is H.264 which was determined to be accepted by most wireless carriers. In other embodiments, the subprocess has the alternative steps 842.3 and 842.6 selecting a probable format or codec for the video component and/or audio component.

In one embodiment, FIG. 7C describes a subprocess 840 having at least the step 840.3 of reading domain name or gateway of the carrier corresponding to the address. In another embodiment, FIG. 7C describes an additional step 840.2 of determining the carrier corresponding to the address. For example, in one embodiment, the domain name or gateway may be looked up or queried in a database such as the SMS/MMS address registry 4000. In another embodiment, the domain name or gateway of the carrier may be retrieved from a database filtered by state, nation, continent, or other geographical region. In still another embodiment, the domain name or gateway may be determined by conditional statements, e.g. if A then B, if C then D, and so on, or any other logical structure or expert system for determining the domain name or gateway corresponding to the address. In yet still another embodiment, FIG. 7C describes an alternate step 840.4 of selecting multiple domains corresponding to one or more criteria rather the single domain name or gateway of the carrier corresponding to an address. For example, the criteria may include country code, city code, and/or prefix. In another example, the criteria may include one or more states, nations, continents, or other geographical regions, and thus, the selected domain names or gateways may include all domain names or gateways for the given geographic region(s). In still another example, the criteria may be for one or more communication channels, and thus, the selected domain names or gateways may include all domain names or gateways for the given communication channel(s). In another embodiment, FIG. 7C describes a preliminary step 840.1 of determining if address is a mobile phone number, e.g. 10 digit number.

In other embodiments, FIG. 7C describes the subprocess 840 having additional steps 840.5, 840.6, . . . , 840.NN for other types of mobile devices. For example, one embodiment has an additional step 840.5 for determining if address is a BlackBerry PIN and step 838.6 of reading domain name or gateway. In another embodiment, the subprocess has an additional step 840.8 of determining if address is a Sidekick username and 840.9 of reading domain name or gateway.

FIG. 7D describes a subprocess 840.2 for determining the carrier and its SMS or MMS domain name or gateway through which a message is deliverable. In one embodiment, the process includes the steps 840.2a, 840.2b, 804.2g, 840.2h, 840.2i, 840.2j, 840.2k, and 840.2n. In another embodiment, the process includes the additional steps 840.2L and/or 840.2m. Steps 840.2a and 840.2b establish a network connection to domain or gateway. Steps 840.2g and 840.2h verify deliverability to a particular address at a particular domain or gateway. Step 840.2k determines if message is deliverable to the particular address. Optional step 840.2L records in a database if message is deliverable to the particular address and optional step 840.2m records in a database if message is not deliverable to an address. As stated above, this subprocess may be unnecessary if process 700 is performed prior to alternative processes 800a, 800b, 800c, . . . , 800g.

If the carrier is known for a given address (e.g. address belongs to registered user), the server 200 looks up the carrier's domain name or gateway in a datatable or retrieves it from SMS/MMS address registry 4000. In one embodiment, the address registry is private or access is otherwise limited. In other embodiments, the address registry is publicly accessible. In alternative embodiment, if the carrier is not known for a given address, the server looks up all domain names or gateways for a given geographical region or a given communication channel. For example, in the context of mobile phones, the server looks up domain names all carriers. In another example, in the context of BlackBerrys, the Blackberry domain address or gateway varies within the United States so you have to know the BlackBerry email domain but most other countries have only one BlackBerry email provider. In the context of Sidekicks, the Sidekick domain address does not vary so you just have to have the username. An elementary example of the basic process using conditional statements is shown in Table 6 below:

TABLE 6
Example of Basic Process
CELL PHONE:

```
IF the phone is not a blackberry, or sidekick
THEN check if carrier is known
IF carrier is known, send to phone number@carrierdomain.com
ELSEIF carrier is not known
TELNET mail.carrierdomain.com
      RCPT TO: phonenumber@carrierdomain.com
      QUIT
CALL MAIL SUBROUTINE
Mark In Database That Number Is Deliverable At This Carrier
ELSE
Mark In Database That Number As Not From This Carrier In Number
Database
REPEAT for each carrier UNTIL ‘Recipient is ok’
ELSE IF carrier is not known
Send an email to phone number @ all carrierdomains.com
END IF
```

WINDOWS MOBILE DEVICE:

Windows mobile follows the same process as cell phone

BLACKBERRY:

IF device is a blackberry
THEN check for network
Send to blackberry user @network.com

SIDEKICK:

IF device is sidekick
THEN send to sidekick user @ tmail.com

In one embodiment, FIG. 7E describes a subprocess 844 for preparing a multimedia message as having at least the step of 844.1 of including the applicable MIME type corresponding to the wrapper (and the carrier) and the step 844.5 of inserting the address of recipient. For example, a wrapper for pushing video messages to mobile phones is generally a .3GP wrapper. In one embodiment, the process includes the additional step 844.3 of including or attaching a video component or audio component. In still another embodiment, the process includes the additional step of 844.4 of including a text component. In yet still another embodiment, all of these components are defaults. In various embodiments, the video component, audio component, and/or text component of the message are user selected and the remaining components may be defaults. In a further embodiment, the process may include the additional step 844.6 of including alternate or additional addresses of the recipient to receive duplicates of all or part of the message. In a further embodiment, the process may include the additional step 844.7 of including addresses of other recipients to receive copies of part or all of the message. In the preferred embodiment, the video and audio components are coded in a common format or codex accepted for delivery to mobile phones by all carriers such as H.264 for video component and AMR for the audio component. Examples of the MIME compliant code for video messages is shown below for selected carriers in Table 7 below.

TABLE 7
Example of MIME compliant code

For Verizon
--==Multipart_Boundary_xb13b2e3b526f01eee3f5832bdc6022ddx
Content-Type: video/3gpp2;
name=“video.3gp”
Content-Disposition: attachment;
filename=“video.3gp”
Content-Transfer-Encoding: base64
For Sprint
--==Multipart_Boundary_xb13b2e3b526f01eee3f5832bdc6022ddx
Content-Type: video/3gp;
name=“video.3gp”
Content-Disposition: attachment;
filename=“video.3gp”
Content-Transfer-Encoding: base64
For T-Mobile
--==Multipart_Boundary_xb13b2e3b526f01eee3f5832bdc6022ddx
Content-Type: video/3gpp;
name=“video.3gp”
Content-Disposition: attachment;
filename=“video.3gp”
Content-Transfer-Encoding: base64

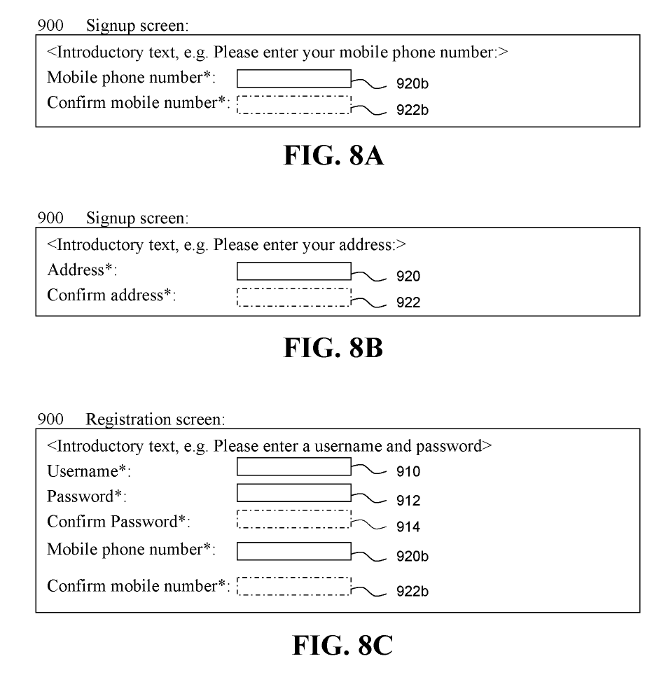

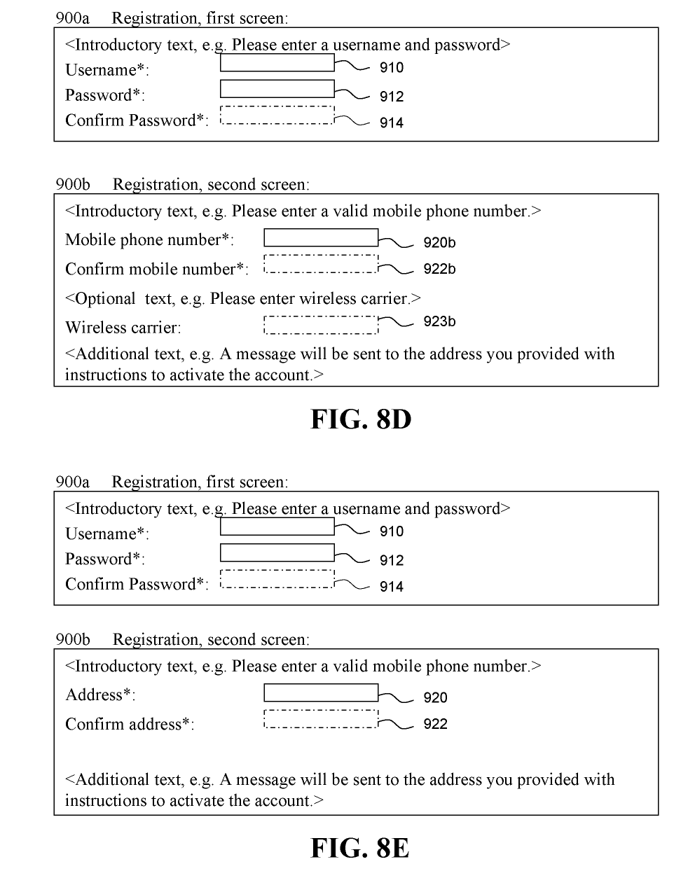

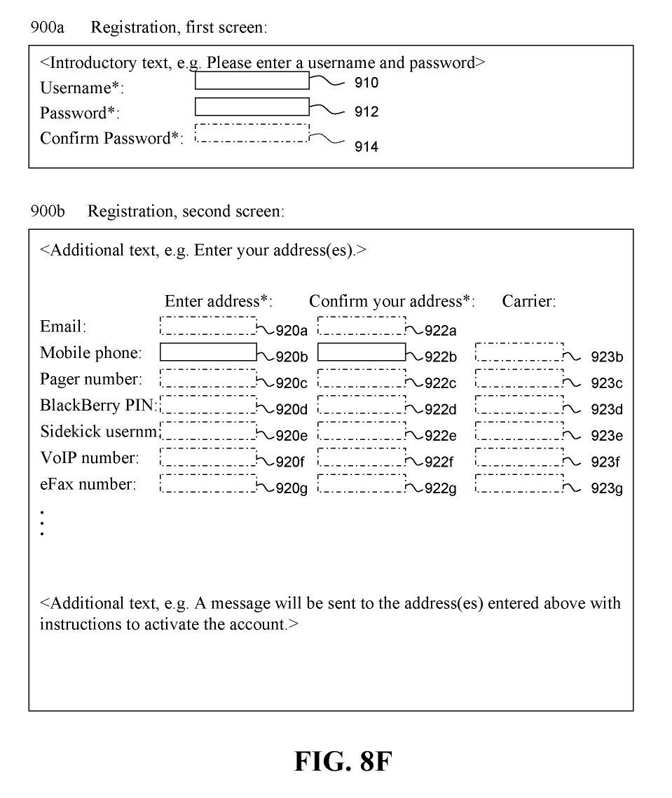

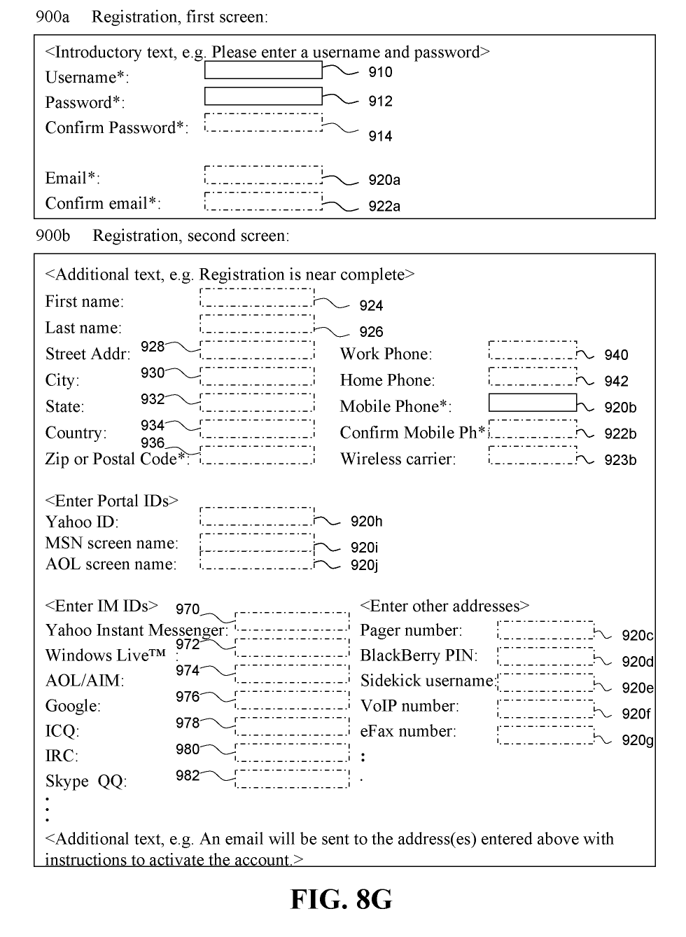

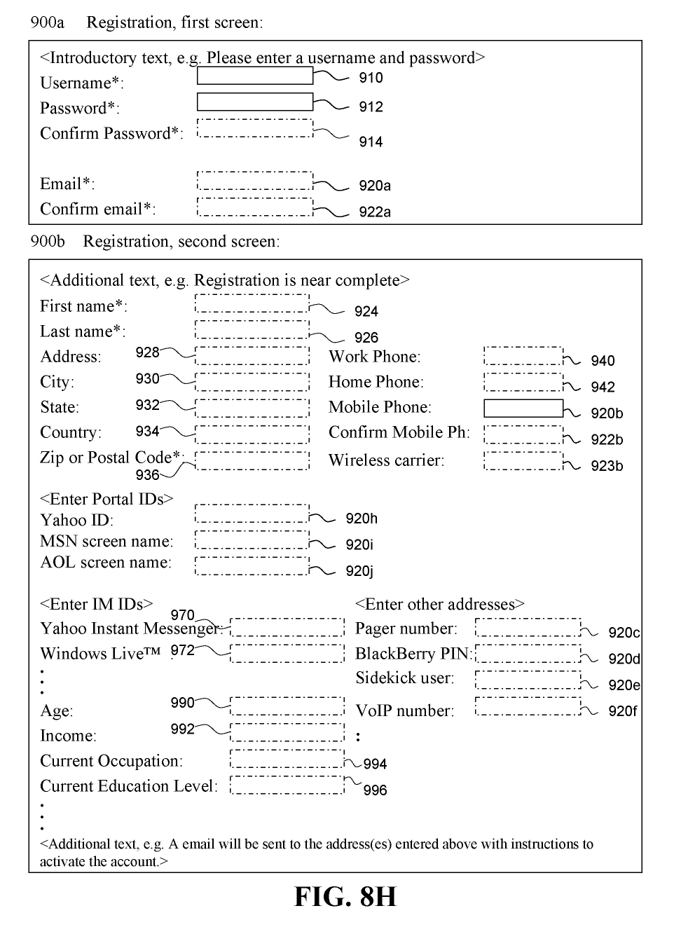

FIGS. 8A and 8B describe a screen layout of a data entry form for a user signup process without establishing an account having a username and/or password. FIGS. 8A and 8B show a very simple layout for a signup process having a single screen 900. For example, the data entry form for a simple signup process may have only a data element 920 (or 920b) and optionally a data element 922 (or 922b) for a duplicate entry the confirm the accuracy of the mobile number. In FIG. 8A, for data elements represent a mobile phone number, and in FIG. 8B, the data elements represent a generalized address which may correspond to any communication channel.

FIGS. 8C through 8G describe screen layouts of alternative data entry forms for a user registration process. FIG. 8C shows a very simple layout for a registration process having a single screen 900. FIGS. 8D through 8G show more elaborate layouts for registration processes having at least two screens 900a and 900b. In FIGS. 8C through 8H, the data entry forms each have at least data elements 910, 912, and 920 (or 920b), and in other embodiments, describe screen layouts having an optional data element 914 to confirm the password and/or optional data element 922 to confirm your address. In FIG. 8D, the data form have a data element 923b to solicit the user's wireless carrier. In still other embodiments, FIGS. 8F through 8G describe screen layouts of data entry forms that have additional data elements. In one of these embodiments, FIG. 8F describes a screen layout comprising data elements 920a, 920b, 920c, . . . , 920z for various addresses and/or corresponding data elements 922a, 922b, 922c, . . . , 922z. to confirm these addresses as well as optional data elements 923b, 923c, . . . , 923z. to solicit the user' carrier. For example, in FIGS. 8F and 8G, the data form may have data elements 924, 926, . . . , 936 relating to user contact information. For example, the data entry form may have a data element 920d for a BlackBerry or a data element 920e for a Sidekick and/or other mobile addresses in addition to a mobile phone number. For example, in FIGS. 8G and 8H, the data entry form may have data elements 920h, 920i, . . . 920j representing one or more portal IDs and/or data elements 970, 972, . . . , 988 representing one or more IM address IDs. In still other embodiments, FIG. 8H describes a data entry form that may include one or more additional data elements 990, 992, . . . , 998 relating to additional demographic information as well as including other data elements.

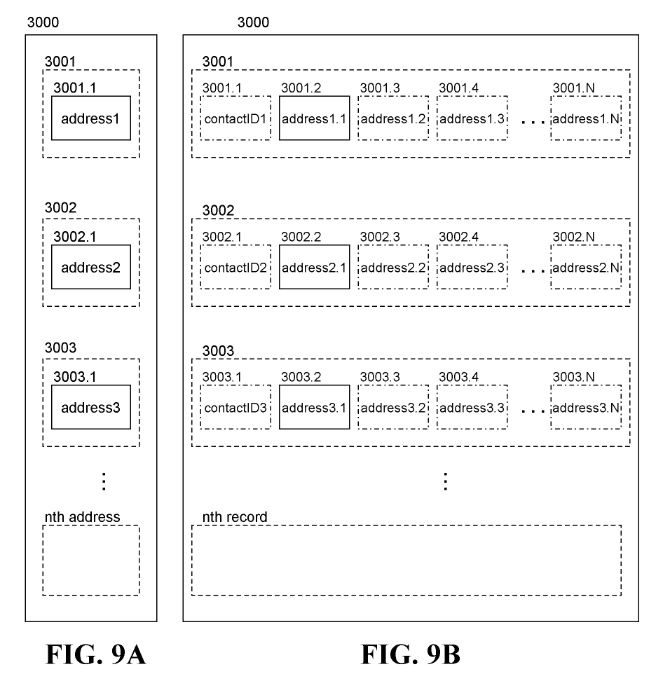

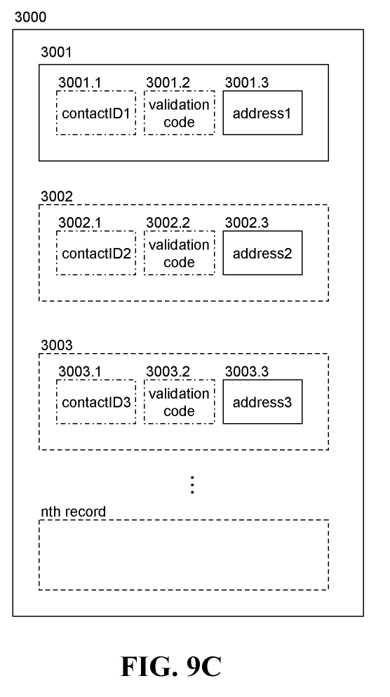

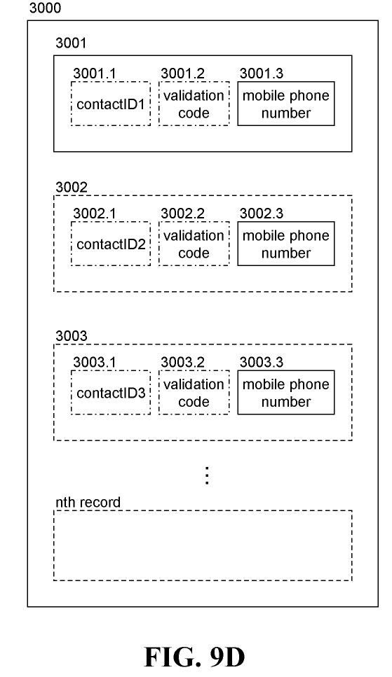

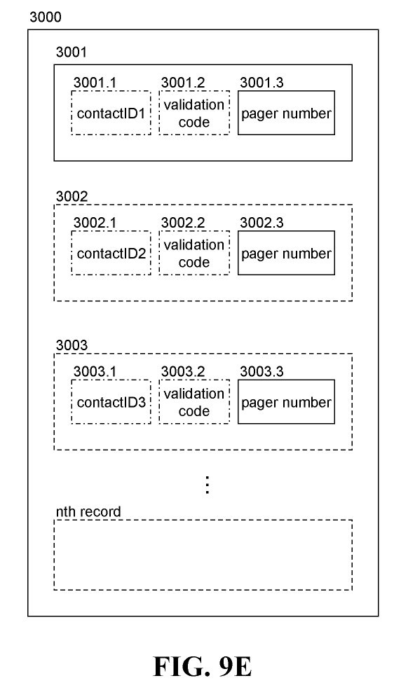

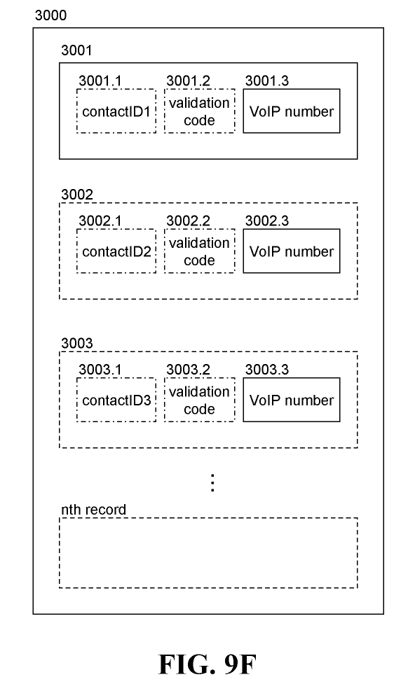

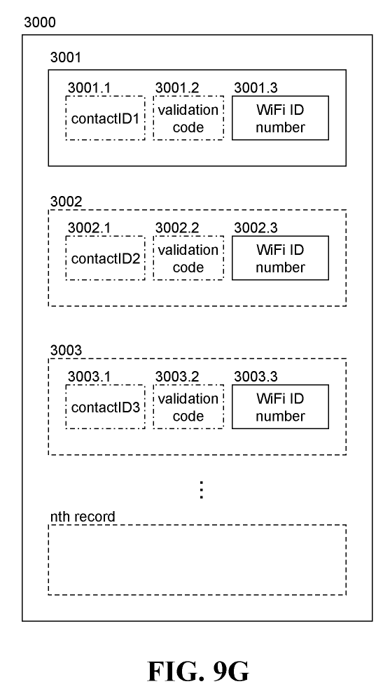

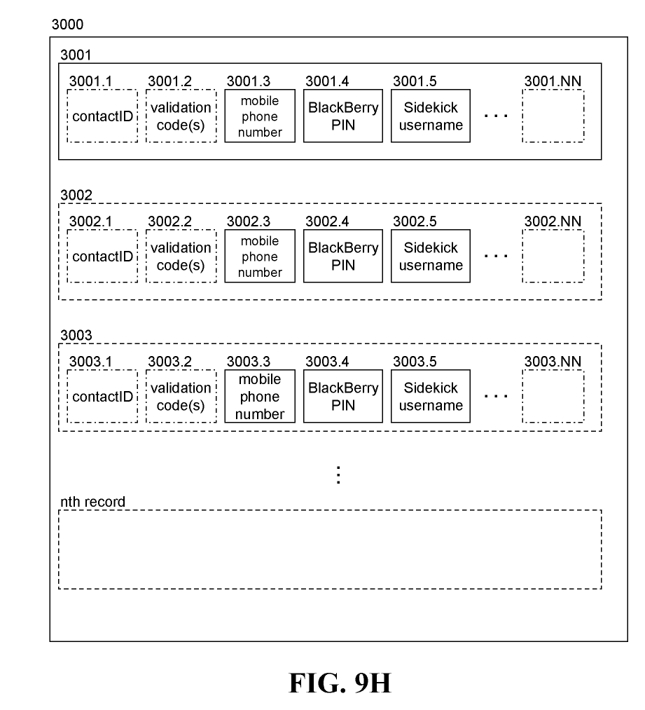

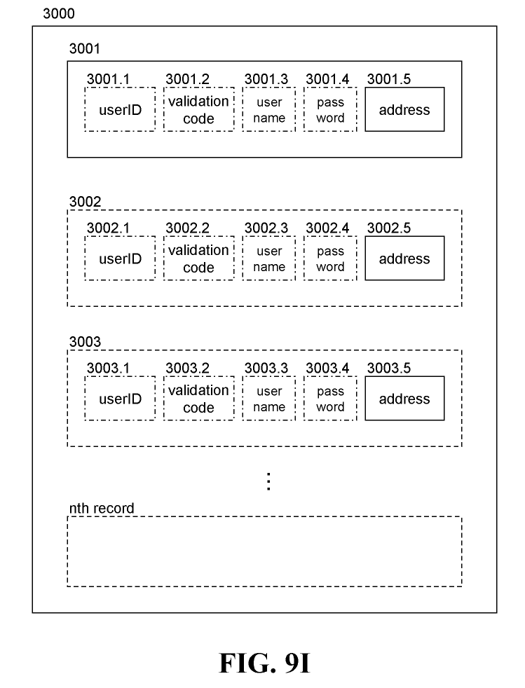

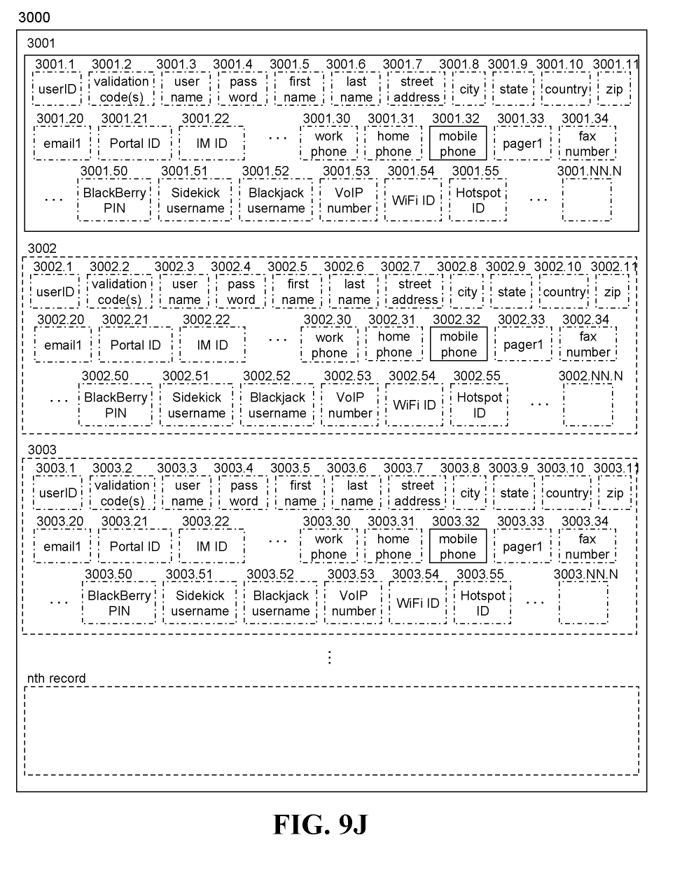

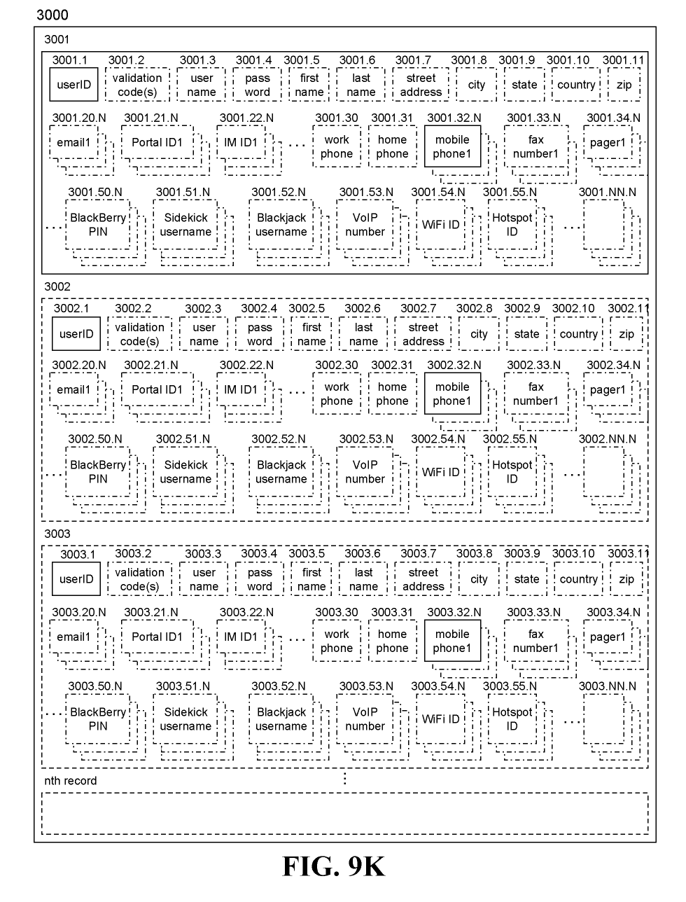

FIGS. 9A through 9K describe methods for storing addresses including but not limited to mobile phone numbers. FIG. 9A describes a method of storing addresses as a single list or multiple lists. In one embodiment, the list includes addresses corresponding to a single communication channel. For example, a list may comprise a series of mobile phone numbers separated by commas or other delimiters and stored in a text or ascii file. In another embodiment, the list includes addresses corresponding to disparate communication channels. For example, a list may comprise a series of addresses comprising mobile phone numbers, BlackBerry IDs, SideKick usernames, email addresses, voicemail boxes, and so on. FIGS. 9B through 9H describe methods of storing addresses in records 3001, 3002, 3003, . . . , nth record in a datatable 3000 without a username and/or password. In some embodiments, each record comprises at least one address stored as data elements 3001.3, 3002.3, 3003.3, . . . . In other embodiments, each record may comprise a additional data elements including contactID as data element 3001.1, 3002.1, 3003.1, . . . and validation code as data element 3001.2, 3002.2, 3003.2, . . . . FIGS. 9I through 9K describe methods of storing addresses in records 3001, 3002, 3003, . . . , nth record in a datatable 3000 that may include a username and/or password. In some embodiments, each record comprises at least one address stored as data elements 3001.3, 3002.3, 3003.3, . . . . In other embodiments, each record may comprise a additional data elements including userID as data element 3001.1, 3002.1, 3003.1, . . . and validation code as data element 3001.2, 3002.2, 3003.2 . . . . For example, in one embodiment, FIG. 9B describes each record as having multiple addresses in data elements 3001.31, 3001.32, 3003.3, . . . , 3001.M. as records 3001, 3002, 3003, . . . , nth record in a datatable 3000. In another embodiment, FIG. 9C describes storing of individual addresses 3001.3, 3002.3, 3003.3, . . . , as stored as records 3001, 3002, 3003, . . . , nth record in a datatable 3000. Similarly, FIG. 9I describes storing of individual addresses 3001.5, 3002.5, 3003.5, . . . , as stored as records 3001, 3002, 3003, . . . , nth record in a datatable 3000 but this embodiment may include data elements for a username 3001.3, 3002.3, 3003.3, . . . , and/or password 3001.4, 3002.4. 3003.4, . . . .

In FIGS. 9B, 9C and 9I, the generalized data elements labeled “address” or the like may comprise addresses corresponding to the same or disparate communication channels. In another embodiment, FIG. 9D describes storing of mobile phone numbers 3001.3, 3002.3, 3003.3, . . . , as stored as records 3001, 3002, 3003, . . . , nth record in a datatable 3000. In other embodiments, FIGS. 9E through 9H and 9J and 9K describe data elements for addresses corresponding to other communication channels including messaging via BlackBerrys, Sidekicks, pagers, faxs, VoIP, WiFi, Hotspots, and so on. In still other embodiments, FIGS. 9J and 9K describe additional data elements for user information, e.g. 3001.5, 3002.5, 3003.5, . . . for user's first name, as well as additional data elements through 3001.NN, 3002.NN, 3003.NN, . . . , for demographics, preferences, behavior, and so on. In at least one embodiment, addresses including mobile phones numbers are validated by sending a message to the mobile phone and requesting user to verify the phone number as part of the signup or registration process. For example, the user may be asked to reply to the sender to verify ownership or control of the address.

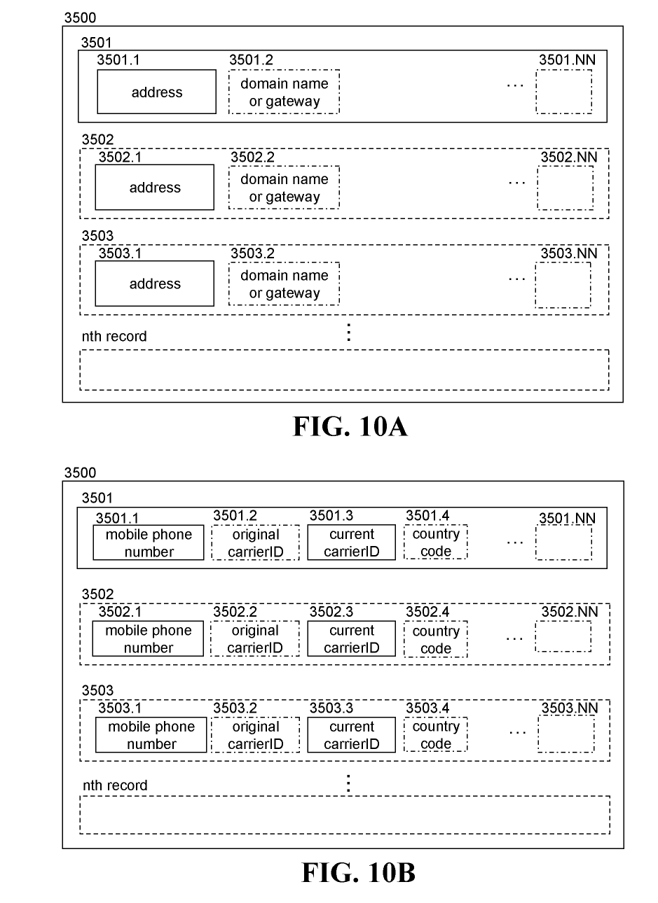

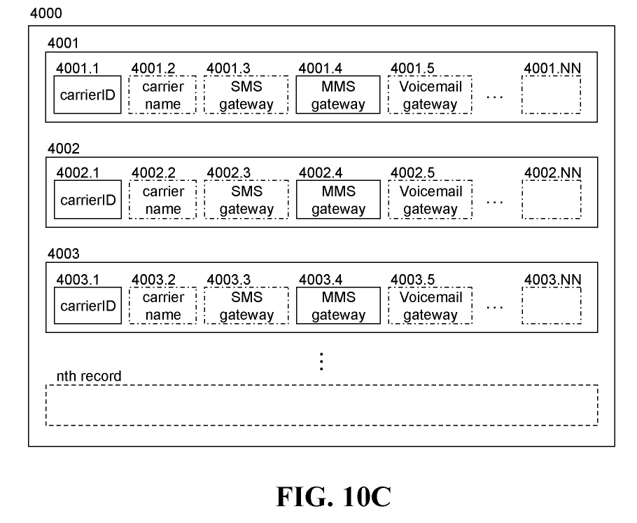

FIGS. 10A and 10B describe methods of storing addresses (and information related to the communications channel) in records 3501, 3502, 3503, . . . , nth record in a datatable 3500. In one embodiment, FIG. 10A shows a method having at least one data element per record comprising a generalized address stored in data elements 3501.1, 3502.1, 3503.1, . . . . In another embodiment, FIG. 10A shows a method having a domain name or gateway as an additional data element 3501.2, 3502.2, 3503.2, . . . . For example, the domain name or gateway data element in records in datatable 3500 may be fully populated by performing process 700. In another example, the records in datatable 3500 may remain unpopulated, or may be partially populated by subprocess 840.2. In still other embodiments, FIG. 10A shows methods having additional data elements 3501.NN, 3502.NN, 3503.NN, . . . .

In one embodiment, FIG. 10B shows a method having at least one data element per record comprising a mobile phone number stored in data elements 3501.1, 3502.1, 3503.1, . . . . In another embodiment, FIG. 10B shows a method having the current carrierID as an additional data element 3501.3, 3502.3, 3503.3 . . . . For example, in this embodiment the current carrierID is the last known carrier as determined by one of several methods including but not limited to soliciting the user for the current carrier or performed process 700 or 840.2. In another embodiment, the method has the original carrierID as an additional data element 3501.2, 3502.2, 3503.2, . . . . For example, in this embodiment the original carrierID is the original carrier to whom a mobile phone number was assigned and can generally be determined by several methods including but not limited to soliciting the user for the original carrier or looking up assigned ranges of mobile phone numbers for each carrier filtered by area code and prefix. In some embodiments, each record comprises the country code as a data elements 3501.4, 3502.4, 3503.4, . . . . For example, the current carrierID data elements in records in datatable 3500 may be fully populated by performing process 700. In another example, the records in datatable 3500 may remain unpopulated, or may be partially populated by subprocess 840.2.

FIG. 10C describes methods of storing carriers and SMS and MMS gateways in records 4001, 4002, 4003, . . . , nth record in a registry 4000. In one embodiment, FIG. 10C shows a shows a method having at least one data element per record comprising a MMS gateway in data elements 4001.4, 4002.4, 4003.4, . . . in addition to a carrierID data element 4001.1, 4002.1, 4003.1, . . . . For example, in one embodiment the carrier ID is populated with a unique code for each carrier, e.g. 001 for Verizon, 002 for Sprint, etc. In this way, the registry 4000 can function as a lookup table for the carrier MMS gateway or other information relating to the carrier. In another embodiment, FIG. 10C shows a method having an optional data element per record comprising a name, description, or other identifier of the carrier in data elements 4001.2, 4002.2, 4003.2. For example, the identifier may be comprised of text, may be comprised of a graphic image, e.g. a logo, or may be a combination of the these. In still another embodiment, FIG. 10C shows a method having an additional data element per record comprising a SMS gateway in data elements 4001.3, 4002.3, 4003.3, . . . . In still another embodiment, FIG. 10C shows a method having an additional data element per record comprising a Voice mail gateway in data elements 4001.5, 4002.5, 4003.5, . . . . In yet still another embodiment, FIG. 10C shows a method having additional data elements per record 4001.NN, 4002.NN, 4003.NN, . . . .

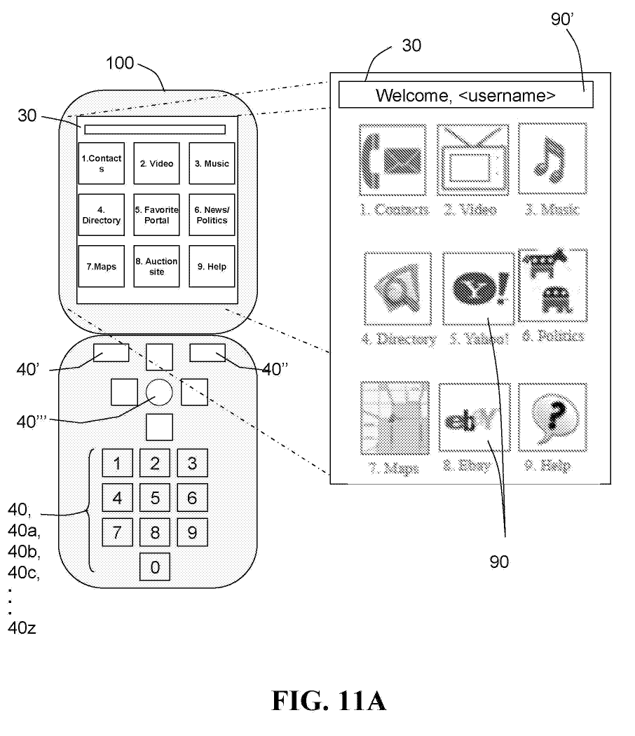

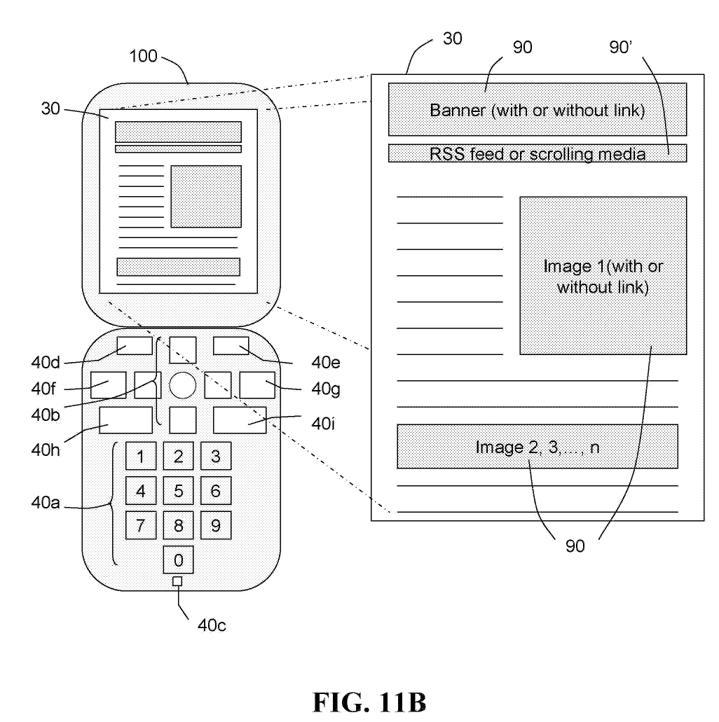

FIGS. 11A and 11B are plan views of a mobile phone's display and user interface showing alternative objects in the display area 30. In FIG. 11A, the display area 30 shows a grid of icons. In several embodiments, one or more of the icons are images of brands (e.g. logos) and have links to additional information on the webserver or any other server 200 (including but not limited to 200′, 200″, 200′″, and 200″″). Many embodiments may have a top image 90 in the form of a banner, e.g. a logo, brand name, or title of document. In addition, an embodiment can have a scrolling information or an RSS feed 90′ at the top in addition to or in lieu of the banner. In FIG. 11B, the display area 30 shows a plurality of displayed objects. In many embodiments, the displayed objects comprise images and text. In many embodiments, the images may be advertisements with links to more information. For example, the image 90 at the top can be banner ad and the image 90″ to the right can be a display ad. In another embodiment, an image 90′ appears directly below the banner. In another embodiment, the image 90 or 90′ recurs at intervals on the page, e.g. a repetition of the same ad, or a series of different ads. Also, in various other embodiments, each of the images 90, 90′ or 90″ can be linked to other information at a URL or a filename. Some embodiments have a scrolling information or an RSS feed 90′ at the top in addition to or in lieu of the banner ad.

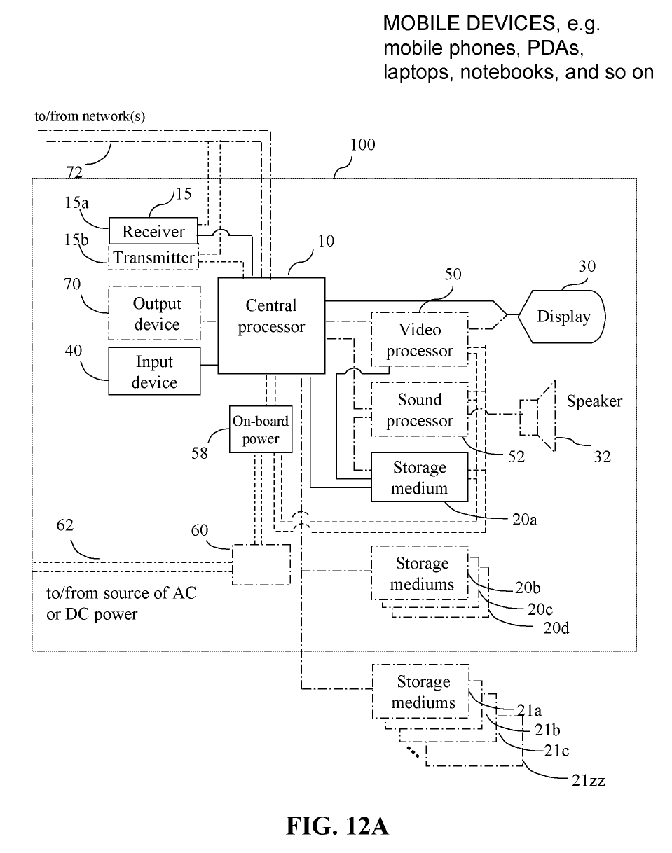

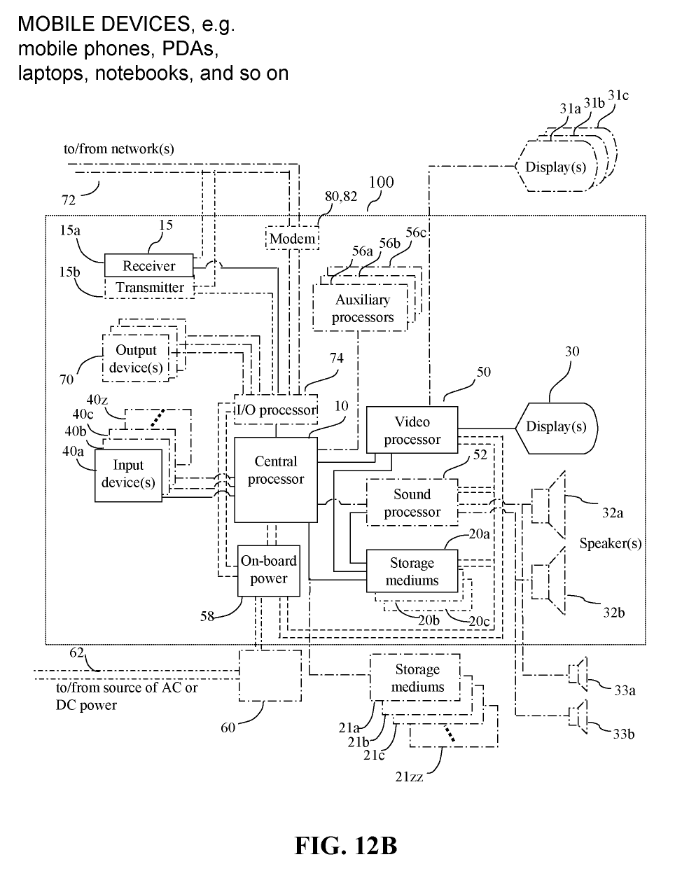

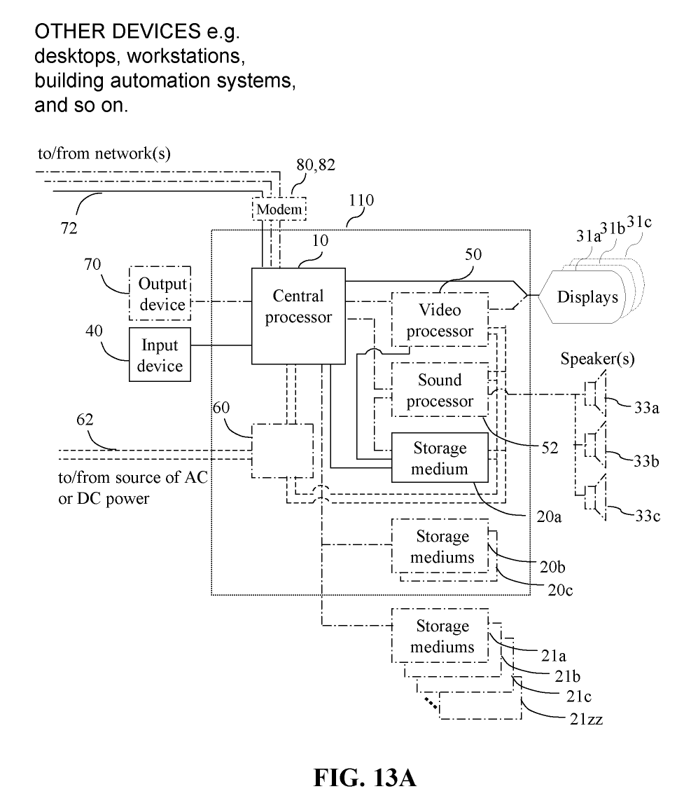

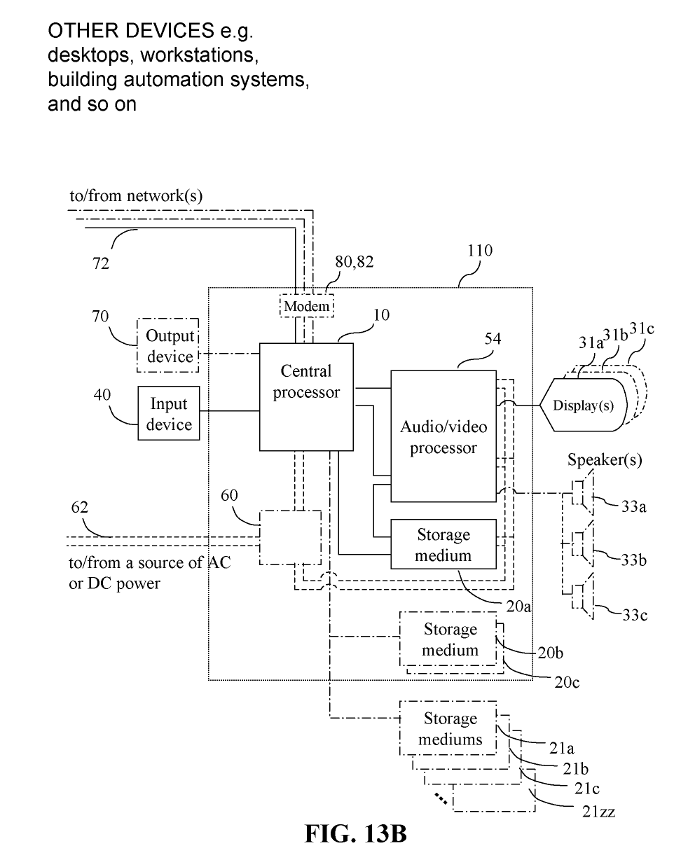

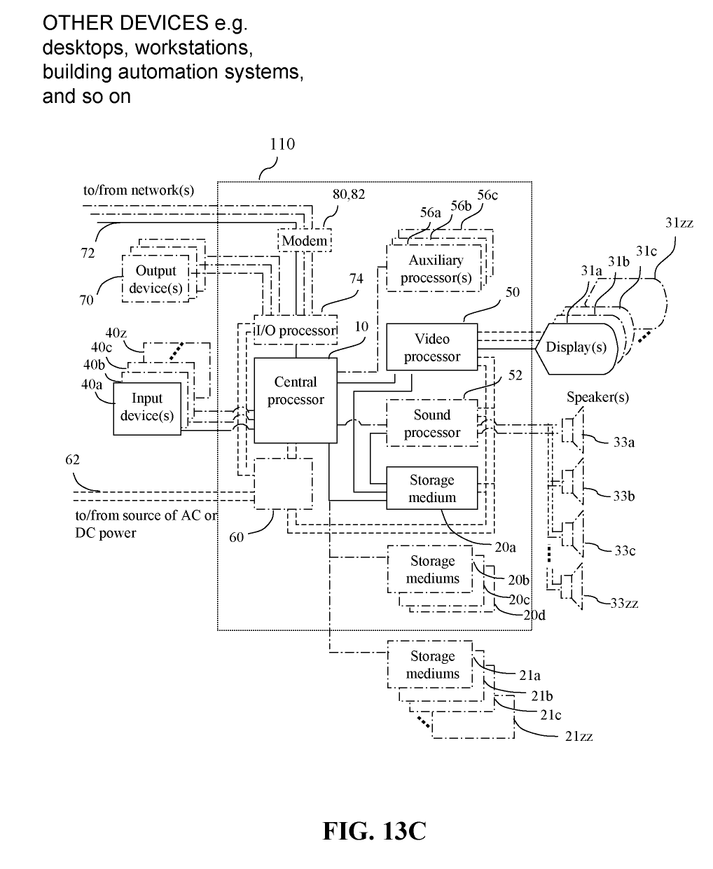

With reference to FIGS. 12A, 12B, and 13A through 13C, the perimeter of the device is shown by dotted lines, electric power (or bus) lines are shown by dashed lines, and alternative components and devices are shown by phantom (or dot-dash) lines.

FIGS. 12A and 12B are schematic drawings of alternative circuits of a mobile device 100 having a central processor 10 in communication with at least one storage medium 20a. In one embodiment of the invention, the circuit comprises the central processor 10, the storage medium 20a, at least one display 30, and at least one on-board power source 58. For example, the display can be any type of display including a flat panel display such as LED, LCD, TFT, plasma, and so on, or a combination of these including a backlit display. For example, the on-board power source may be a battery, a fuel cell, a photovoltaic cell, and so on. In another embodiment, the central processor is in communication with a receiver 15a and at least one speaker 32, and in another embodiment, the central processor is in communication with a transmitter 15b. In still another embodiment, the circuit comprises a sound processor 52 in communication with the central processor and the speaker 32. In one embodiment, the central processor 10 is in communication with a wireless cellular network of the type operated by Verizon, Sprint or AT&T through the receiver 15a and the transmitter 15b. In still another embodiment, the central processor is in communication with the receiver/transmitter 15 which comprises a receiver 15a and/or transmitter 15b. In still another embodiment, the device comprises at least one input device 40. In yet still another embodiment, the circuit also comprises a video processor 50 in communication with the central processor and the display. In a further embodiment, the circuit also comprises one or more additional storage mediums in communication with the central processor where the additional storage mediums may be internal storage mediums 20b, 20c, and 20d and/or external storage mediums 21a, 21b, 21c . . . 21zz. The second storage medium may be flash memory or any type of external device capable of storing data including but not limited to a memory stick, CF card, a SD card, a mini or micro CF or SF card, a jump or flash drive, and so on. In still another embodiment, the circuit also comprises an output device 70 in communication with the central processor. In still another embodiment, the central processor is in communication with a server 200 at a remote location whereby information is transmitted to and from the remote location. In yet still other embodiments, the device 100 has additional displays 31a, 31b, and 31c and/or additional speakers 33a and 33b. In still yet another embodiment, in addition to the onboard power source 58, the device 100 has a connection to an external power source 62, and as necessary, a transformer 60. The transformer may be a AC-to-DC converter, a step down transformer, or any type of transformer or adapter.

With reference to FIG. 12B, the circuit includes an input-output processor 74 which is in communication with the central processor 10. In another embodiment, the input-output processor 74 is in communication with a modem 80 and/or a wireless network adapter 82 which in turn is connected to a network 72. In still another embodiment, the modem 80 or network adapter 82 is an external component rather than an internal component. In still another embodiment, the device 100 includes additional input devices 40a . . . 40z such as alternative keys, touchpads, or touchscreens for data entry, a microphone, and/or digital camera. In yet still another embodiment, the device 100 includes auxillary processor(s) 56a, 56b, and 56c in communication with the central processor 10.

FIGS. 13A, 13B and 13C are schematic drawings of alternative circuits of other electronic devices 110 including stationary electronic devices having a central processor 10 in communication with at least one storage medium 20a, and at least one input device 40, and at least one connection to an external power source 62. In one embodiment of the invention, the circuit comprises the central processor 10, the storage medium 20a, at least one display 30, and the input device 40. In another embodiment, the central processor is in communication with a network 72. In still another embodiment, the circuit includes at least one speaker 33a. In yet still another embodiment, the circuit also comprises multiple output devices 70, and/or network connections 72. In yet still another embodiment, a modem 80 and/or a wireless network adapter 82 is in communication with the central processor. In yet still other embodiments, the circuit also comprises multiple internal storage mediums 20a . . . 20c, external storage mediums 21a . . . 21zz, displays 31a . . . 31c, speakers 33a . . . 33c, input devices 40.

In FIGS. 13A, 13B and 13C, the central processor may be in communication with a network 72 and the device 110 has at least one input-output device 74. When in communication with the network 72, the input-output device 74 may be a network card of the type manufactured by Novell Communications of Provo Utah; a dial-up modem of the type manufactured by Hayes Corporation of Boston Mass.; or an alternative type of modem such as wireless, DSL, or cable modems. In the preferred embodiment, the I/O device 74 is a wireless modem because it has the capability to remain “always-on” similar to a mobile communications device.

With reference to FIG. 13B, the audio processor and video processor are a single audio-visual processor 54 which is in communication with the central processor 10 and/or one or more displays 31a . . . 31c and/or one or more speakers 33a . . . 33c. In another embodiment, the modem 80 and/or a wireless network adapter 82 is an internal component rather than an external component.

With reference to FIG. 13C, the circuit includes an input-output processor 74 which is in communication with the central processor 10. In another embodiment, the input-output processor is in communication with a modem 80 and/or a wireless network adapter 82 which in turn is connected to a network 72. In still another embodiment, the device 100 includes auxiliary processor(s) 56a, 56b, and 56c in communication with the central processor 10. In yet others embodiments, the circuit may include a series of displays 31a . . . 31zz, a series speakers 33a . . . 33zz, multiple input devices 40, and/or multiple output devices 70.

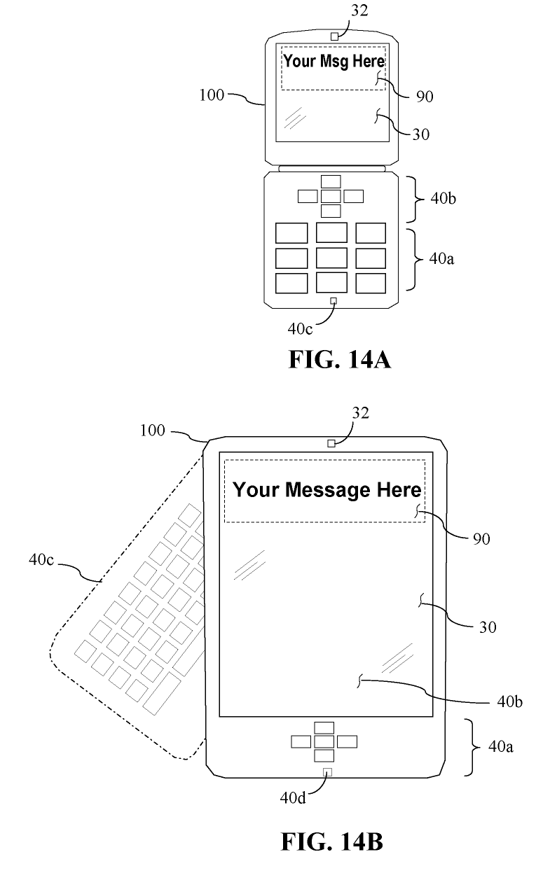

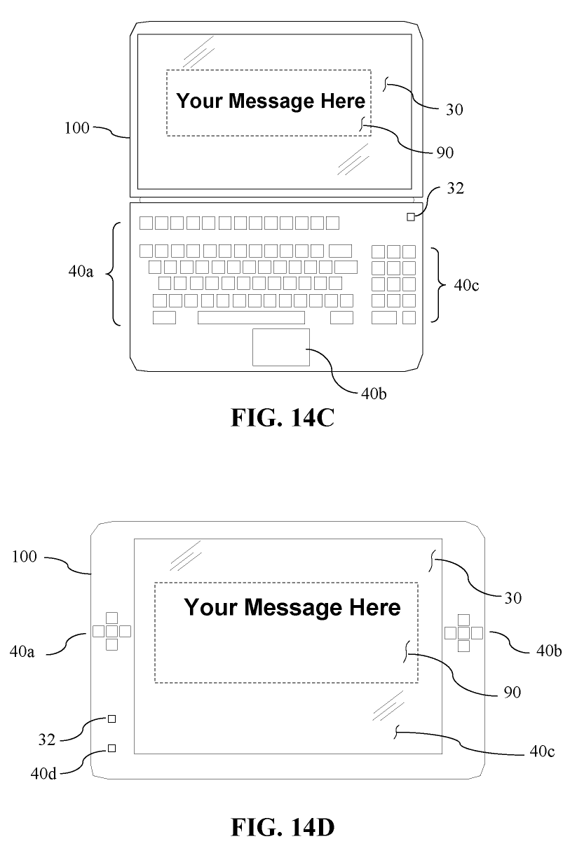

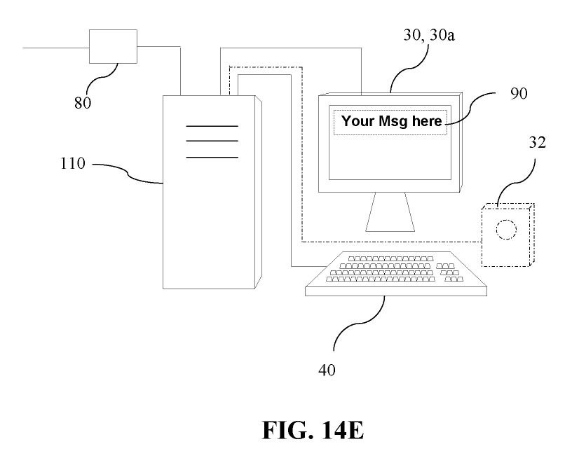

FIGS. 14A through 14D are perspective drawings of alternative mobile devices 100 having a display 30, a speaker 32, at least one input device 40, and at least one message display area 90. In one embodiment, the display 30 may be a flat panel display and the input device(s) 40 is may be one of several types including a number/letter keypad or navigation/execution keypad of the type manufactured by Samsung Electronics, or a touchpad of the type manufactured by Toshiba, or a touchscreen of the type made by Sony Electronics. In FIGS. 14A and 14B, the message display area 90 is shown at or near the top of the display 30 but may be located elsewhere on the display 30 or may be enlarged to encompass the entire display 30 or shrunk to a smaller size. Similarly, in FIGS. 14C and 14D, the message display area 90 is shown at or near the center of the display 30 but may be located elsewhere on the display 30 or may be enlarged to encompass the entire display 30 or shrunk to a smaller size.

In FIG. 14A, the device 100 has three input devices 40a, 40b and 40c corresponding to a number/letter keypad, a navigation/execution keypad, and a microphone, respectively. In FIG. 14B, the device has four input devices 40a, 40b, 40c and 40d corresponding to a navigation/execution keypad, a touchscreen, a number/character keypad, and a microphone, respectively. In FIG. 14C, the device has three input devices 40a, 40b, and 40c corresponding to a character keypad, a touchpad, and a number keypad, respectively. In FIG. 14D, the device has four input devices 40a, 40b, 40c and 40d corresponding to a first navigation/execution keypad at the left, a second navigation/execution keypad at the right, a touchscreen, and a micropphone, respectively.

FIG. 14E is a perspective drawing of a stationary electronic device having a display 30, a speaker 32, at least one input device 40, and at least one message display area 90. In FIG. 14E, the message display area 90 is shown at or near the top of the display 30 but may be located elsewhere on the display 30 or may be enlarged to encompass the entire display 30 or shrunk to a smaller size. In FIG. 14E, the device has one input device 40 corresponding a keyboard.

The circuit and is powered by either an internal power source 15 or by an external source 62 of direct current (DC) power or alternating current (AC) power. Where the source is internal, the power source 15 may be including but not limited to a battery, a fuel cell, photovoltaic cell, and so on. Where the source is AC power, a transformer 60 is in communication with the source 62. The transformer may be a board-mounted transformer of the magnetic type manufactured by Hammond Manufacturing of Cheektowaga, N.Y. or a stand-alone power adapter of the type manufactured by Motorola Corporation of Schaumburg, Ill.

In one embodiment the storage medium(s) 20a . . . 20d may be a hard drive of the type manufactured by Quantum Corp. of Milpitas, Calif., and in another embodiment, the storage medium may be a flash memory device of the type manufactured by Sandisk. Alternatively, the central processor receives instructions and/or data from the storage medium 20 and/or a second storage medium 22. The second storage medium 22 may be a DVD, CDROM, memory stick, CF card, SD card, jump drive, programmable read only memory (PROM), electronically-alterable programmable memory (EPROM), or the like. In another embodiment, the second storage medium 22 is an integrated circuit housed within a game box. In still another embodiment, the second storage medium is a CDROM which is removeably connected to the circuit.

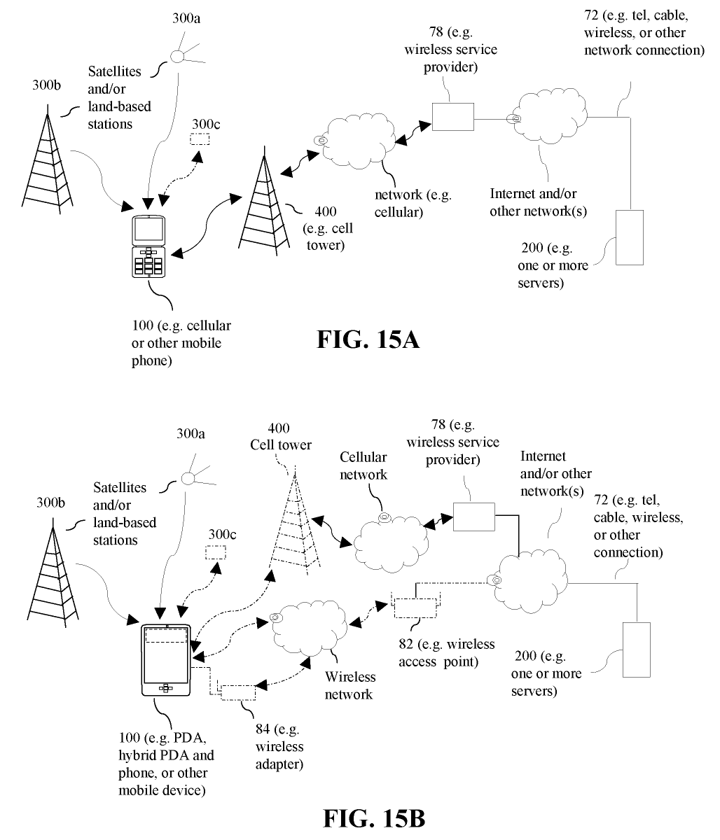

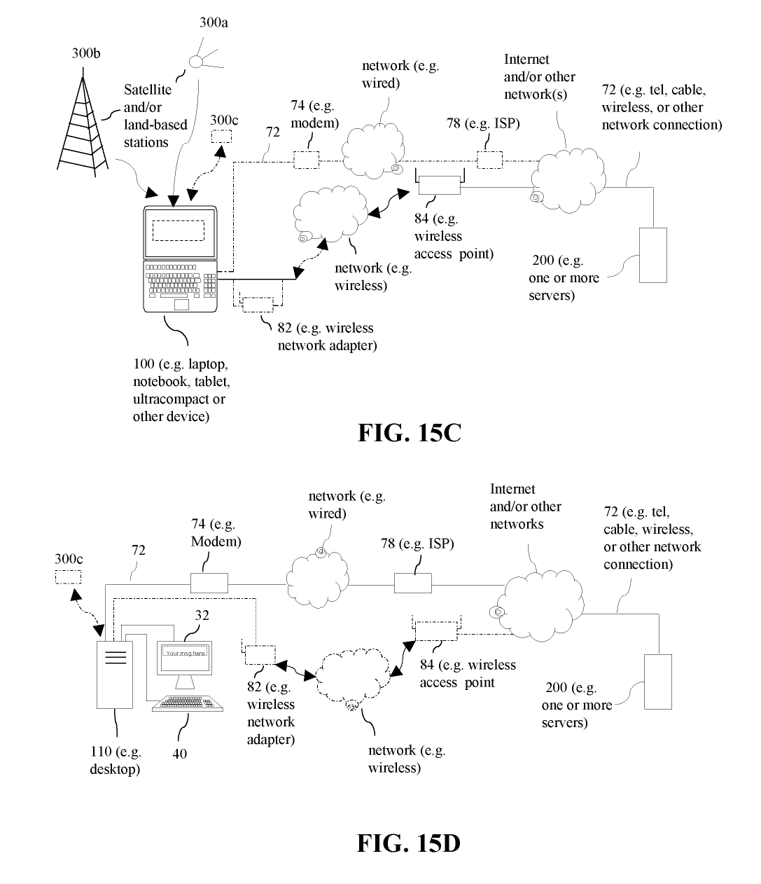

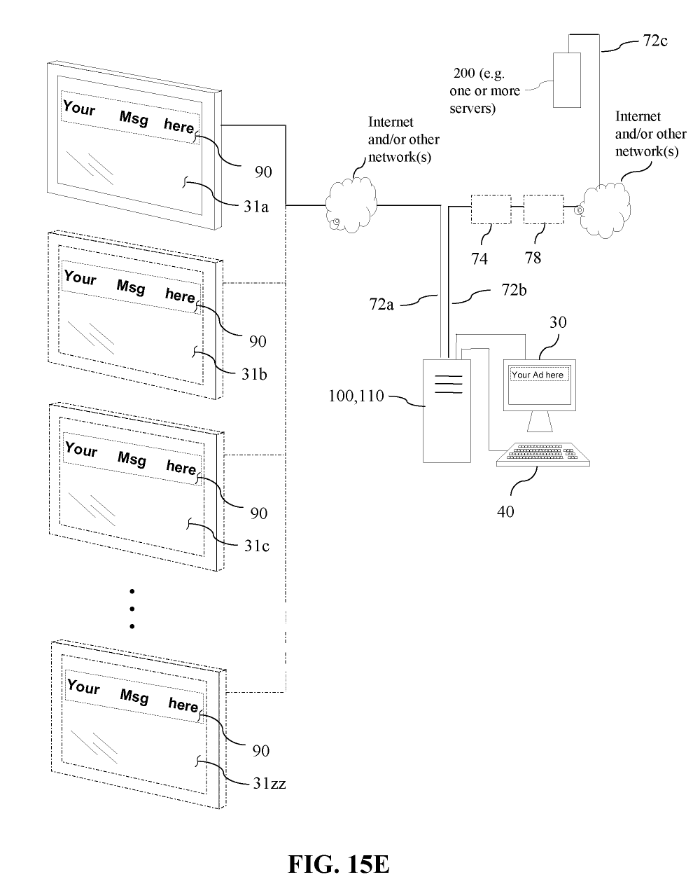

With reference to FIGS. 15A through 15E, a computer server is depicted by numeral 200. The computer server 200 may include any computer including a file server, a web server, and so on. Satellite-based positioning station(s) is/are depicted by numeral 300a, land-based positioning station(s) are depicted by numeral 300b, and source(s) using narrow cast or near field communications are depicted by numeral 300c. The positioning station(s) 300a may be located in geo-stationary orbit, the positioning station(s) 300b may be located in any fixed position on a temporary or permanent basis, and source(s) 300c may be located anyplace or located on anything, whether mobile or non-mobile, on a temporary or permanent basis. For example, source(s) 300c may be RFID tags, NFC chips, or the like.

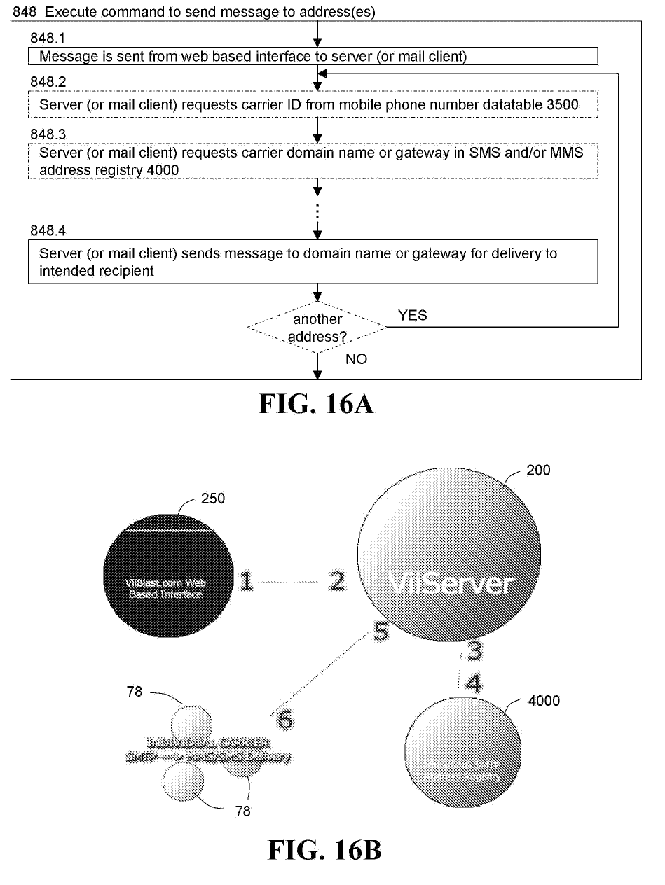

FIGS. 16A and 16B show the server-side of the process of sending a message to one or more addresses. FIG. 16A shows the subprocess 848 of executing a command to send messages to one or more addresses. In one embodiment, the subprocess comprise at least the step 848.1 message sent to a server 200 and the step 848.2 of the server sending the message to address(es). In another embodiment, the subprocess uses a mail client to send the message using SMTP. In still another embodiment, the subprocess calls a built-in mail( ) function on the server to send the message. In yet still another embodiment, the subprocess calls a proprietary mail subroutine that includes, for example, determining that message is deliverable to the address. In this way, the domain name or carrier would not receive spam. Better still, the proprietary mail subroutine could store the determination that message is deliverable at a given domain name or gateway. In this way, the domain name or carrier would not receive multiple requests to determine if address except for periodic updates of the datatable.

In the event one or more of the address(es) may be a complete or full address (e.g. username@domainname.com), additional steps 848.3 and 848.4 may not be required. However, in another embodiment, the subprocess uses the built-in mail( ) function on the server. In other embodiments, the subprocess comprises the additional steps 848.2 of server requesting carrier ID from a mobile phone number datatable 3500 and/or the step 848.3 of requesting carrier domain name or gateway from SMS/MMS address registry 4000. For example, these requests may be calls to subroutines, queries to databases using SQL, or other commands to lookup the requested information. FIG. 16B shows one or more servers 200 in communication with a one or more network(s). In one embodiment, there is only a single server 200. For example, the server may be a mail and/or multimedia messaging server of the type called ViiServer made by Trinity Tech Media, Inc. of Palm Springs, Calif. In another embodiment, there are two servers 200 where one server is an Internet or webserver and another server is a mail server in communication with the webserver. In still other embodiments, there a plurality of servers 200 in communication across one or more network(s) which may or may not include database server(s), webserver(s), fileserver(s), and/or adserver(s).

In operation, the process may initiate with one of alternative processes 800a, 800b, 800c, . . . , and so on. In another embodiment, one or more processes 500, 600, and/or 700 occurs in advance of alternative processes 800a, 800b, 800c, . . . , and so on, in which subprocesses 830.NN are streamlined to subprocess 830′ (or 830″) by reducing the number of steps, and thus, optimized for efficiency. For example, the wrapper and media codecs may be pre-determined for each communication channel in process 500. In another example, a user may predetermine a multimedia message template and save the template for subsequent use in process 600. In still another embodiment, domain names or gateways of carriers 78 may be pre-determined for each address in process 700 and saved in a datatable 3500. Execution of alternative processes 800a, 800b, 800c, . . . or 800′ or 800″ results in a message and one or more addresses is received by a server 200 for processing and sending over one or more network(s) to carriers 78 for delivery to the address(es) of the intended recipient(s). Typically, the address(es) and the message is received via a web interface 250 using HTTP or WAP but may also be received using any means and any device including but not limited to a server, desktop computer, mobile device, or other electronic device. In one embodiment, one or more of the media components of the message are received in advance of the address(es). For example, a media component, e.g. a video, may be uploaded to a user's account and saved in a user database. In another embodiment, one or more of the media components are received at the same time as the address(es). In still other embodiments, the media components and/or addresses are received at various times prior to sending the message(s).

In one embodiment, the mobile marketer or advertiser schedules the time applicable for each advertisement or promotion, e.g. NOW, TODAY at NOON, TODAY at 5 PM, TODAY at 6 PM, TOMORROW at 7 AM, and so on. In still another embodiment, the marketer or advertiser schedules a recurring time for one or more advertisements or promotions, e.g. EACH HOUR during COMMUTE TIME, EACH HOUR during PRIMETIME, EACH MORNING at 7 AM, EACH DAY at NOON, EACH EVENING at 6 PM. In other embodiments, a user may opt-in to receive additional messages comprising varied media files from third parties and the service may allow the user to schedule when to receive these additional messages which may include advertisements, promotions, announcements, licensed content, samples, and so on.

In some embodiments, advertisements or promotions may be comprised of text, music, photos, video, or clips. The prior art teaches away from use of the typical mobile phone in favor of more complex mobile devices with larger screens, more sophisticated OS, and browsers. However, use of the video player on the mobile phone can enable any mobile phone to be suitable delivery vehicle for video media including but not limited to video advertising, promotions, movies, TV shows, podcasts, and so on. In yet still another example, the media may also include media file (or descriptions, summaries, or thumbnails of media) recommended by one or more recommendor systems.

Thus, a person skilled in the art will understand that the invention has benefit for cross-platform delivery of messages to mobile phones as well as delivery of messages via multiple communication channels. In addition, a person skilled in the art will understand that the invention has benefit for both advertising and marketing, especially mobile advertising and marketing. Advertisers can target advertisements and promotions to mobile users without detracting from the value of device as a communications tool. Although a marketing message may be displayed on the device when the user is not using the mobile phone for purposes of communication, display of a message prior to making a connection may delay, and thus, detract from the value of the device as a communications tool. Thus, the users of mobile phone are generally intolerant of advertising when they wish to make phone calls, or to download information, through the network. Yet, a message may also be displayed of the device without detracting from its value by being displayed when the user is dialing a telephone number and/or after termination of a communication. For example, if the message is a sound bite, it would fit in during dialing. A longer message could be paused during a communication and resumed when the communication is terminated.

Better still, users may be more tolerant of advertising when they are browsing the web on the mobile phone. Also, if a user defers consideration of an advertisement or promotion for any reason (e.g. is busy, in a hurry or otherwise occupied), the advertiser and market can receive additional opportunities to get the user's attention because the user saved or deferred consideration of the advertisement or promotions.

The invention may be practiced on any computer or electronic device capable any manner or form of visual display. All types of computers, computer systems, and computer networks having the capability of a visual display can generally be programmed to operate computer games and interactive programs. Even those without capability of visual display can be programmed to operate a variety of computer games or interactive programs. In addition, many electronic devices can be programmed to operate a computer game or interactive program.

Some examples to illustrate the methods and systems include the following non-exhaustive list of potential applications in Table 8 below:

TABLE 8
Potential Applications

| | Media Type | | | | Interactivity | |
|---|---|---|---|---|---|---|
| Potential Application | Music | Video | Image | Text | Yes | No |
| Mobile device as conventional pager | X | X | X | X | | X |
| Mobile device as two-way pager | X | X | X | X | X | |
| Mobile device as two-way | X | X | X | X | X | |
| communicator or hailing device | | | | | | |
| Mobile device as alert notificiation | X | X | X | X | X | |
| Mobile device as direct marketing | X | X | X | X | X | |
| platform | | | | | | |
| Mobile device as customer relations | X | X | X | X | X | |
| platform | | | | | | |
| Mobile device as corporate investor | X | X | X | X | X | |
| relations platform | | | | | | |
| Mobile device as MP3 player | X | | X | | | X |
| Mobile device as Podcast player | X | X | | | | X |
| Mobile device as portable TV | X | X | | | X | |
| Mobile device as video player | | X | | | | |
| Mobile device as advertising platform | | X | X | X | X | |
| Mobile device as portable slide viewer | | | X | X | X | |
| Mobile device as video phone | X | X | | | X | |
| Mobile device as e-book reader | | | X | X | | X |
| Mobile device as collaboration tool or | X | X | X | X | X | |
| as portable white board device | | | | | | |
| Mobile phone as notetaking device | X | X | X | X | X | |
| Mobile phone as portable RSS viewer | X | X | X | X | | X |
| Mobile phone as voting machine or as | X | X | X | X | X | |
| polling/surveying device | | | | | | |
| Others . . . | X | X | X | X | X | |

Electronic devices may include any type of computer and computer system such as personal computers, laptop computers, notebook computers, handheld computers, arcade game machines, handheld games, video game systems, video game consoles, video game boxes, personal digital assistants, mobile computing devices, cable boxes, telephones, telecomputing devices, and telecommunication devices. The processes, subprocesses, and algorithms may be processed on a single processor, an array of processors, separated into two portions corresponding to server side or device side, or split in any number of ways. The processor(s) may comprise one or more processors such as a single integrated circuit or multiple integrated circuits having different functions i.e. central processing unit (CPU), input-output (I/O) processing, video processing, audio processing, transmission, reception, and so on. The display(s) may be any type of analog or digital CRT display including monochrome or color monitor, TV, DTV, HDTV, and so on, and any combination of these such as array of CRTs; any flat panel display including but not limited to LCD, TFT, plasma, and so on, or any combination of these such as an array of LCDs; or a analog or digital projection system such as front projection or rear projection of the types manufactured by Sony Electronics of San Diego, Calif., and Da-Lite of Warsaw, Ind., or such as LCD or DLP of the type manufactured by InFocus of Wilsonville, Oreg., and so on.

The methods and systems of the present invention include processes, subprocesses, and modules which may be used separately, and also in conjunction with one another. Modules may comprise source that is interpreted or the source code may be compiled into executable code. The method and systems may use the results created by any process, subprocess and/or module of this invention for any purpose including but not limited to creating, adapting, or mobilizing web content for viewing on mobile devices.

The methods and systems of the invention also include processes and subprocesses, which may be used separately, and also in conjunction with one another. These may be run independently, in series, in parallel or in any combination. The methods and systems may use the results created by any process and/or subprocess of this invention for any purpose including distributing of targeted message(s), or advertising, marketing, or other promotion.

From the foregoing it will be appreciated that although specific embodiments of the technology have been described herein for purposes of illustration, various modifications may be made without deviating from the spirit and scope of the invention. For example, the user may lease products or services rather than purchase them outright. Also, the user may provide personal information as consideration in addition to or in lieu of payment for products and services. A message or information may be presented in ways other than visual display. For example, a message or information may be output in an audio form. Further, the invention can be used with mobile phones, desktop or personal computers, computer terminals, TVs and monitors, video game machines, video game boxes, web TV, cable TV, CCTV, video consoles, laptop computers, notebook computers, handheld computers, personal digital assistants, telephones, smart phones, wireless phones, pagers, and so on. Accordingly, the invention should be broadly construed and should not be limited.

What is claimed is:

1. A computer implemented method to send a message to at least one address corresponding to mobile phone comprising the steps of:
a first electronic device receiving a request via a web interface wherein the request includes at least one address;
the first electronic device sending the request to a second electronic device and the second electronic device receiving the request;
the second electronic device, if the address is incomplete, determining a gateway or domain for the address;
the second electronic device determining a MIME type for the gateway or domain for the address; and
sending the message to the address;

2. The method of claim 1 which comprises an additional step of determining a wrapper corresponding to the gateway or domain prior to sending the message.

3. The method of claim 1 wherein the message is a multimedia message and the gateway or is a MMS gateway or domain.

4. The method of claim 1 wherein the message includes a video message.

5. A computer implemented method to send a message to a plurality of addresses having a first electronic device in communication with a second electronic device, which in turn, is in communication with other electronic devices comprising the steps of:
the first electronic device receiving a request via a web interface wherein the request includes at least two addresses that correspond to disparate communication channels;
the first electronic device sending the request to the second electronic device and the second electronic device receiving the request;
the second electronic device, if each address is incomplete, determining a gateway or domain for each address;
the second electronic device determining a MIME type for the gateway or domain for each address; and
sending the message to each address;

6. The method of claim 5 wherein the plurality of addresses comprises a pre-defined group of addresses.

7. The method of claim 5 which comprises an additional step of determining a wrapper corresponding to the gateway or domain prior to sending the message.

8. The method of claim 5 wherein the message is a multimedia message and the gateway is a MMS gateway or domain.

9. The method of claim 5 wherein the message includes a video message.

10. The method of claim 5 wherein the addresses correspond to a plurality of mobile phone numbers.

11. The method of claim 5 wherein the addresses correspond to disparate communication channels.

12. The method of claim 5 wherein the MIME type varies by wireless carrier.

13. The method of claim 5 wherein at least one address is a mobile phone number and at least one address is an email address.

14. A computer implemented method of sending a message to a plurality of mobile phones corresponding to a plurality of wireless carriers comprising the steps of:
an electronic device determining if a message is deliverable to an address through a gateway of one of the wireless carriers;
upon determining that the message is deliverable through a gateway of at least one of the wireless carriers, the electronic device storing an identifier of the gateway of the wireless carrier corresponding to the address;
the electronic device reading the identifier of the gateway corresponding to the address;
and the electronic device sending the message to the address via the gateway.

15. The method of claim 14 wherein the method checks the gateway of each wireless carrier in a predetermined order commencing with the gateway of the wireless carrier have the largest subscriber base, the wireless carrier with the next largest subscriber base, and so on.

16. The method of claim 14 wherein the method checks the gateway for each wireless carrier commencing with the gateway of the current wireless carrier.

17. The method of claim 14 wherein the method checks the gateway for each wireless carrier commencing with the gateway of the original wireless carrier.
